(19) United States
(12) Patent Application Publication
(10) Pub. No.: US 2019/0371360 A1
(43) Pub. Date: Dec. 5, 2019

(54) INFORMATION RECORDING MEDIUM, METHOD FOR PRODUCING SAME, AND SPUTTERING TARGET

(71) Applicant: Panasonic Intellectual Property Management Co., Ltd., Osaka (JP)

(72) Inventors: Akio TSUCHINO, Okayama (JP); Rie KOJIMA, Okayama (JP); Kazuki AITA, Okayama (JP)

(21) Appl. No.: 16/541,753

(22) Filed: Aug. 15, 2019

Related U.S. Application Data
(63) Continuation of application No. PCT/JP2018/002387, filed on Jan. 26, 2018.

(30) Foreign Application Priority Data
Feb. 24, 2017 (JP) 2017-033226

(51) Int. Cl. G11B 7/26; G11B 7/2433; G11B 7/0045; G11B 7/259

(52) U.S. Cl. CPC G11B 7/26; G11B 7/2433; G11B 2007/24308; G11B 7/259; G11B 7/00456

(57) ABSTRACT

An information recording medium includes three or more information layers. The three or more information layers include a first information layer including a first dielectric film, a recording film, and a second dielectric film in this order. The first dielectric film contains an oxide of D1. The D1 represents at least one element selected from a first group consisting of Nb, Mo, Ta, W, Ti, Bi, and Ce. The recording film contains at least W, Cu, Mn, and oxygen and M. The M represents at least one element selected from a second group consisting of Nb, Mo, Ta, and Ti. The W, the Cu, the Mn, and the M except the oxygen in the recording film satisfy a following formula (1):

WₓCu_{y}Mn_{z}M_{100-x-y-z} (atom %) (1)
wherein x, y, and z satisfy 15≤x≤60, y≤z, 0<z≤40, and 60≤x+y+z≤98.

### TECHNICAL FIELD

The present disclosure relates to a large-capacity information recording medium that records or reproduces information by an optical means, a method for producing the information recording medium, and a sputtering target.

### BACKGROUND ART

Use of digital data is increasing every year due to, for example, growth of the Internet and digitalization of broadcasting. An optical information recording medium, or an optical disc has been, as a highly-reliable information recording medium suitable for storing data for a long period, continuously evolved along with an increasing amount of information to attain a high capacity.

A Blu-ray (registered trademark) Disc Extra Large (BDXL) standard has been designed in June, 2010. A three-layer disc (including three information layers) conforming to this standard has a recording capacity of 33.4 gigabytes (GB) per one information layer and is capable of storing data as large amount as 100 GB on one side. As regards the three information layers of the three-layer disc, one that is farthest from a laser beam source is referred to as an “L0 layer,” another that is next farthest is referred to as an “L1 layer,” and the other that is nearest to the laser beam source is referred to as an “L2 layer.” Using this Blu-ray Disc Recordable Extra Large (BD-R XL), an optical disc library has already been proposed that is capable of attaining a large capacity of up to about 638 terabytes (TB) (for example, see NPL1).

Designed in March, 2014 as a standard following the BDXL standard is professional optical disc standard “Archival Disc” (for example, see NPL2). The Archival Disc has higher reliability than the BD (Blu-ray disc) and employs a land-and-groove recording method to have higher recording density. Further, the Archival Disc has a disc structure on both sides of a substrate and is thus provided as a larger-capacity recording medium. A roadmap of the Archival Disc standard is designed so as to sequentially increase the recording capacity per one disc. According to this roadmap, the Archival Disc is specifically scheduled to be developed as a 300-GB system for a first generation, a 500-GB system for a second generation, and a 1-TB system for a third generation.

The first-generation 300-GB Archival Disc includes a substrate each side of which is provided with a three-layer disc capable of storing 150-GB information, and is thus capable of recording and reproducing 300-GB information per one Archival Disc. That is, this Archival Disc has a recording capacity of 50 GB per one information layer. Each information layer has a simple structure having an oxide recording film sandwiched between oxide dielectric films (for example, see PTLS 1 and 2). Irradiation of the recording film with a laser beam causes the recording film to be changed in shape, and a signal is thus recorded. Using this disc, an optical disc library has already been proposed that is capable of attaining a capacity as large as up to 1.9 petabytes (PB) (for example, see NPL3).

### CITATION LIST

### Patent Literatures

PTL1: PCT International Publication No. 2013/183277
PTL2: Japanese Patent No. 4210620

### Non-Patent Literatures

NPL1: Data Archiver LB-DH8 series catalog, September 2016, Panasonic Corporation
NPL2: Archival Disc White Paper: Archival Disc Technology, 1st Edition, July 2015.
NPL3: Data Archiver LB-DH7 series catalog, September 2016, Panasonic Corporation

### SUMMARY

The second-generation 500-GB-capacity Archival Disc is supposed to attain a capacity of 250 GB by the three-layer disc provided on one side. That is, it is necessary to increase the recording capacity per one information layer from the first-generation 50 GB to 83.4 GB. As one measure of increasing the recording capacity, there is a method for increasing the recording density in one information layer. An object of the present disclosure is to provide an information recording medium capable of increasing the recording density so as to attain a recording medium that has a capacity as large as or larger than the capacity of the second-generation Archival Disc.

An information recording medium according to one aspect of the present disclosure is an information recording medium that records or reproduces information by irradiation with a laser beam,
the information recording medium including three or more information layers, three or more information layers including a first information layer, the first information layer including a first dielectric film, a recording film, and a second dielectric film in this order from a farther end toward a nearer end of the first information layer from a laser beam-irradiated surface of the information recording medium,
the first dielectric film containing an oxide of D1, where the D1 representing at least one element selected from a first group consisting of niobium (Nb), molybdenum (Mo), tantalum (Ta), tungsten (W), titanium (Ti), bismuth (Bi), and cerium (Ce),
the recording film containing at least tungsten (W), copper (Cu), manganese (Mn), and oxygen and further containing M, where the M representing at least one element selected from a second group consisting of niobium (Nb), molybdenum (Mo), tantalum (Ta), and titanium (Ti),
the W, the Cu, the Mn, and the M except the oxygen in the recording film satisfying a following formula (1):

WₓCu_{y}Mn_{z}M_{100-x-y-z} (atom %) (1),
wherein x, y, and z satisfy 15≤x≤60, y≤z, 0<z≤40, and 60≤x+y+z≤98.

An information recording medium according to another aspect of the present disclosure is an information recording medium that records or reproduces information by irradiation with a laser beam, the information recording medium including three or more information layers, the three or more information layers including an information layer, the information layer including a first dielectric film, a recording film, and a second dielectric film in this order from a farther end toward a nearer end of the information layer from a laser beam-irradiated surface of the information recording medium, the first dielectric film and the second dielectric film containing an oxide of D3, where the D3 representing at least one element selected from a group consisting of zirconium (Zr), indium (In), tin (Sn), and silicon (Si), the recording film containing at least tungsten (W), copper (Cu), manganese (Mn), titanium (Ti), and oxygen, the W, the Cu, the Mn, and the Ti except the oxygen in the recording film satisfying a following formula (2):

WₓCu_{y}Mn_{z}Ti_{100-x-y-z} (atom %) (2),
wherein x, y, and z satisfy 15≤x≤60, y≤z, 0<z≤40, and 60≤x+y+z≤98.

A method for producing an information recording medium according to the present disclosure is a method for producing an information recording medium, the method including steps of respectively forming three or more information layers included in an information recording medium,
in which at least one of the steps of respectively forming the three or more information layers includes:
forming a first dielectric film containing an oxide of D1 by sputtering with use of a target containing the D1, where the D1 representing at least one element selected from a first group consisting of niobium (Nb), molybdenum (Mo), tantalum (Ta), tungsten (W), titanium (Ti), bismuth (Bi), and cerium (Ce); and forming a recording film containing at least tungsten (W), copper (Cu), manganese (Mn), and oxygen, and further containing M by sputtering with use of a target containing at least W, Cu, and Mn and further containing the M, where the M representing at least one element selected from a second group consisting of niobium (Nb), molybdenum (Mo), tantalum (Ta), and titanium (Ti),
the W, the Cu, the Mn, and the M except the oxygen in the target used in a step for forming the recording film satisfying a following formula (1):

WₓCu_{y}Mn_{z}M_{100-x-y-z} (atom %) (1),
wherein x, y and z satisfy 15≤x≤60, y≤z, 0<z≤40, and 60≤x+y+z≤98.

A sputtering target according to the present disclosure is a sputtering target for forming a recording film of an information recording medium,
the sputtering target containing at least tungsten (W), copper (Cu), and manganese (Mn); and
M, where the M representing at least one element selected from a group consisting of niobium (Nb), molybdenum (Mo), tantalum (Ta), and titanium (Ti), and
the W, the Cu, the Mn, and the M except oxygen satisfying a following formula (1):

WₓCu_{y}Mn_{z}M_{100-x-y-z} (atom %) (1),
wherein x, y, and z satisfy 15≤x≤60, y≤z, 0<z≤40, and 60≤x+y+z≤98.

Even when increased in recording density and shorten in mark length, the information recording medium according to the present disclosure is capable of giving a relatively high signal/noise (S/N) and thus recording and reproducing a large amount of information.

### BRIEF DESCRIPTION OF DRAWINGS

FIG. 1 is a sectional view of information recording medium 100 according to a first exemplary embodiment of the present disclosure.

FIG. 2 is a sectional view of information recording medium 200 according to a second exemplary embodiment of the present disclosure.

FIG. 3 is a sectional view of information recording medium 300 according to a third exemplary embodiment of the present disclosure.

FIG. 4 is a sectional view of information recording medium 400 according to a fourth exemplary embodiment of the present disclosure.

FIG. 5 is a sectional view of information recording medium 500 according to a ninth exemplary embodiment of the present disclosure.

### DESCRIPTION OF EMBODIMENTS

### (Background to One Exemplary Embodiment of Present Disclosure)

Increasing the recording density is one exemplary means of increasing the recording capacity of a medium that optically records information. One of the means of increasing the recording density is, for example, a method for shortening a minimum mark length. Such a method, however, causes a problem that a shorter mark length gives a higher-frequency period signal to give system noise that affects the disc to lower the S/N (S: signal, N: noise) and thus degrade signal quality. In order to obtain good signal quality, it is necessary to improve the S/N by increasing an amount of light for reproduction that enters an optical pickup. The amount of light for reproduction is determined by a product of a reflectance of an information layer and power for reproduction of the optical pickup. The inventors of the present invention have studied a configuration of the information layer capable of further increasing the product (that is, the amount of light for reproduction).

Here, the reflectance is described in detail. The reflectance is a reflectance of a guide groove (a land portion, a groove portion) in each information layer and refers to one that is measured for a non-stacked information layer (that is, a single layer). An effective reflectance refers to a reflectance measured in each of information layers that have been actually assembled into a disc. As regards the Archival Disc having three layers on one side, for example, the effective reflectance of the L0 layer is measured by making a laser beam for reproduction incident on the disc, letting the laser beam pass the L2 layer and the L1 layer to reach the L0 layer and reflect on the L0 layer and letting the laser beam further pass the L1 layer and the L2 layer to return to the optical pickup, and obtaining the amount of the light that has returned to the optical pickup. That is, the effective reflectance of the L0 layer is measured by obtaining a proportion of the returned laser power for reproduction in the laser power for reproduction (100%) output from the pickup. The effective reflectance of the L1 layer is measured by obtaining the amount of light that has passed the L2 layer, been reflected, passed the L2 layer, and returned to the optical pickup. The effective reflectance of the L2 layer is measured by obtaining the amount of light that has been incident and reflected without passing another information layer and has returned to the optical pickup without passing another layer.

The Archival Disc employs a land-and-groove recording method. In this recording method, an increase in recording density increases an influence of crosstalk. In order to reduce the influence, it is desirable to further increase groove depth, whereas deepening the groove tends to decrease the reflectance.

Next, a definition of the power for reproduction is described. The power for reproduction is defined as maximum power that allows one-million-time reproduction (one-million-pass) of a recording signal which is performed by continuously irradiating the recording signal with a laser beam for reproduction having a prescribed power. More specifically, the maximum power is obtained by a method for determining pass or fail with respect to a change amount in channel bit error rate of a recording signal from an initial value to a value after one-million-time-reproduction at a certain power or with respect to a channel bit error value itself after one-million-time reproduction and further determining, when the change amount or the channel bit error value is passing, pass or fail for one-million-time reproduction with an increased power, followed by some more one-million-time reproduction with the power increased, until fail determination is given. For example, a power that gives a channel bit error rate value of less than or equal to 2×E-3 may be determined to be passing.

Having high power for reproduction means having good reproduction durability. In the three-layer disc, the reproduction durability of the L0 layer is evaluated by measuring the power for reproduction with use of the laser beam for reproduction that has passed the L2 layer and the L1 layer. The power for reproduction of the L1 layer is measured with use of the laser beam for reproduction that has passed the L2 layer. The power for reproduction of the L2 layer is measured with use of the laser beam for reproduction that passes no other layer.

It is possible to obtain the amount of light for reproduction from the effective reflectance and the power for reproduction. Specifically, the amount of light for reproduction is obtained by obtaining a product of the effective reflectance and the power for reproduction of each layer and dividing the product by 100 (effective reflectance R (%)×power for reproduction Pr (mW)/100). The second-generation Archival Disc is supposed to need a larger amount of light for reproduction and requires, for example, an amount of light for reproduction of more than or equal to 0.09 at quadruple speed. On the other hand, when a 500-GB land-and-groove recording Archival Disc is prepared with use of the recording film and the dielectric film employed in the first-generation Archival Disc, the amount of light for reproduction is as follows.

Amount of light for reproduction of L0 layer: 0.056 (2.8%×2 mW/100)

Amount of light for reproduction of L1 layer: 0.077 (4.5%×1.7 mW/100)

Amount of light for reproduction of L2 layer: 0.082 (6.3%×1.3 mW/100)

Thus, it is clear that the recording film and the dielectric film used in the first-generation Archival Disc are incapable of securing the amount of light for reproduction required in the second-generation Archival Disc. Particularly, the amount of light for reproduction of the L0 layer is considerably smaller than the required value.

In order to raise the amount of light for reproduction, any one of following methods is required: 1) increasing both the reflectance and the power for reproduction; 2) increasing the reflectance while being hardly capable of increasing the power for reproduction; 3) increasing the reflectance while allowing the power for reproduction to decrease; 4) increasing the power for reproduction while being hardly capable of increasing the reflectance; and 5) increasing the power for reproduction while allowing the reflectance to decrease. Among these methods, the method 1) is most preferable, but some situations only allow selection from the methods 2) to 5). As described above, the L0 layer of the second-generation Archival Disc requires a larger amount of light for reproduction than the amount of light for reproduction in the first-generation Archival Disc, and in order to raise the amount of light for reproduction by any one of the methods 1) to 5), it has been necessary to re-examine configurations of the recording film and the dielectric film in the L0 layer.

The L0 layer includes the first dielectric film, the recording film, and the second dielectric film in this order from an L0 layer's farther end toward the laser beam-irradiated surface (or the laser beam source). A calculation according to a matrix method has clarified that as a method for increasing the reflectance of the L0 layer, there are a method for thickening the first dielectric film, a method for increasing a refractive index of the first dielectric film, and a method for increasing a refractive index of the recording film.

The method for thickening the first dielectric film has a small effect of increasing the reflectance according to the calculation. The inventors of the present invention have actually attempted an improvement in the reflectance by increasing film thickness (change from 11.5 nm to 17 nm) of a ZrO₂—SiO₂—In₂O₃ first dielectric film actually employed in the L0 layer of a 300-GB disc. The attempt has resulted in a relative improvement of the effective reflectance only by 5%.

Alternatively, there is a method for increasing transmittances of the L1 layer and the L2 layer to increase a laser beam reaching the L0 layer and thus increase the effective reflectance of the L0 layer.

On the other hand, in order to increase the power for reproduction, it is effective to make the L0 layer more transparent and thus degrade recording sensitivity. More specifically, it is effective to make the recording film in the L0 layer more transparent, that is, to decrease an optical absorptance of the recording film. It is possible to lower the optical absorptance of the L0 layer by decreasing an extinction coefficient of the recording film. The decrease in the extinction coefficient of the recording film increases the transmittance of the L0 layer and thus lowers the absorptance.

As a method for decreasing the extinction coefficient of the recording film, there is exemplified a method for reducing ratios of Cu and Mn contained in the recording film. This is because these metals have large optical absorption. The reduction of Cu and Mn, however, causes problems such as 1) conductivity is lowered to make Direct Current (DC) sputtering difficult and 2) signal modulation depth is decreased to lower the signal quality.

Alternatively, it is also possible to lower the absorptance of the L0 layer by making composition of the layers constituting the L0 layer into composition of the layers constituting the L1 layer and the L2 layer. A decrease in absorptance of the L0 layer, however, increases the power for reproduction but lowers the reflectance, canceling each other to be incapable of achieving a large increase in the amount of light for reproduction. The L0 layer has an amount of light for reproduction of 0.077 when the composition of the layers constituting the L1 layer is applied to the L0 layer, and the L0 layer has an amount of light for reproduction of 0.082 when the composition of the layers constituting the L2 layer is applied to the L0 layer.

The recording film employed in the first-generation 300-GB Archival Disc is W—Cu—Zn—Mn—O (O: oxygen). A function of each element is described.

W—O in the recording film is a transparent oxide and has a function of generating oxygen to expand the recording film when the recording film is irradiated with a laser beam. Further, when the recording film is formed by DC sputtering with use of a target containing W, the W in the target has a function of stably maintaining the DC sputtering. The recording film that contains no W is not expanded to make formation of a recording mark difficult. Forming the recording film by sputtering with use of the target containing W while introducing oxygen makes the W into W—O or allows at least part of the W to combine with another element to form a composite oxide in the recording film.

Cu—O in the recording film is an oxide having an optical absorbency and plays a role of making the recording film absorb a laser beam. Cu in a target imparts conductivity to the target, and when the recording film is formed by DC sputtering, the Cu has a function of stably maintaining the DC sputtering. A target that contains no Cu makes the DC sputtering very difficult. Forming the recording film by sputtering with use of the target containing Cu while introducing oxygen makes the Cu into Cu—O or allows at least part of the Cu to combine with another element to form a composite oxide in the recording film.

Zn—O in the recording film is a conductive oxide, and formation of the recording film by DC sputtering with use of a target containing Zn—O further stabilizes the maintenance of the DC sputtering. Further, adjusting an amount of Zn—O enables adjustment of the transmittance and the optical absorptance of the recording film. Even when the target contains no Zn—O, however, it is possible to perform the DC sputtering. Forming the recording film by sputtering with use of the target containing Zn—O while introducing oxygen makes the Zn—O remain unchanged or allows at least part of the Zn—O to combine with another element to form a composite oxide in the recording film.

Mn—O in the recording film is an oxide having optical absorbency and has a function of generating oxygen to expand the recording film when the recording film is irradiated with a laser beam. The modulation depth becomes larger along with an increase of Mn—O, to improve the signal quality. The recording film that contains no Mn—O is incapable of forming a good-quality recording mark.

Forming the recording film by sputtering with use of a target containing Mn—O while introducing oxygen makes the Mn—O remain unchanged or allows at least part of the Mn—O to combine with another element to form a composite oxide in the recording film.

As the method for increasing the refractive index of the recording film, the inventors of the present invention have studied replacement of Zn—O, which has, even when not contained, no influence on DC sputtering or recording and reproduction characteristics, with another oxide having a larger refractive index than Zn—O.

Further, the inventors of the present invention have considered that in order to increase the amount of light for reproduction of the L0 layer, adjusting the composition of only the recording film or only the first dielectric film in the L0 layer is not sufficient and a configuration is preferable that is obtained by appropriately increasing both the refractive indexes of the recording film and the first dielectric film in the L0 layer and appropriately decreasing the extinction coefficient of the recording film. Then, the inventors of the present invention have variously studied a combination of the recording film with the first dielectric film and found that specifying the composition of each of the first dielectric film and the recording film increases at least one of the effective reflectance and the power for reproduction and is thus capable of relatively increasing the amount of light for reproduction.

That is, a first aspect of the present disclosure is an information recording medium that records or reproduces information by irradiation with a laser beam, the information recording medium including three or more information layers, the three or more information layers including a first information layer, the first information layer including a first dielectric film, a recording film, and a second dielectric film in this order from a farther end toward a nearer end of the first information layer from a laser beam-irradiated surface of the information recording medium, the first dielectric film containing an oxide of D1, where the D1 representing at least one element selected from a first group consisting of niobium (Nb), molybdenum (Mo), tantalum (Ta), tungsten (W), titanium (Ti), bismuth (Bi), and cerium (Ce), the recording film containing at least tungsten (W), copper (Cu), manganese (Mn), and oxygen and further containing M, where the M representing at least one element selected from a second group consisting of niobium (Nb), molybdenum (Mo), tantalum (Ta), and titanium (Ti), the W, the Cu, the Mn, and the M except the oxygen in the recording film satisfying a following formula (1):

WₓCu_{y}Mn_{z}M_{100-x-y-z} (atom %) (1)
wherein x, y, and z satisfy 15≤x≤60, y≤z, 0<z≤40, and 60≤x+y+z≤98.

A second aspect of the present disclosure is the information recording medium according to the first aspect, in which x and z in the formula (1) satisfy 0.5≤(x/z)≤3.0.

A third aspect of the present disclosure is the information recording medium according to the first aspect, in which the first group consists of Nb, Mo, and Ta.

A fourth aspect of the present disclosure is the information recording medium according to the first aspect, in which the second group consists of Nb, Mo, and Ta.

A fifth aspect of the present disclosure is the information recording medium according to any one of the first to fourth aspects, in which the first information layer is disposed at a position farthest from the laser beam-irradiated surface.

A sixth aspect of the present disclosure is the information recording medium according to the first aspect, in which the second dielectric film contains an oxide of D2, where the D2 representing at least one element selected from a third group consisting of niobium (Nb), molybdenum (Mo), tantalum (Ta), tungsten (W), titanium (Ti), bismuth (Bi), cerium (Ce), zirconium (Zr), indium (In), tin (Sn), and silicon (Si).

A seventh aspect of the present disclosure is the information recording medium according to the sixth aspect, in which the third group consists of Nb, Mo, Ta, Zr, In, Sn, and Si.

An eighth aspect of the present disclosure is the information recording medium according to the first aspect, in which the recording film further contains zinc (Zn).

A ninth aspect of the present disclosure is the information recording medium according to the first aspect, in which the first dielectric film further contains an oxide of zirconium (Zr) and has a proportion of the oxide of Zr of less than or equal to 70 mol % in a total amount of the oxide of Zr and the oxide of the D1.

A tenth aspect of the present disclosure is the information recording medium according to the first aspect, in which the first information layer further includes a third dielectric film, and the third dielectric film, the first dielectric film, and the recording film are disposed in this order from the farther end toward the nearer end of the first information layer from the laser beam-irradiated surface.

An eleventh aspect of the present disclosure is the information recording medium according to the first aspect, in which the first information layer further includes a third dielectric film, and the first dielectric film, the third dielectric film, and the recording film are disposed in this order from the farther end toward the nearer end of the first information layer from the laser beam-irradiated surface.

A twelfth aspect of the present disclosure is the information recording medium according to the tenth or eleventh aspect, in which the third dielectric film contains an oxide of D3, where the D3 representing at least one element selected from a fourth group consisting of zirconium (Zr), indium (In), tin (Sn), and silicon (Si).

A thirteenth aspect of the present disclosure is the information recording medium according to the first aspect, in which the three or more information layers includes a second information layer. The second information layer is different from the first information layer and includes a recording film, and
the recording film in the second information layer contains at least tungsten (w), copper (Cu), manganese (Mn), and oxygen.

A fourteenth aspect of the present disclosure is the information recording medium according to the first aspect, including a substrate on each side of which the three or more information layers are disposed.

A fifteenth aspect of the present disclosure is the information recording medium according to the first aspect, in which each of the three or more information layers has uneven surfaces including a groove and a land on each of which information recorded, the groove being nearer from the laser beam-irradiated surface than the land is.

A sixteenth aspect of the present disclosure is the information recording medium according to the first or eighth aspect, in which the first information layer is positioned farthest from the laser beam-irradiated surface, and the three or more information layers include a second information layer. The second information layer is different from the first information layer and includes a first dielectric film, a recording film, and a second dielectric film in this order from a farther end of the second information layer from the laser beam-irradiated surface, and the first dielectric film and the second dielectric film in the second information layer contain an oxide of D3, where the D3 representing at least one element selected from a fourth group consisting of zirconium (Zr), indium (In), tin (Sn), and silicon (Si).

A seventeenth aspect of the present disclosure is the information recording medium according to the sixteenth aspect, in which the first dielectric film in the second information layer contains at least Zr and Si, and the first dielectric film in the second information layer contains the Zr more than the Si.

An eighteenth aspect of the present disclosure is an information recording medium that records or reproduces information by irradiation with a laser beam, the information recording medium including three or more information layers, the three or more information layers including an information layer, the information layer, the information layer including a first dielectric film, a recording film, and a second dielectric film in this order from a farther end toward a nearer end of the information layer from a laser beam-irradiated surface of the information recording medium,
the first dielectric film and the second dielectric film containing an oxide of D3, where the D3 representing at least one element selected from a group consisting of zirconium (Zr), indium (In), tin (Sn), and silicon (Si), and
the recording film containing at least tungsten (W), copper (Cu), manganese (Mn), titanium (Ti), and oxygen, the W, the Cu, the Mn, and the Ti except the oxygen in the recording film satisfying a following formula (2):

WₓCu_{y}Mn_{z}Ti_{100-x-y-z} (atom %) (2),
wherein x, y, and z satisfy 15≤x≤60, y≤z, 0<z≤40, and 60≤x+y+z≤98.

A nineteenth aspect of the present disclosure is the information recording medium according to the eighteenth aspect, in which the recording film further contains at least one element selected from a group consisting of zinc (Zn), niobium (Nb), molybdenum (Mo), and tantalum (Ta).

A twentieth aspect of the present disclosure is the information recording medium according to the tenth, or eleventh aspect, in which at least one of the first dielectric film, the second dielectric film, or the third dielectric film further contains carbon (C).

A twenty-first aspect of the present disclosure is a method for producing an information recording medium, the method including steps of respectively forming three or more information layers included in an information recording medium, in which at least one of the steps of respectively forming the three or more information layers includes:
forming a first dielectric film containing an oxide of D1 by sputtering with use of a target containing D1, where the D1 representing at least one element selected from a first group consisting of niobium (Nb), molybdenum (Mo), tantalum (Ta), tungsten (W), titanium (Ti), bismuth (Bi), and cerium (Ce); and
forming a recoding film containing at least tungsten (W), copper (Cu), manganese (Mn), and oxygen, and further containing M by sputtering with use of a target containing at least W, Cu, and Mn and further containing the M, where the M representing at least one element selected from a second group consisting of niobium (Nb), molybdenum (Mo), tantalum (Ta), and titanium (Ti),
the W, the Cu, the Mn, and the M except the oxygen in the target used in a step for forming the recording film satisfying a following formula (1):

WₓCu_{y}Mn_{z}M_{100-x-y-z} (atom %) (1)
wherein x, y, and z satisfy 15≤x≤60, y≤z, 0<z≤40, and 60≤x+y+z≤98.

A twenty-second aspect of the present disclosure is the method for producing the information recording medium according to the twenty-first aspect, in which x and z in the formula (1) satisfy 0.5≤(x/z)≤3.0.

A twenty-third aspect of the present disclosure is the method for producing the information recording medium according to the twenty-first aspect, in which the step for forming the recording film employs a reactive sputtering method that introduces oxygen.

A twenty-fourth aspect of the present disclosure is the method for producing an information recording medium according to the twenty-first aspect, in which the target used in the step for recording film further contains zinc (Zn) and the step for forming the recording film forms, by the sputtering, the recording film containing at least the W, the Cu, the Mn, the M, the Zn, and the oxygen.

A twenty-fifth aspect of the present disclosure is
a sputtering target for forming a recording film of an information recording medium, the sputtering target containing at least tungsten (W), copper (Cu), and manganese (Mn) and further containing M, where the M representing at least one element selected from a group consisting of niobium (Nb), molybdenum (Mo), tantalum (Ta), and titanium (Ti),
the W, the Cu, the Mn, and the M except oxygen satisfying a following formula (1):

WₓCu_{y}Mn_{z}M_{100-x-y-z} (atom %) (1),
wherein x, y, and z satisfy 15≤x≤60, y≤z, 0<z≤40, and 60≤x+y+z≤98.

A twenty-sixth aspect of the present disclosure is the sputtering target according to the twenty-fifth aspect, in which x and z in the formula (1) satisfy 0.5≤(x/z)≤3.0.

A twenty-seventh aspect of the present disclosure is the sputtering target according to the twenty-fifth aspect, in which the sputtering target further contains zinc (Zn).

Hereinafter, exemplary embodiments of the present disclosure are described with reference to drawings. The following exemplary embodiments, however, are examples, and the present disclosure is not limited to the following exemplary embodiments.

### First Exemplary Embodiment

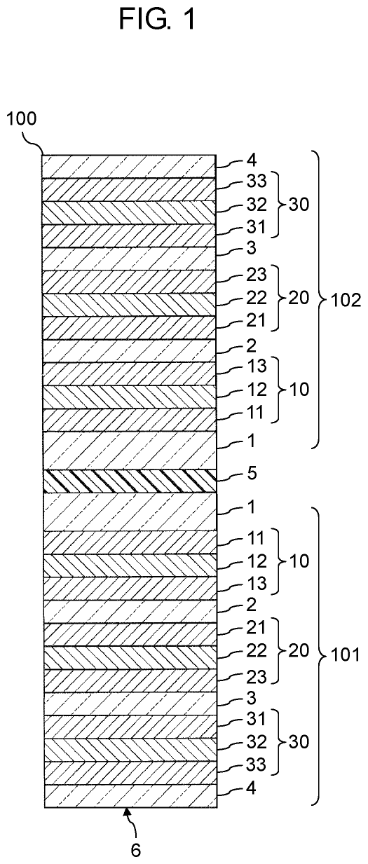

As a first exemplary embodiment, one example of the information recording medium is described that records and reproduces information with laser beam 6. FIG. 1 shows a sectional view of the optical information recording medium. Information recording medium 100 according to the present exemplary embodiment includes, on each side of substrate 1, three information layers that records and reproduces information, with substrate 1 interposed between two sets of the three information layers (a total of 6 layers) and is a multi-layer optical information recording medium capable of recording and reproducing information in each of the information layers by irradiation with laser beam 6 from an information recording medium's cover layer 4 side. Laser beam 6 is a laser beam in a blue-violet region with a wavelength of about 405 nm.

Information recording medium 100 is a double-side information recording medium obtained by bonding A-side information recording medium 101 and B-side information recording medium 102 to each other. A-side information recording medium 101 and B-side information recording medium 102 are bonded to each other by back surfaces of media's substrates 1 (a side opposite to a surface on which the information layers are provided) with bonding layer 5 in between. A-side information recording medium 101 and B-side information recording medium 102 each include, on substrate 1, L0 layer 10, L1 layer 20, and L2 layer 30 sequentially stacked as the information layers, with, for example, intermediate separation layers 2 and 3 interposed between two of the information layers and further include cover layer 4 provided in contact with L2 layer 30. L1 layer 20 and L2 layer 30 are transmissive information layers.

When a guide groove is formed in substrate 1 of information recording medium 100, a surface of substrate 1 that is nearer to laser beam 6 is referred to as a “groove” for convenience and a surface that is farther from laser beam 6 is referred to as a “land” for convenience. Forming a pit on a recording film at positions corresponding to both the groove and the land (land-groove recording) while increasing the recording density (that is, shortening the mark length) enables a capacity of, for example, 83.4 GB per one information layer. Since information recording medium 100 is capable of recording and reproducing information by the six information layers, it is possible to provide information recording medium 100 as one having a capacity of 500 GB. As described later, the guide groove may also be formed in intermediate separation layers 2 and 3. Particularly, when the land-groove recording is performed on L1 layer 20 and L2 layer 30, the guide groove is preferably formed in intermediate separation layers 2 and 3.

It is possible to control the effective reflectances of the three information layers by adjusting the reflectances of L0 layer 10, L1 layer 20, and L2 layer 30 and the transmittances of L1 layer 20 and L2 layer 30. In the present specification, the effective reflectance is, as described above, defined as the reflectance of each of the three information layers stacked on one another. The reflectance without the term “effective” refers to a reflectance measured without stacking the layers, unless otherwise noted. A reflectance R_{g} denotes a guide-groove reflectance of an unrecorded groove portion and a reflectance Rₗ denotes a guide-groove reflectance of an unrecorded land portion.

In the present exemplary embodiment, an information recording medium is, as one example, described that has a configuration designed such that L0 layer 10 has an effective reflectance R_{g} of 3.4% and an effective reflectance Rₗ of 3.7%, L1 layer 20 has an effective reflectance R_{g} of 4.8% and an effective reflectance Rₗ of 5.1%, and L2 layer 30 has an effective reflectance R_{g} of 6.4% and an effective reflectance Rₗ of 6.8%.

When L2 layer 30 has a transmittance of 79% and L1 layer 20 has a transmittance of 72%, it is possible to obtain the effective reflectances described above by designing L0 layer 10 to have a reflectance R_{g} of 10.5% and a reflectance Rₗ of 11.3%, L1 layer 20 to have a reflectance R_{g} of 7.7% and a reflectance Rₗ of 8.2%, and L2 layer 30 to have a reflectance R_{g} of 6.4% and a reflectance Rₗ of 6.8%. The transmittances herein represent average values of the groove portion and the land portion in the recording film that is unrecorded.

Hereinafter, substrate 1, intermediate separation layers 2 and 3, cover layer 4, and bonding layer 5 are described in terms of a function, a material, and thickness.

As the material for substrate 1, it is possible to use, for example, a resin such as polycarbonate, an amorphous polyolefin, or polymethyl methacrylate (PMMA), or glass. A recess-and-projection guide groove for guiding a laser beam may be formed as necessary in a substrate 1's recording film 12-side surface. Substrate 1 is preferably transparent but may be translucent, and is not particularly limited in terms of transparency. A shape of substrate 1 is not also particularly limited and may be disk-shaped. Substrate 1 has, for example, a disk shape having a thickness of about 0.5 mm and a diameter of about 120 mm.

A recess-and-projection guide groove for guiding laser beam 6 may be formed as necessary in a substrate 1's L0 layer 10-side surface. When the guide groove is formed in substrate 1, a guide groove (surface) of substrate 1 that is nearer to laser beam 6 is referred to as a “groove” and a guide groove (surface) that is farther from laser beam 6 is referred to as a “land” as described above. A depth of the guide groove (difference in height between a groove surface and a land surface) may range, for example, from 10 nm to 50 nm, inclusive. When the land-groove recording method is employed and performed at high recording density, the depth of the guide groove may be designed deeper so as to reduce the influence of crosstalk. Deepening the guide groove, however, tends to decrease the reflectance. In order to reduce the crosstalk and enable maintenance of the reflectance, the depth of the guide groove preferably ranges from 20 nm to 40 nm, inclusive. In the first exemplary embodiment, land-groove distance (distance between a width-wise center of a groove and a width-wise center of a land adjacent to the groove) is about 0.225 μm. The land-groove distance, however, is not limited to this value.

Intermediate separation layers 2 and 3 are made of, for example, a resin such as a photo-curable resin (particularly, an ultraviolet-curable resin) or a slow-acting thermosetting resin and is made of, for example, an acrylic resin. Intermediate separation layers 2 and 3 that have low optical absorption for a wavelength-A laser beam used for recording and reproduction enable laser beam 6 to efficiently reach L0 layer 10 and L1 layer 20. Intermediate separation layers 2 and 3 are provided to discriminate focus positions on L0 layer 10, L1 layer 20, and L2 layer 30. Therefore, intermediate separation layers 2 and 3 may have a thickness of, for example, more than or equal to a focus depth ΔZ determined according to a numerical aperture (NA) of an objective lens and the wavelength λ of the laser beam. When a reference for optical intensity at a focus is assumed to be 80% of optical intensity in a case of no aberration, it is possible to approximate the focus depth ΔZ as ΔZ=Δ/{2(NA)²}. In order to prevent an influence of a back focus on L1 layer 20, intermediate separation layers 2 and 3 may have different values for the thickness.

A recess-and-projection guide groove may be formed in laser beam 6 incident-side surfaces of intermediate separation layers 2 and 3. The difference in height and the land-groove distance of the guide groove provided in intermediate separation layers 2 and 3 are as described for the guide groove provided in substrate 1. In the first exemplary embodiment, the depth of the guide groove (difference in height between the groove surface and the land surface) is set at 30 nm and the land-groove distance is set at about 0.225 μm. The depth of the guide groove and the land-groove distance, however, are not limited to these values.

Cover layer 4 is made of, for example, a resin such as a photo-curable resin (particularly, an ultraviolet-curable resin) or a slow-acting thermosetting resin, or a dielectric. Cover layer 4 may have low optical absorption for the laser beam used. Alternatively, cover layer 4 may be formed using a resin such as polycarbonate, an amorphous polyolefin, or polymethyl methacrylate (PMMA), or glass. When these materials are used, cover layer 4 may be sheet-shaped or thin plate-shaped. Sheet-shaped or thin plate-shaped cover layer 4 may be formed by, for example, bonding, as an adhesive, a resin such as a photo-curable resin (particularly, an ultraviolet-curable resin) or a slow-acting thermosetting resin to second dielectric film 33 in L2 layer 30. Cover layer 4 may have a thickness ranging, for example, from about 40 μm to 80 μm, particularly from about 50 μm to 65 μm that enables good recording and reproduction at a NA of 0.85.

Bonding layer 5 is made of, for example, a resin such as a photo-curable resin (particularly, an ultraviolet-curable resin) or a slow-acting thermosetting resin and bonds A-side information recording medium 101 to B-side information recording medium 102. Bonding layer 5 is not particularly limited in terms of transparency and may be transparent or translucent. Bonding layer 5 may be provided with a film that blocks laser beam 6. Bonding layer 5 may have a thickness ranging from about 5 μm to 80 μm, particularly from about 20 μm to 50 μm.

When information recording medium 100 has about the same thickness as a BD-standard medium, total thickness of intermediate separation layers 2 and 3 and cover layer 4 may be set at 100 μm. For example, the thickness of intermediate separation layer 2 may be set at about 25 μm, the thickness of intermediate separation layer 3 at about 18 μm, and the thickness of cover layer 4 at about 57 μm.

Next, a configuration of L0 layer 10 is described. L0 layer 10 is formed by stacking, on a surface of substrate 1, at least first dielectric film 11, recording film 12, and second dielectric film 13 in this order.

First dielectric film 11 has an action of adjusting an optical phase difference to control signal amplitude and an action of adjusting a bulge of a recording mark to control signal amplitude. First dielectric film 11 also has an action of suppressing ingress of moisture into recording film 12 and an action of suppressing escape of oxygen in recording film 12 to exterior.

L0 layer 10 positioned farthest from a laser beam incident surface (surface of cover layer 4) tends to have a smallest amount of light for reproduction. Further, a finding by the inventors of the present invention has clarified that, of the two dielectric films positioned on both sides of recording film 12, first dielectric film 11 positioned farther from the laser beam incident surface has a larger influence on the amount of light for reproduction.

Therefore, in the present exemplary embodiment, first dielectric film 11 is formed as a film containing an oxide of D1. The D1 represents at least one element selected from a first group consisting of Nb, Mo, Ta, W, Ti, Bi, and Ce. The oxide of the D1 enables formation of a transparent film. The dielectric film that contains the oxide of the D1 has a high refractive index and contributes to an improvement in the reflectance of L0 layer 10.

First dielectric film 11 may contain one oxide of the D1 (may be unitary), and in that case, first dielectric film 11 may contain any one of, for example, Nb₂O₅, MoO₃, Ta₂O₅, WO₃, TiO₂, Bi₂O₃, and CeO₂. These are transparent oxides that all have a refractive index of more than or equal to 2.2. More specifically, refractive index values actually measured with a spectroscopic ellipsometer at a wavelength of 405 nm are 2.42 for Nb₂O₅, 2.21 for MoO₃, 2.26 for Ta₂O₅, 2.25 for WO₃, 2.62 for TiO₂, 2.76 for Bi₂O₃, and 2.62 for CeO₂. These oxides all contribute to an improvement in the reflectance of L0 layer 10.

First dielectric film 11 is a nanometer-order thin film formed by, for example, sputtering. Therefore, the oxide contained in first dielectric film 11 sometimes does not strictly give a stoichiometric composition due to deficiency of oxygen and/or a metal during sputtering and due to incorporation of inevitable impurities. Because of this reason, the oxide contained in first dielectric film 11 does not necessarily have to be one having a stoichiometric composition in the present exemplary embodiment and the other exemplary embodiments. The materials represented by stoichiometric compositions in the present specification include one that does not strictly have a stoichiometric composition due to, for example, deficiency of oxygen and/or a metal and due to incorporation of impurities.

In order to further increase conductivity of first dielectric film 11, NbOₓ (x<2.5, corresponding to oxygen-deficient Nb₂O₅) or TiOₓ (x<2, corresponding to oxygen-deficient TiO₂) may be used. First dielectric film 11 preferably has a specific resistance value of less than or equal to 1 Ωcm. This also similarly applies to first dielectric films 21, 31 described later.

First dielectric film 11 may be made of a mixture of two or more oxides selected from these oxides or may be made of a composite oxide formed of two or more oxides selected from these oxides. When containing two metal elements as the D1 (when being binary), first dielectric film 11 may have a composition of, for example, Nb₂O₅—MoO₃, Nb₂O₅—Ta₂O₅, Nb₂O₅—WO₃, Nb₂O₅—TiO₂, Nb₂O₅—Bi₂O₃, Nb₂O₅—CeO₂, MoO₃—Ta₂O₅, MoO₃—WO₃, MoO₃—TiO₂, MoO₃—Bi₂O₃, MoO₃—CeO₂, Ta₂O₅—WO₃, Ta₂O₅—TiO₂, Ta₂O₅—Bi₂O₃, Ta₂O₅—CeO₂, WO₃—TiO₂, WO₃—Bi₂O₃, WO₃—CeO₂, TiO₂—Bi₂O₃, TiO₂—CeO₂, or Bi₂O₃—CeO₂. Here, the hyphen “-” means “mixing.” For example, Nb₂O₅—MoO₃ thus means to be formed by mixing the two oxides Nb₂O₅ and MoO₃. In the binary compositions, a mixing ratio between oxides is not particularly limited.

When containing three metal elements as the D1 (when being ternary), first dielectric film 11 may have a composition of, for example, Nb₂O₅—MoO₃—Ta₂O₅, Nb₂O₅—MoO₃—WO₃, Nb₂O₅—MoO₃—TiO₂, Nb₂O₅—MoO₃—Bi₂O₃, Nb₂O₅—MoO₃—CeO₂, Nb₂O₅—Ta₂O₅—WO₃, Nb₂O₅—Ta₂O₅—TiO₂, Nb₂O₅—Ta₂O₅—Bi₂O₃, Nb₂O₅—Ta₂O₅—CeO₂, Nb₂O₅—WO₃—TiO₂, Nb₂O₅—WO₃—Bi₂O₃, Nb₂O₅—WO₃—CeO₂, Nb₂O₅—TiO₂—Bi₂O₃, Nb₂O₅—TiO₂—CeO₂, Nb₂O₅—Bi₂O₃—CeO₂, MoO₃—Ta₂O₅—WO₃, MoO₃—Ta₂O₅—TiO₂, MoO₃—Ta₂O₅—Bi₂O₃, MoO₃—Ta₂O₅—CeO₂, MoO₃—WO₃—TiO₂, MoO₃—WO₃—Bi₂O₃, MoO₃—WO₃—CeO₂, MoO₃—TiO₂—Bi₂O₃, MoO₃—TiO₂—CeO₂, MoO₃—Bi₂O₃—CeO₂, Ta₂O₅—WO₃—TiO₂, Ta₂O₅—WO₃—Bi₂O₃, Ta₂O₅—WO₃—CeO₂, Ta₂O₅—TiO₂—Bi₂O₃, Ta₂O₅—TiO₂—CeO₂, Ta₂O₅—Bi₂O₃—CeO₂, WO₃—TiO₂—Bi₂O₃, WO₃—TiO₂—CeO₂, WO₃—Bi₂O₃—CeO₂, or TiO₂—Bi₂O₃—CeO₂. In the ternary compositions, a mixing ratio among oxides is not particularly limited.

When containing four metal elements as the D1 (when being quaternary), first dielectric film 11 may have a composition of, for example, Nb₂O₅—MoO₃—Ta₂O₅—WO₃, Nb₂O₅—MoO₃—Ta₂O₅—TiO₂, Nb₂O₅—MoO₃—Ta₂O₅—Bi₂O₃, Nb₂O₅—MoO₃—Ta₂O₅—CeO₂, Nb₂O₅—MoO₃—WO₃—TiO₂, Nb₂O₅—MoO₃—WO₃—Bi₂O₃, Nb₂O₅—MoO₃—WO₃—CeO₂, Nb₂O₅—MoO₃—TiO₂—Bi₂O₃, Nb₂O₅—MoO₃—TiO₂—CeO₂, Nb₂O₅—MoO₃—Bi₂O₃—CeO₂, Nb₂O₅—Ta₂O₅—WO₃—TiO₂, Nb₂O₅—Ta₂O₅—WO₃—Bi₂O₃, Nb₂O₅—Ta₂O₅—WO₃—CeO₂, Nb₂O₅—Ta₂O₅—TiO₂—Bi₂O₃, Nb₂O₅—Ta₂O₅—TiO₂—CeO₂, Nb₂O₅—Ta₂O₅—Bi₂O₃—CeO₂, Nb₂O₅—WO₃—TiO₂—Bi₂O₃, Nb₂O₅—WO₃—TiO₂—CeO₂, Nb₂O₅—WO₃—Bi₂O₃—CeO₂, Nb₂O₅—TiO₂—Bi₂O₃—CeO₂, MoO₃—Ta₂O₅—WO₃—TiO₂, MoO₃—Ta₂O₅—WO₃—Bi₂O₃, MoO₃—Ta₂O₅—WO₃—CeO₂, MoO₃—Ta₂O₅—TiO₂—Bi₂O₃, MoO₃—Ta₂O₅—TiO₂—CeO₂, MoO₃—Ta₂O₅—Bi₂O₃—CeO₂, MoO₃—WO₃—TiO₂—Bi₂O₃, MoO₃—WO₃—TiO₂—CeO₂, MoO₃—WO₃—Bi₂O₃—CeO₂, MoO₃—TiO₂—Bi₂O₃—CeO₂, Ta₂O₅—WO₃—TiO₂—Bi₂O₃, Ta₂O₅—WO₃—TiO₂—CeO₂, Ta₂O₅—WO₃—Bi₂O₃—CeO₂, Ta₂O₅—TiO₂—Bi₂O₃—CeO₂, or WO₃—TiO₂—Bi₂O₃—CeO₂. In the quaternary compositions, a mixing ratio among oxides is not particularly limited.

In the unitary to quaternary compositions exemplified above, NbOₓ may be used in place of Nb₂O₅ and TiOₓ may be used in place of TiO₂. This also similarly applies to first dielectric films 21, 31 described later.

First dielectric film 11 may contain, for example, more than or equal to 50 mol % of the oxide of the D1 or may be substantially made of the oxide of the D1. Here, the term “substantially” is used in consideration of cases in which when formed by, for example, sputtering, first dielectric film 11 sometimes inevitably contains other elements derived from a rare gas (Ar, Kr, or Xe), moisture, organic matter (C), and air that exist in a sputtering atmosphere and impurities contained in a jig and a sputtering target that are disposed in a sputtering chamber. When all atoms contained in first dielectric film 11 are defined as 100 atom %, these inevitable components may be contained up to 10 atom % as an upper limit. This also similarly applies to cases in which the term “substantially” is used for the other dielectric films described later.

The oxide of the D1 may be an oxide of at least one element selected particularly from a group consisting of Nb, Mo, or Ta. The oxide of these elements has a refractive index at 405 nm of more than or equal to 2.2 to be capable of further increasing the amount of light for reproduction of L0 layer 10. Further, addition of the oxide of these elements enables formation of first dielectric film 11 at a high film-forming rate. The oxide of at least one element selected from Nb, Mo, and Ta may be contained in an amount of more than or equal to 50 mol %. Alternatively, first dielectric film 11 may be substantially made of the oxide of at least one element selected from Nb, Mo, and Ta.

When the binary, ternary, and quaternary compositions exemplified above include the oxide of at least one element selected from Nb, Mo, and Ta, the oxide may be contained in an amount of more than or equal to 50 mol %.

When first dielectric film 11 has a composition of, for example, Nb₂O₅—MoO₃—Ta₂O₅, a mixing ratio is not particularly limited and may be any ratio. When having a composition of Nb₂O₅—MoO₃—WO₃, first dielectric film 11 preferably contains more than or equal to 50 mol % of Nb₂O₅—MoO₃ (mixture of two oxides). When having a composition of Nb₂O₅—MoO₃—Ta₂O₅—TiO₂, first dielectric film 11 preferably contains more than or equal to 50 mol % of Nb₂O₅—MoO₃—Ta₂O₅ (mixture of three oxides).

First dielectric film 11 may further contain an oxide of Zr. The oxide of Zr is, for example, ZrO₂. The oxide of Zr, however, does not necessarily have to be one having a stoichiometric composition. The oxide of Zr enables adjustment of, for example, hardness of first dielectric film 11 and adhesiveness of first dielectric film 11 to substrate 1 and improves the power for reproduction of L0 layer 10. When containing the oxide of Zr, first dielectric film 11 may have a proportion of the oxide of Zr of less than or equal to 70 mol % in a total amount of the oxide of Zr and the oxide of the D1. First dielectric film 11 that has an excessively large proportion of the oxide of Zr decreases the refractive index and is thus sometimes incapable of increasing the reflectance of L0 layer 10.

First dielectric film 11 that contains the oxide of the D1 and the oxide of Zr has a composition of, for example, ZrO₂—Nb₂O₅, ZrO₂—MoO₃, ZrO₂—Ta₂O₅, ZrO₂—WO₃, ZrO₂—TiO₂, ZrO₂—Bi₂O₃, or ZrO₂—CeO₂. Alternatively, first dielectric film 11 that contains the oxide of the D1 and the oxide of Zr may have a composition of, for example, ZrO₂—Nb₂O₅—MoO₃, ZrO₂—Nb₂O₅—Ta₂O₅, ZrO₂—Nb₂O₅—WO₃, ZrO₂—Nb₂O₅—TiO₂, ZrO₂—Nb₂O₅—Bi₂O₃, ZrO₂—Nb₂O₅—CeO₂, ZrO₂—MoO₃—Ta₂O₅, ZrO₂—MoO₃—WO₃, ZrO₂—MoO₃—TiO₂, ZrO₂—MoO₃—Bi₂O₃, ZrO₂—MoO₃—CeO₂, ZrO₂—Ta₂O₅—WO₃, ZrO₂—Ta₂O₅—TiO₂, ZrO₂—Ta₂O₅—Bi₂O₃, ZrO₂—Ta₂O₅—CeO₂, ZrO₂—WO₃—TiO₂, ZrO₂—WO₃—Bi₂O₃, ZrO₂—WO₃—CeO₂, ZrO₂—TiO₂—Bi₂O₃, ZrO₂—TiO₂—CeO₂, or ZrO₂—Bi₂O₃—CeO₂. In the compositions including ZrO₂ exemplified here, NbOₓ may be used in place of Nb₂O₅ and TiOₓ may be used in place of TiO₂. This also similarly applies to first dielectric films 21, 31 described later.

First dielectric film 11 may have a thickness ranging, for example, from 5 nm to 40 nm, inclusive. First dielectric film 11 that has a thickness of less than 5 nm lowers a protection function and is thus sometimes incapable of suppressing ingress of moisture into recording film 12. First dielectric film 11 that has a thickness of more than 40 nm sometimes lowers the reflectance of L0 layer 10.

It is possible to analyze the composition of first dielectric film 11, for example, with an X-ray micro analyzer (XMA) or an electron probe micro analyzer (EPMA) or by Rutherford backscattering spectrometry (RBS). It is also possible to similarly analyze the composition of the other dielectric films described later by these measures.

Recording film 12 contains W, Cu, Mn, and oxygen and further contains M. The M represents at least one element selected from a second group consisting of Nb, Mo, Ta, and Ti. Recording film 12 that contains W, Cu, Mn, and oxygen allows, for example, separation of O by irradiation with laser beam 6 or combination of O atoms with each other to form an expansion portion to be a recording mark. This formation of the expansion portion is an irreversible change, so that the L0 layer that includes this recording film 12 is recordable.

The M optimizes the refractive index and the extinction coefficient of recording film 12 to improve the amount of light for reproduction of the L0 layer. Recording film 12 that contains the M enables an increase in the amount of light for reproduction by any of the means 2) to 5) among the means 1) to 5) of increasing the amount of light for reproduction described before.

In recording film 12, Nb, Mo, Ta, and Ti exist in an oxide form. Nb, Mo, Ta, and Ti are each capable of forming a plurality of oxides having different oxidation numbers. In general, an oxide containing much oxygen is transparent. For example, NbO (divalent niobium) and NbO₂ (tetravalent niobium) are black, whereas Nb₂O₅ (pentavalent niobium) is colorless. Magneli-phase oxide Nb₃ₙ₊₁O₈ₙ₋₂ also exists. MoO₂ (tetravalent molybdenum) is black, whereas MoO₃ (hexavalent molybdenum) is colorless. A blue Magneli-phase oxide obtained by reduction of MoO₃ also exists. TaO₂ (tetravalent tantalum) is black, whereas Ta₂O₅ (pentavalent tantalum) is colorless. TiO (divalent titanium) is black and Ti₂O₃ (trivalent titanium) is black-violet, whereas TiO₂ (tetravalent titanium) is colorless.

With a total amount of the W, the Cu, the Mn, and the M contained in recording film 12 defined as 100 atom %, a ratio among the elements is represented by a following formula (1):

WₓCu_{y}Mn_{z}M_{100-x-y-z} (atom %) (1)
wherein x, y, and z satisfy 15≤x≤60, y≤z, 0<z≤40, and 60≤x+y+z≤98.

Recording film 12 containing W, Cu, Mn, and the M that satisfy the formula makes the recording and reproduction characteristics of L0 layer 10 good.

In the formula (1), x (ratio of W) preferably ranges from 15 to 60, inclusive. When x is in this range, it is possible to form recording film 12 by stable DC sputtering and thus obtain the L0 layer having good recording and reproduction characteristics. In multi-sputtering that simultaneously sputters elementary-substance targets of W, Cu, Mn, and the M, when x is more than or equal to 15, it is possible to perform good DC sputtering. In use of an alloy target containing W, Cu, Mn, and the M in mixture, when x ranges from 20 to 50, inclusive, it is possible to perform good DC sputtering.

When DC sputtering is performed, with x being less than 15, the sputtering sometimes becomes unstable to easily cause abnormal electrical discharge. With x being more than 60, L0 layer 10 sometimes requires large laser power for recording.

A ratio x/z may range from 0.5 to 3.0, inclusive. With x/z being in this range, it is possible to stably perform DC sputtering. With x/z being less than 0.5, DC sputtering becomes unstable when performed to sometimes easily cause abnormal electrical discharge. With x/z being more than 3.0, L0 layer 10 sometimes requires large laser power for recording.

The letters y and z satisfy the relationship y z. The satisfaction of this relationship decreases the extinction coefficient of recording film 12 to enable an increase in the transmittance of L0 layer 10. The letter z may be, for example, one to ten times the value of y. With y being more than z, the extinction coefficient of recording film 12 increases to lower the transmittance and thus increase the absorptance of L0 layer 10, so that it is sometimes impossible to increase the power for reproduction. Further, with y being more than z, the signal quality is sometimes lowered.

The letter z satisfies 0<z≤40. Setting z at less than or equal to 40 suppresses the extinction coefficient (absorptance) of recording film 12 to be capable of increasing the power for reproduction. With z being larger, the reflectance of the L0 layer tends to be further increased. For example, recording film 12 that satisfies 20≤z≤40 further improves the reflectance of L0 layer 10.

The addition x+y+z ranges from 60 to 98, inclusive. With x+y+z ranging from 60 to 98, inclusive, the recording and reproduction characteristics of L0 layer 10 become good. With x+y+z ranging from 60 to 98, inclusive, the refractive index and the extinction coefficient of recording film 12 are optimized to increase the reflectance and decrease the absorptance of L0 layer 10, thus enabling an increase in the power for reproduction. With x+y+z being less than 60, the M is excessively increased to decrease the extinction coefficient, excessively increase the transmittance, and sometimes increase the absorptance of recording film 12. As a result, L0 layer 10 sometimes requires large laser power for recording and also sometimes makes high-speed recording difficult. With x+y+z being more than 98, the ratio of M is decreased to sometimes become unable to increase the refractive index of recording film 12.

The M in recording film 12 is more preferably at least one element selected from Nb, Mo, and Ta. Addition of any of these elements as the M to recording film 12 increases the refractive index of recording film 12 to be capable of improving the reflectance of the L0 layer and enables acceleration of a sputtering rate to be capable of forming recording film 12 with good productivity.

Recording film 12 may further contain Zn. Addition of Zn enables a further improvement in stability of sputtering when recording film 12 is formed by DC sputtering. Therefore, even an increase in sputtering power or a decrease of an Ar gas is less likely to cause abnormal electrical discharge to improve the productivity. A content of Zn may be less than or equal to 20 atom %, with a total number of atoms of the W, the Cu, the Mn, the M, and the Zn defined as 100, so as not to affect the refractive index and the extinction coefficient of recording film 12.

Recording film 12 may have a composition of, for example, W—Cu—Mn—Nb—O(O: oxygen), W—Cu—Mn—Nb—Zn—O, W—Cu—Mn—Nb—Mo—O, W—Cu—Mn—Nb—Mo—Zn—O, W—Cu—Mn—Nb—Mo—Ta—O, W—Cu—Mn—Nb—Mo—Ta—Zn—O, W—Cu—Mn—Nb—Mo—Ta—Ti—O, W—Cu—Mn—Nb—Mo—Ta—Ti—Zn—O, W—Cu—Mn—Nb—Mo—Ti—O, W—Cu—Mn—Nb—Mo—Ti—Zn—O, W—Cu—Mn—Nb—Ta—O, W—Cu—Mn—Nb—Ta—Zn—O, W—Cu—Mn—Nb—Ta—Ti—O, W—Cu—Mn—Nb—Ta—Ti—Zn—O, W—Cu—Mn—Nb—Ti—O, W—Cu—Mn—Nb—Ti—Zn—O, W—Cu—Mn—Mo—O, W—Cu—Mn—Mo—Zn—O, W—Cu—Mn—Mo—Ta—O, W—Cu—Mn—Mo—Ta—Zn—O, W—Cu—Mn—Mo—Ta—Ti—O, W—Cu—Mn—Mo—Ta—Ti—Zn—O, W—Cu—Mn—Mo—Ti—O, W—Cu—Mn—Mo—Ti—Zn—O, W—Cu—Mn—Ta—O, W—Cu—Mn—Ta—Zn—O, W—Cu—Mn—Ta—Ti—O, W—Cu—Mn—Ta—Ti—Zn—O, W—Cu—Mn—Ti—O, or W—Cu—Mn—Ti—Zn—O.

W in recording film 12 may exist in a WO₃ form that gives high transparency. Recording film 12 may also contain metal W, WO₂, an intermediate oxide between WO₂ and WO₃ (e.g., W₁₈O₄₉, W₂₀O₅₈, W₅₀O₁₄₈, and W₄₀O₁₁₉), or a Magneli phase (WₙO₃ₙ₋₁).

Cu in recording film 12 may exist in a CuO or Cu₂O form. Recording film 12 may also contain metal Cu.

Mn in recording film 12 may exist in a form of at least one oxide selected from MnO, Mn₃O₄, Mn₂O₃, and MnO₂. Recording film 12 may also contain metal Mn.

Nb in recording film 12 may exist in a colorless Nb₂O₅ form or a NbOₓ form. Recording film 12 may also contain both Nb₂O₅ and NbOₓ. Recording film 12 may also contain NbO, NbO₂, or a Magneli phase (Nb₃ₙ₊₁O₈ₙ₋₂). Recording film 12 may also contain metal Nb.

Mo in recording film 12 may exist in a colorless MoO₃ form. Recording film 12 may also contain MoO₂, an intermediate oxide between MoO₂ and MoO₃ (e.g., Mo₃O₈, Mo₄O₁₁, Mo₅O₁₄, Mo₈O₂₃, Mo₉O₂₆, and Mo₁₇O₄₇), or a Magneli phase (MoₙO₃ₙ₋₂). Recording film 12 may also contain metal Mo.

Ta in recording film 12 may exist in a colorless Ta₂O₅ form. Recording film 12 may also contain TaO₂. Recording film 12 may also contain metal Ta.

Ti in recording film 12 may exist in a colorless TiO₂ form or a TiOₓ form. Recording film 12 may also contain both TiO₂ and TiOₓ. Recording film 12 may also contain TiO, Ti₂O₃, or a Magneli phase (TiₙO₂ₙ₋₁). Recording film 12 may also contain metal Ti.

In recording film 12, a composite oxide may also exist that contains two or more metals selected from W, Cu, Mn, the M, and Zn.

When having a composition of, for example, W—Cu—Mn—Nb—O, recording film 12 highly possibly has any one of systems WO₃—CuO—MnO₂—Nb₂O₅, WO₃—CuO—Mn₂O₃—Nb₂O₅, WO₃—CuO—Mn₃O₄—Nb₂O₅, WO₃—CuO—MnO—Nb₂O₅, WO₃—Cu₂O—MnO₂—Nb₂O₅, WO₃—Cu₂O—Mn₂O₃—Nb₂O₅, WO₃—Cu₂O—Mn₃O₄—Nb₂O₅, and WO₃—Cu₂O—MnO—Nb₂O₅. In the systems exemplified here, NbO may exist in place of Nb₂O₅ or both Nb₂O₅ and NbO may exist.

When having a composition of, for example, W—Cu—Mn—Mo—O, recording film 12 highly possibly has any one of systems WO₃—CuO—MnO₂—MoO₃, WO₃—CuO—Mn₂O₃—MoO₃, WO₃—CuO—Mn₃O₄—MoO₃, WO₃—CuO—MnO—MoO₃, WO₃—Cu₂O—MnO₂—MoO₃, WO₃—Cu₂O—Mn₂O₃—MoO₃, WO₃—Cu₂O—Mn₃O₄—MoO₃, and WO₃—Cu₂O—MnO—MoO₃.

When having a composition of, for example, W—Cu—Mn—Ta—O, recording film highly possibly has any one of systems WO₃—CuO—MnO₂—Ta₂O₅, WO₃—CuO—Mn₂O₃—Ta₂O₅, WO₃—CuO—Mn₃O₄—Ta₂O₅, WO₃—CuO—MnO—Ta₂O₅, WO₃—Cu₂O—MnO₂—Ta₂O₅, WO₃—Cu₂O—Mn₂O₃—Ta₂O₅, WO₃—Cu₂O—Mn₃O₄—Ta₂O₅, and WO₃—Cu₂O—MnO—Ta₂O₅.

When having a composition of, for example, W—Cu—Mn—Ti—O, recording film 12 highly possibly has any one of systems WO₃—CuO—MnO₂—TiO₂, WO₃—CuO—Mn₂O₃—TiO₂, WO₃—CuO—Mn₃O₄—TiO₂, WO₃—CuO—MnO—TiO₂, WO₃—Cu₂O—MnO₂—TiO₂, WO₃—Cu₂O—Mn₂O₃—TiO₂, WO₃—Cu₂O—Mn₃O₄—TiO₂, and WO₃—Cu₂O—MnO—TiO₂. TiOₓ may exist in place of TiO₂ or both TiO₂ and TiOₓ may exist.

Any of the systems exemplified above may contain Zn. In that case, Zn is considered to be contained in a ZnO form.

As described above, when recording film 12 contains a plurality of oxides, the composition of the elements except oxygen, i.e., W, Cu, Mn, and the M is represented by WₓCu_{y}Mn_{z}M_{100-x-y-z} (atom %), and, x, y, and z satisfy 15≤x≤60, y z, 0<z≤40, and 60≤x+y+z≤98 and preferably satisfy 0.5≤(x/z)≤3.0 in the formula, it is possible to obtain an amount of light for reproduction that allows securement of a S/N necessary for recording and reproducing a large amount (for example, 500 GB per one disc) of information.

A proportion of the oxygen contained in recording film 12 may range, for example, from 60 atom % to 80 atom %, inclusive, particularly from 63 atom % to 73 atom %, inclusive, with a total number of atoms of the W, the Cu, the Mn, the M, the oxygen, and the possibly added Zn defined as 100%. With the proportion of the oxygen being less than 60 atom %, the recording sensitivity becomes good to decrease the power for recording, lowering, due to the decrease, the power for reproduction to sometimes decrease the amount of light for reproduction. With the proportion of the oxygen being more than 80 atom %, the recording sensitivity is excessively degraded to require high power for recording and thus make high-speed recording difficult.

Recording film 12 may be substantially made of W, Cu, Mn, the M, oxygen, and possibly added Zn. Here, the term “substantially” is used in consideration of cases in which when formed by, for example, sputtering, recording film 12 sometimes inevitably contains other elements derived from a rare gas (Ar, Kr, or Xe) moisture, organic matter (C), and air that exist in a sputtering atmosphere and impurities contained in a jig and a sputtering target that are disposed in a sputtering chamber. When all atoms contained in recording film 12 are defined as 100 atom %, these inevitable components may be contained up to 10 atom % as an upper limit. This also similarly applies to cases in which the term “substantially” is used for the other recording films described later.

Recording film 12 may have a thickness ranging, for example, from 10 nm to 50 nm, inclusive, particularly from 20 nm to 40 nm, inclusive. Recording film 12 that has a thickness of less than 10 nm is not sufficiently expanded not to sometimes allow formation of a good recording mark, resulting in degradation of the channel bit error rate. Recording film 12 that has a thickness of more than 50 nm becomes good in recording sensitivity to decrease the power for recording, lowering, due to the decrease, the power for reproduction to sometimes decrease the amount of light for reproduction. Further, recording film 12 that has a thickness of more than 50 nm prolongs time (sputtering time) required for forming recording film 12 to sometimes lower the productivity.

It is possible to analyze the composition of recording film 12, for example, with an X-ray micro analyzer (XMA) or by energy dispersive X-ray spectrometry (EDS) or Rutherford backscattering spectrometry (RBS).

Second dielectric film 13 has, similarly to first dielectric film 11, an action of adjusting an optical phase difference to control signal amplitude and an action of controlling a bulge of a recording pit to control signal amplitude. Second dielectric film 13 also has an action of suppressing ingress of moisture from intermediate separation layer 2 into recording film 12 and an action of suppressing escape of oxygen in recording film 12 to exterior. Second dielectric film 13 also has functions of suppressing incorporation of organic matter from intermediate separation layer 2 into recording film 12 and securing adhesiveness between L0 layer 10 and intermediate separation layer 2.

Second dielectric film 13 may be one that contains, similarly to first dielectric film 11, an oxide of the D1 and may be one that has a different composition. As described above, the composition of dielectric film 13 has a smaller influence on the amount of light for reproduction of L0 layer 10 than the composition of first dielectric film 11, so that the composition of second dielectric film 13 is not particularly limited. Second dielectric film 13 may have, for example, the same composition as the dielectric film employed in the first-generation Archival Disc.

Second dielectric film 13 may be, for example, one that contains an oxide of D2. The D2 represents at least one element selected from a third group consisting of Nb, Mo, Ta, W, Ti, Bi, Ce, Zr, In, Sn, and Si. Among the D2, Nb, Mo, Ta, W, Ti, Bi, and Ce correspond to the D1. Accordingly, when second dielectric film 13 contains the oxide of these elements, L0 layer 10 increases the reflectance to tend to increase the amount of light for reproduction. Oxides of Zr, In, Sn, and Si are capable of increasing adhesiveness between second dielectric film 13 and intermediate separation layer 2.

Second dielectric film 13 may contain one oxide of the D2 (may be unitary), and in that case, second dielectric film 13 may contain any one of, for example, Nb₂O₅, MoO₃, Ta₂O₅, WO₃, TiO₂, Bi₂O₃, CeO₂, ZrO₂, In₂O₃, SnO₂, and SiO₂. These are transparent oxides and well adhere to intermediate separation layer 2.

Second dielectric film 13 is a nanometer-order thin film formed by, for example, sputtering. Therefore, the oxide contained in second dielectric film 13 sometimes does not strictly give a stoichiometric composition due to deficiency of oxygen and/or a metal during sputtering and due to incorporation of inevitable impurities. Because of this reason, the oxide contained in second dielectric film 13 does not necessarily have to be one having a stoichiometric composition in the present exemplary embodiment and the other exemplary embodiments. As described above, the materials represented by stoichiometric compositions in the present specification include one that does not strictly have a stoichiometric composition due to, for example, deficiency of oxygen and/or a metal and due to incorporation of impurities.

In order to make second dielectric film 13 conductive, NbOₓ (x<2.5, corresponding to oxygen-deficient Nb₂O₅) or TiOₓ (x<2, corresponding to oxygen-deficient TiO₂) may be used. Second dielectric film 13 preferably has a specific resistance value of less than or equal to 1 Ωcm. This also similarly applies to second dielectric films 23, 33 described later.

Second dielectric film 13 may be made of a mixture of two or more oxides selected from these oxides or may be made of a composite oxide formed of two or more oxides selected from these oxides. When containing two metal elements as the D2 (when being binary), second dielectric film 13 may have a composition of, for example, Nb₂O₅—MoO₃, Nb₂O₅—Ta₂O₅, Nb₂O₅—WO₃, Nb₂O₅—TiO₂, Nb₂O₅—Bi₂O₃, Nb₂O₅—CeO₂, Nb₂O₅—ZrO₂, Nb₂O₅—In₂O₃, Nb₂O₅—SnO₂, Nb₂O₅—SiO₂, MoO₃—Ta₂O₅, MoO₃—WO₃, MoO₃—TiO₂, MoO₃—Bi₂O₃, MoO₃—CeO₂, MoO₃—ZrO₂, MoO₃—In₂O₃, MoO₃—SnO₂, MoO₃—SiO₂, Ta₂O₅—WO₃, Ta₂O₅—TiO₂, Ta₂O₅—Bi₂O₃, Ta₂O₅—CeO₂, Ta₂O₅—ZrO₂, Ta₂O₅—In₂O₃, Ta₂O₅—SnO₂, Ta₂O₅—SiO₂, WO₃—TiO₂, WO₃—Bi₂O₃, WO₃—CeO₂, WO₃—ZrO₂, WO₃—In₂O₃, WO₃—SnO₂, WO₃—SiO₂, TiO₂—Bi₂O₃, TiO₂—CeO₂, TiO₂—ZrO₂, TiO₂—In₂O₃, TiO₂—SnO₂, TiO₂—SiO₂, Bi₂O₃—CeO₂, Bi₂O₃—ZrO₂, Bi₂O₃—In₂O₃, Bi₂O₃—SnO₂, Bi₂O₃—SiO₂, CeO₂—ZrO₂, CeO₂—In₂O₃, CeO₂—SnO₂, CeO₂—SiO₂, ZrO₂—In₂O₃, ZrO₂—SnO₂, ZrO₂—SiO₂, In₂O₃—SnO₂, In₂O₃—SiO₂, or SnO₂—SiO₂. In the binary compositions, a mixing ratio between oxides is not particularly limited.

When containing three metal elements as the D2 (when being ternary), second dielectric film 13 may have a composition of, for example, Nb₂O₅—MoO₃—Ta₂O₅, Nb₂O₅—MoO₃—WO₃, Nb₂O₅—MoO₃—TiO₂, Nb₂O₅—MoO₃—Bi₂O₃, Nb₂O₅—MoO₃—CeO₂, Nb₂O₅—MoO₃—ZrO₂, Nb₂O₅—MoO₃—In₂O₃, Nb₂O₅—MoO₃—SnO₂, Nb₂O₅—MoO₃—SiO₂, Nb₂O₅—Ta₂O₅—WO₃, Nb₂O₅—Ta₂O₅—TiO₂, Nb₂O₅—Ta₂O₅—Bi₂O₃, Nb₂O₅—Ta₂O₅—CeO₂, Nb₂O₅—Ta₂O₅—ZrO₂, Nb₂O₅—Ta₂O₅—In₂O₃, Nb₂O₅—Ta₂O₅—SnO₂, Nb₂O₅—Ta₂O₅—SiO₂, Nb₂O₅—WO₃—TiO₂, Nb₂O₅—WO₃—Bi₂O₃, Nb₂O₅—WO₃—CeO₂, Nb₂O₅—WO₃—ZrO₂, Nb₂O₅—WO₃—In₂O₃, Nb₂O₅—WO₃—SnO₂, Nb₂O₅—WO₃—SiO₂, Nb₂O₅—TiO₂—Bi₂O₃, Nb₂O₅—TiO₂—CeO₂, Nb₂O₅—TiO₂—ZrO₂, Nb₂O₅—TiO₂—In₂O₃, Nb₂O₅—TiO₂—SnO₂, Nb₂O₅—TiO₂—SiO₂, Nb₂O₅—Bi₂O₃—CeO₂, Nb₂O₅—Bi₂O₃—ZrO₂, Nb₂O₅—Bi₂O₃—In₂O₃, Nb₂O₅—Bi₂O₃—SnO₂, Nb₂O₅—Bi₂O₃—SiO₂, Nb₂O₅—CeO₂—ZrO₂, Nb₂O₅—CeO₂—In₂O₃, Nb₂O₅—CeO₂—SnO₂, Nb₂O₅—CeO₂—SiO₂, Nb₂O₅—ZrO₂—In₂O₃, Nb₂O₅—ZrO₂—SnO₂, Nb₂O₅—ZrO₂—SiO₂, Nb₂O₅—In₂O₃—SnO₂, Nb₂O₅—In₂O₃—SiO₂, Nb₂O₅—SnO₂—SiO₂, MoO₃—Ta₂O₅—WO₃, MoO₃—Ta₂O₅—TiO₂, MoO₃—Ta₂O₅—Bi₂O₃, MoO₃—Ta₂O₅—CeO₂, MoO₃—Ta₂O₅—ZrO₂, MoO₃—Ta₂O₅—In₂O₃, MoO₃—Ta₂O₅—SnO₂, MoO₃—Ta₂O₅—SiO₂, MoO₃—WO₃—TiO₂, MoO₃—WO₃—Bi₂O₃, MoO₃—WO₃—CeO₂, MoO₃—WO₃—ZrO₂, MoO₃—WO₃—In₂O₃, MoO₃—WO₃—SnO₂, MoO₃—WO₃—SiO₂, MoO₃—TiO₂—Bi₂O₃, MoO₃—TiO₂—CeO₂, MoO₃—TiO₂—ZrO₂, MoO₃—TiO₂—In₂O₃, MoO₃—TiO₂—SnO₂, MoO₃—TiO₂—SiO₂, MoO₃—Bi₂O₃—CeO₂, MoO₃—Bi₂O₃—ZrO₂, MoO₃—Bi₂O₃—In₂O₃, MoO₃—Bi₂O₃—SnO₂, MoO₃—Bi₂O₃—SiO₂, MoO₃—CeO₂—ZrO₂, MoO₃—CeO₂—In₂O₃, MoO₃—CeO₂—SnO₂, MoO₃—CeO₂—SiO₂, MoO₃—ZrO₂—In₂O₃, MoO₃—ZrO₂—SnO₂, MoO₃—ZrO₂—SiO₂, MoO₃—In₂O₃—SnO₂, MoO₃—In₂O₃—SiO₂, MoO₃—SnO₂—SiO₂, Ta₂O₅—WO₃—TiO₂, Ta₂O₅—WO₃—Bi₂O₃, Ta₂O₅—WO₃—CeO₂, Ta₂O₅—WO₃—ZrO₂, Ta₂O₅—WO₃—In₂O₃, Ta₂O₅—WO₃—SnO₂, Ta₂O₅—WO₃—SiO₂, Ta₂O₅—TiO₂—Bi₂O₃, Ta₂O₅—TiO₂—CeO₂, Ta₂O₅—TiO₂—ZrO₂, Ta₂O₅—TiO₂—In₂O₃, Ta₂O₅—TiO₂—SnO₂, Ta₂O₅—TiO₂—SiO₂, Ta₂O₅—Bi₂O₃—CeO₂, Ta₂O₅—Bi₂O₃—ZrO₂, Ta₂O₅—Bi₂O₃—In₂O₃, Ta₂O₅—Bi₂O₃—SnO₂, Ta₂O₅—Bi₂O₃—SiO₂, Ta₂O₅—CeO₂—ZrO₂, Ta₂O₅—CeO₂—In₂O₃, Ta₂O₅—CeO₂—SnO₂, Ta₂O₅—CeO₂—SiO₂, Ta₂O₅—ZrO₂—In₂O₃, Ta₂O₅—ZrO₂—SnO₂, Ta₂O₅—ZrO₂—SiO₂, Ta₂O₅—In₂O₃—SnO₂, Ta₂O₅—In₂O₃—SiO₂, Ta₂O₅—SnO₂—SiO₂, WO₃—TiO₂—ZrO₂, WO₃—TiO₂—In₂O₃, WO₃—TiO₂—SnO₂, WO₃—TiO₂—SiO₂, WO₃—Bi₂O₃—ZrO₂, WO₃—Bi₂O₃—In₂O₃, WO₃—Bi₂O₃—SnO₂, WO₃—Bi₂O₃—SiO₂, WO₃—CeO₂—ZrO₂, WO₃—CeO₂—In₂O₃, WO₃—CeO₂—SnO₂, WO₃—CeO₂—SiO₂, WO₃—ZrO₂—In₂O₃, WO₃—ZrO₂—SnO₂, WO₃—ZrO₂—SiO₂, WO₃—In₂O₃—SnO₂, WO₃—In₂O₃—SiO₂, WO₃—SnO₂—SiO₂, TiO₂—Bi₂O₃—ZrO₂, TiO₂—Bi₂O₃Bi₂O₃, TiO₂—Bi₂O₃—SiO₂, TiO₂—Bi₂O₃—SiO₂, TiO₂—CeO₂—ZrO₂, TiO₂—CeO₂—In₂O₃, TiO₂—CeO₂—SnO₂, TiO₂—CeO₂—SiO₂, TiO₂—ZrO₂—In₂O₃, TiO₂—ZrO₂—SnO₂, TiO₂—ZrO₂—SiO₂, TiO₂—In₂O₃—SnO₂, TiO₂—In₂O₃—SiO₂, TiO₂—SnO₂—SiO₂, Bi₂O₃—CeO₂—ZrO₂, Bi₂O₃—CeO₂—In₂O₃, Bi₂O₃—CeO₂—SnO₂, Bi₂O₃—CeO₂—SiO₂, Bi₂O₃—ZrO₂—In₂O₃, Bi₂O₃—ZrO₂—SnO₂, Bi₂O₃—ZrO₂—SiO₂, Bi₂O₃—In₂O₃—SnO₂, Bi₂O₃—In₂O₃—SiO₂, Bi₂O₃—SnO₂—SiO₂, CeO₂—ZrO₂—In₂O₃, CeO₂—ZrO₂—SnO₂, CeO₂—ZrO₂—SiO₂, CeO₂—In₂O₃—SnO₂, CeO₂—In₂O₃—SiO₂, CeO₂—SnO₂—SiO₂, ZrO₂—In₂O—SnO₂, ZrO₂—In₂O—SiO₂, ZrO₂—SnO₂—SiO₂, or In₂O₃—SnO₂—SiO₂. In the ternary compositions, a mixing ratio among oxides is not particularly limited.

In the unitary to ternary compositions exemplified above, NbOₓ may be used in place of Nb₂O₅ and TiOₓ may be used in place of TiO₂. This also similarly applies to second dielectric films 23, 33 described later.

Second dielectric film 13 may contain, for example, more than or equal to 50 mol % of the oxide of the D2 or may be substantially made of the oxide of the D2. A meaning of the term “substantially” is as described before in relation to first dielectric film 11. When a proportion of the oxide of the D2 is excessively small, it is impossible to increase the reflectance, sometimes becoming unable to increase the amount of light for reproduction or sometimes lowering the adhesiveness between second dielectric film 13 and intermediate separation layer 2.

The oxide of the D2 may be an oxide of at least one element selected particularly from a group consisting of Nb, Mo, Ta, Zr, In, Sn, and Si. The oxide of these elements are capable of further increasing the reflectance of L0 layer 10 and/or increasing the adhesiveness between second dielectric film 13 and intermediate separation layer 2. The oxide of at least one element selected from Nb, Mo, Ta, Zr, In, Sn, and Si may be contained in an amount of more than or equal to 50 mol %. Alternatively, second dielectric film 13 may be substantially made of the oxide of at least one element selected from Nb, Mo, Ta, Zr, In, Sn, and Si.

When the binary and ternary compositions exemplified above include the oxide of at least one element selected from Nb, Mo, Ta, Zr, In, Sn, and Si, the oxide may be contained in an amount of more than or equal to 50 mol %.

When second dielectric film 13 has a composition of, for example, Nb₂O₅—MoO₃—Ta₂O₅ or ZrO₂—In₂O₃—SiO₂, a mixing ratio is not particularly limited and may be any ratio. When having a composition of Nb₂O₅—MoO₃—WO₃, second dielectric film 13 preferably contains more than or equal to 50 mol % of Nb₂O₅—MoO₃ (mixture of two oxides).

When first dielectric film 11 and/or second dielectric film 13 contains ZrO₂, stable zirconia (one obtained by doping ZrO₂ with less than or equal to 10% of Y₂O₃, MgO, or CaO) may be used as the ZrO₂. This also similarly applies to first dielectric films 21, 31 and second dielectric films 23, 33 described later.

Second dielectric film 13 may have a thickness ranging, for example, from 5 nm to 30 nm, inclusive. Second dielectric film 13 that has a thickness of less than 5 nm lowers a protection function and is thus sometimes incapable of suppressing ingress of moisture into recording film 12. Second dielectric film 13 that has a thickness of more than 30 nm decreases the reflectance of L0 layer 10

It is possible to design specific thickness of first dielectric film 11, recording film 12, and second dielectric film 13 by calculation based on a matrix method (for example, see “Wave Optics” by Hiroshi Kubota, Section 3, Iwanami Shoten, 1971). Adjustment of the thickness of each film enables adjustment of the reflectance of recorded or unrecorded recording film 12 and a phase difference of reflected light between a recorded portion and an unrecorded portion to optimize the signal quality of a reproduction signal.

Next, a configuration of L1 layer 20 is described. L1 layer 20 is formed by stacking, on a surface of intermediate separation layer 2, at least first dielectric film 21, recording film 22, and second dielectric film 23 in this order.

First dielectric film 21 has the same functions as first dielectric film 11 in L0 layer 10 described above. First dielectric film 21 also has a role of making L1 layer 20 adhere to intermediate separation layer 2. Unlike first dielectric film 11, composition of first dielectric film 21 is not limited. This is because L1 layer 20 that is located nearer to the laser beam 6 incident surface than L0 layer 10 easily secures the effective reflectance and the amount of light for reproduction of L1 layer 20 without specification of the composition of first dielectric film 21. Accordingly, first dielectric film 21 may be formed using the materials exemplified in relation to first dielectric film 11 or second dielectric film 13 or may be formed using another material, for example, a material having a smaller refractive index than the material used for first dielectric film 11.

First dielectric film 21 may have a composition of, for example, ZrO₂—SiO₂, ZrO₂—In₂O₃, ZrO₂—SnO₂, In₂O₃—SiO₂, In₂O₃—SnO₂, SnO₂—SiO₂, ZrO₂—SiO₂—In₂O₃, ZrO₂—SiO₂—SnO₂, ZrO₂—In₂O₃—SnO₂, or In₂O₃—SnO₂—SiO₂. It is possible to form ZrO₂—SiO₂—In₂O₃ and In₂O₃—SnO₂ films by DC sputtering.

It is possible to obtain higher power for reproduction by making an amount of Zr larger than an amount of Si in first dielectric film 21. This is because making the amount of Zr larger than the amount of Si enables alleviation of an adverse effect of organic matter and moisture desorbed from intermediate separation layer 2 on first dielectric film 21, to be capable of suppressing degradation of the reproduction durability.

First dielectric film 21 may have a thickness ranging from 10 nm to 50 nm, inclusive. First dielectric film 21 that has a thickness of less than 10 nm lowers adhesiveness to intermediate separation layer 2 to sometimes lower a protection function of suppressing ingress of moisture into recording film 22. First dielectric film 21 that has a thickness of more than 50 nm sometimes lowers the reflectance of L1 layer 20. Further, first dielectric film 21 that has a thickness of more than 50 nm prolongs time (sputtering time) required for forming first dielectric film 21 to sometimes lower the productivity.

Recording film 22 has the same functions as recording film 12 in L0 layer 10 described above. In general, L1 layer 20 easily gives a higher effective reflectance and a larger amount of light for reproduction than L0 layer 10 as described above, so that unlike recording film 12, composition of recording film 22 is not limited. Accordingly, recording film 22 may be formed using the same materials as exemplified in relation to recording film 12 or may be formed using another material, for example, a material containing W, Cu, and Mn but not the M. Recording film 22 may further contain Zn.

More specifically, recording film 22 may be, similarly to recording film 12, formed of a material containing W, Cu, Mn, the M, and oxygen, with composition of the W, the Cu, the Mn, and the M represented by WₓCu_{y}Mn_{z}M_{100-x-y-z} (atom %) (in the formula, 15≤x≤60, y≤z, 0<z≤40, and 60≤x+y+z≤98). In that case, it is possible to increase the transmittance of L1 layer 20 and thus improve the reflectance of L0 layer 10, that is, to increase the amount of light for reproduction of L0 layer 10.

L1 layer 20 that is positioned nearer to laser beam 6 than L0 layer 10 easily increases the effective reflectance of L1 layer 20. Therefore, recording film 22 may be formed of a material having a smaller value of z (amount of Mn) than the material for recording film 12 in L0 layer 10, to prioritize securement of a high transmittance. In the formula, z may satisfy, for example, 10 z≤30. A value of x (amount of W) may be increased by a reduced amount of z.

Alternatively, recording film 22 may be formed of the same material as the recording film of the first-generation Archival Disc. In that case, it is possible to use, in production of the information recording medium according to the present exemplary embodiment, a sputtering target used in production of the first-generation Archival Disc and thus to sometimes improve the productivity or reduce costs. More specifically, recording film 22 may be formed of, for example, W—Cu—Mn—Zn—O.

A proportion of the oxygen contained in recording film 22 may range, for example, from 60 atom % to 80 atom %, inclusive, particularly from 65 atom % to 75 atom %, inclusive, with a total number of atoms of the metal elements and the oxygen defined as 100%.

Recording film 22 may have a film thickness ranging from 15 nm to 50 nm, inclusive, particularly from 25 nm to 45 nm, inclusive. Recording film 22 that has a film thickness of less than 15 nm is not sufficiently expanded not to allow formation of a good recording mark, resulting in degradation of the channel bit error rate. Recording film 22 that has a film thickness of more than 50 nm becomes good in recording sensitivity to decrease the power for recording, lowering, due to the decrease, the power for reproduction to sometimes decrease the amount of light for reproduction. Further, recording film 22 that has a thickness of more than 50 nm prolongs time (sputtering time) required for forming recording film 22 to sometimes lower the productivity.

Second dielectric film 23 has the same functions as second dielectric film 13 in L0 layer 10 described above. Composition of second dielectric film 23 is not particularly limited. This is because L1 layer 20 that is located nearer to the laser beam 6 incident surface than L0 layer 10 easily secures the effective reflectance and the amount of light for reproduction of L1 layer 20 without specification of the composition of second dielectric film 23. It is possible to form second dielectric film 23 using the materials exemplified in relation to first dielectric film 11 or second dielectric film 13. Alternatively, second dielectric film 23 may be formed using another material, for example, a material having a smaller refractive index than the material used for first dielectric film 11.

Second dielectric film 23 may have a composition of, for example, ZrO₂, SiO₂, In₂O₃, SnO₂, ZrO₂—SiO₂, ZrO₂—In₂O₃, ZrO₂—SnO₂, In₂O₃—SiO₂, In₂O₃—SnO₂, SnO₂—SiO₂, ZrO₂—SiO₂—In₂O₃, ZrO₂—SiO₂—SnO₂, ZrO₂—In₂O₃—SnO₂, or In₂O₃—SnO₂—SiO₂. It is possible to form ZrO₂—SiO₂—In₂O₃ and In₂O₃—SnO₂ films by DC sputtering.

Second dielectric film 23 may have a thickness ranging from 5 nm to 30 nm, inclusive. Second dielectric film 23 that has a thickness of less than 5 nm lowers a protection function and is thus sometimes incapable of suppressing ingress of moisture into recording film 22, and second dielectric film 23 that has a thickness of more than 30 nm sometimes decreases the reflectance of L1 layer 20.

Next, a configuration of L2 layer 30 is described. L2 layer 30 is formed by stacking, on a surface of intermediate separation layer 3, at least first dielectric film 31, recording film 32, and second dielectric film 33 in this order.

The configuration of L2 layer 30 is basically the same as the configuration of L1 layer 20. First dielectric film 31 has the same functions as first dielectric film 21 in L1 layer 20 and therefore has the same functions as first dielectric film 11 in L0 layer 10. First dielectric film 31 also has a role of making L2 layer 30 adhere to intermediate separation layer 3. Composition of first dielectric film 31 is not particularly limited similarly to first dielectric film 21. This is because L2 layer 30 that is positioned on an outermost end of the information recording medium easily secures the effective reflectance and the amount of light for reproduction of L2 layer 30 without specification of the composition of first dielectric film 31. Accordingly, it is possible to form first dielectric film 31 using the materials exemplified in relation to first dielectric film 11 and second dielectric film 13 in L0 layer 10. Alternatively, first dielectric film 31 may be formed using another material. First dielectric film 31 may be formed of, for example, a material having a smaller refractive index than the material used for first dielectric film 11. In that case, first dielectric film 31 may be formed of the materials described in relation to first dielectric film 21 in L1 layer 20.

First dielectric film 31 may have a thickness ranging from 10 nm to 50 nm, inclusive. First dielectric film 31 that has a thickness of less than 10 nm lowers adhesiveness to intermediate separation layer 3 to sometimes lower a protection function of suppressing ingress of moisture into recording film 32. First dielectric film 31 that has a thickness of more than 50 nm sometimes lowers the reflectance of L2 layer 30. Further, first dielectric film 31 that has a thickness of more than 50 nm prolongs time (sputtering time) required for forming first dielectric film 31 to sometimes lower the productivity.

Recording film 32 has the same functions as recording film 22 in L1 layer 20 and therefore has the same functions as recording film 12 in L0 layer 10. As described above, L2 layer 30 that is positioned on the outermost end easily gives a larger amount of light for reproduction than L1 layer 20 and L0 layer 10, so that unlike recording film 12, composition of recording film 32 is not limited. Accordingly, it is possible to form recording film 32 using, similarly to recording film 22, the materials exemplified in relation to recording film 12 in L0 layer 10. Alternatively, recording film 32 may be formed using another material, for example, a material containing W, Cu, and Mn but not the M. Recording film 32 may further contain Zn.

More specifically, recording film 32 may be, similarly to recording film 12, formed of a material containing W, Cu, Mn, the M, and oxygen, with composition of the W, the Cu, the Mn, and the M represented by WₓCu_{y}Mn_{z}M_{100-x-y-z} (atom %) (in the formula, 15≤x≤60, y≤z, 0<z≤40, and 60≤x+y+z≤98). In that case, it is possible to increase the transmittance of L2 layer 30 and thus improve the reflectance of L0 layer 10, that is, to increase the amount of light for reproduction of L0 layer 10.

L2 layer 30 that is positioned nearest to laser beam 6 easily increases the effective reflectance of L2 layer 30. Therefore, recording film 32 may be formed of a material having a smaller value of z (amount of Mn) than the materials for recording film 12 in L0 layer 10 and recording film 22 in L1 layer 20, to prioritize securement of a high transmittance. In the formula, z may satisfy, for example, 5≤z≤30. A value of x (amount of W) may be increased by a reduced amount of z.

Alternatively, recording film 32 may be formed of the same material as the recording film of the first-generation Archival Disc. In that case, it is possible to use, in production of the information recording medium according to the present exemplary embodiment, a sputtering target used in production of the first-generation Archival Disc and thus to sometimes improve the productivity or reduce costs. More specifically, recording film 32 may be formed of, for example, W—Cu—Mn—Zn—O.

A proportion of the oxygen contained in recording film 32 may, similarly to the proportion in recording film 22, range, for example, from 60 atom % to 80 atom %, inclusive, particularly from 65 atom % to 75 atom %, inclusive, with a total number of atoms of the metal elements and the oxygen defined as 100%.

Recording film 32 may have a film thickness ranging from 15 nm to 50 nm, inclusive, particularly from 25 nm to 45 nm, inclusive. Recording film 32 that has a film thickness of less than 15 nm is not sufficiently expanded not to allow formation of a good recording mark, resulting in degradation of the channel bit error rate. Recording film 32 that has a film thickness of more than 50 nm becomes good in recording sensitivity to decrease the power for recording, lowering, due to the decrease, the power for reproduction to sometimes decrease the amount of light for reproduction. Further, recording film 32 that has a thickness of more than 50 nm prolongs time (sputtering time) required for forming recording film 32 to sometimes lower the productivity.

Second dielectric film 33 has the same functions as second dielectric film 23 in L1 layer 20 and therefore has the same functions as second dielectric film 13 in L0 layer 10. Composition of second dielectric film 33 is not particularly limited similarly to second dielectric film 23. This is because L2 layer 30 that is positioned on the outermost end easily gives a larger amount of light for reproduction than L1 layer 20 and L0 layer 10 and easily secures the effective reflectance and the amount of light for reproduction of L2 layer 30 without specification of the composition of second dielectric film 33. Accordingly, it is possible to form second dielectric film 33 using the materials exemplified in relation to first dielectric film 11 and second dielectric film 13 in L0 layer 10. Alternatively, second dielectric film 33 may be formed using another material. Second dielectric film 33 may be formed of, for example, a material having a smaller refractive index than the material used for first dielectric film 11. In that case, second dielectric film 33 may be formed of the materials described in relation to second dielectric film 23 in L1 layer 20.

Second dielectric film 33 may have a thickness ranging from 5 nm to 30 nm, inclusive. Second dielectric film 33 that has a thickness of less than 5 nm lowers a protection function and is thus sometimes incapable of suppressing ingress of moisture into recording film 32. Second dielectric film 33 that has a thickness of more than 30 nm sometimes lowers the reflectance of L2 layer 30.

First dielectric films 11, 21, 31, recording films 12, 22, 32, and second dielectric films 13, 23, 33 may be formed by radio frequency (RF) sputtering or DC sputtering, using a sputtering target obtained by mixing oxides that constitute these films. Alternatively, these films may be formed by RF sputtering with introduction of oxygen or DC sputtering with introduction of oxygen, using an alloy sputtering target containing no oxygen. Alternatively, these films may be formed by a method for attaching sputtering targets of oxides to separate power sources, respectively and simultaneously performing RF sputtering or DC sputtering (multi-sputtering method). RF sputtering and DC sputtering may be performed simultaneously. Further, exemplified as another film forming method is a method for attaching sputtering targets made of metal elementary substances or alloys, or sputtering targets of oxides to separate power sources, respectively and simultaneously performing RF sputtering or DC sputtering with introduction of oxygen as necessary. Alternatively, these films may be formed by a method for performing RF sputtering or DC sputtering, using a sputtering target formed by mixing a metal with an oxide, with introduction of oxygen.

In a modified example of the first exemplary embodiment, the recording film in any one of the information layers of information recording medium 100 according to the present exemplary embodiment may be another recording film made of, for example, Te—O—Pd or Ge—Bi—O, that is, a recording film other than the W—O recording film. Alternatively, in another modified example, a reflective film or a dielectric film made of a material not exemplified above may be provided as necessary. Effects of a technique according to the present disclosure are achieved also in these modified examples.

In another modified example, a combination of the first dielectric film having a specific composition with the recording film having a specific composition may be attained in another information layer in addition to or in place of the L0 layer. The combination of the first dielectric film having a specific composition with the recording film having a specific composition is effective to improve the amount of light for reproduction of the L0 layer that easily lowers the amount of light for reproduction, and when such a combination is used in another information layer, it is possible to improve the amount of light for reproduction in the other information layer.

Use of the combination of the first dielectric film having a specific composition with the recording film having a specific composition in the L1 layer or the L2 layer enables an increase in the transmittance of the L1 layer or the L2 layer to be capable of increasing the amount of laser beam 6 that reaches the L0 layer and thus improving the effective reflectance of the L0 layer, resulting in an improvement of the amount of light for reproduction of the L0 layer. That is, it is possible to increase the S/N ratio of a short mark recorded on the L0 layer also by application of the first dielectric film having a specific composition and the recording film having a specific composition to the L1 layer and the L2 layer.

A recording method of information recording medium 100 may be any one of Constant Linear Velocity (CLV) where linear velocity is constant, Constant Angular Velocity (CAV) where a rotation rate is constant, Zoned CLV, and Zoned CAV. Applicable data bit length is 51.3 nm.

Recording and reproduction of information on and from information recording medium 100 according to the present exemplary embodiment may be performed by an optical system with an objective lens having a numerical aperture NA of 0.91 or by an optical system with an NA of more than 1. As the optical system, a solid immersion lens (SIL) or a solid immersion mirror (SIM) may be used. In this case, intermediate separation layers 2 and 3 and cover layer 4 may have a thickness of less than or equal to 5 μm. Alternatively, an optical system with near-field light may be used.

### Second Exemplary Embodiment

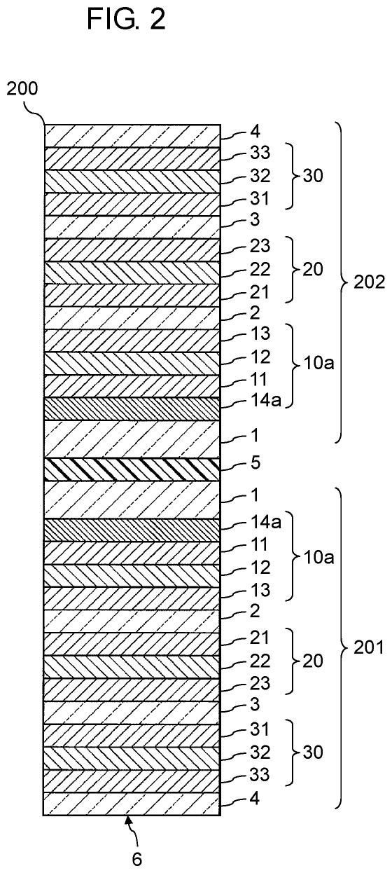

As a second exemplary embodiment, another example of the information recording medium according to the present disclosure is described. As the second exemplary embodiment, one example of the information recording medium is described that records and reproduces information with a laser beam. FIG. 2 shows a sectional view of the optical information recording medium. Information recording medium 200 according to the present exemplary embodiment is different from the first exemplary embodiment only in including A-side information recording medium 201 and B-side information recording medium 202 and including third dielectric film 14a between first dielectric film 11 and substrate 1 in L0 layer 10a.

L0 layer 10a may include third dielectric film 14a, first dielectric film 11, recording film 12, and second dielectric film 13 in this order from a L0 layer 10a's farther end toward a laser beam 6-irradiation side.

Third dielectric film 14a is provided to improve the reproduction durability and increase the power for reproduction of L0 layer 10a. Third dielectric film 14a also has a function of well adhering to first dielectric film 11 to improve adhesiveness between substrate 1 and L0 layer 10.

When the composition of first dielectric film 11 is selected as described above to be capable of improving the reflectance of L0 layer 10 but to be hardly capable of raising the power for reproduction or to decrease the power for reproduction, third dielectric film 14a may be provided as necessary. Continuous irradiation with laser beam 6 at prescribed power to reproduce a signal recorded on the L0 layer may possibly cause peeling or atom diffusion between substrate 1 and first dielectric film 11. Third dielectric film 14a may be provided to suppress such peeling or atom diffusion and thus secure good adhesiveness between substrate 1 and the L0 layer.

Third dielectric film 14a contains an oxide of D3. The D3 represents at least one element selected from a fourth group consisting of Zr, In, Sn, and Si. Third dielectric film 14a may have a composition of, for example, ZrO₂, SiO₂, In₂O₃, SnO₂, ZrO₂—SiO₂, ZrO₂—In₂O₃, ZrO₂—SnO₂, In₂O₃—SiO₂, In₂O₃—SnO₂, SnO₂—SiO₂, ZrO₂—SiO₂—In₂O₃, ZrO₂—SiO₂—SnO₂, ZrO₂—In₂O₃—SnO₂, or In₂O₃″SnO₂—SiO₂. In a mixture of binary or ternary oxides, a mixing ratio among the oxides is not particularly limited. Third dielectric film 14a may be made of a composite oxide formed of two or more oxides. Further, similarly to first dielectric film 11 in L0 layer 10 of the first exemplary embodiment, the oxide of the D3 does not necessarily have to be one having a stoichiometric composition.

Third dielectric film 14a may contain, for example, more than or equal to 50 mol % of the oxide of the D3 or may be substantially made of the oxide of the D3. A meaning of the term “substantially” is as described in relation to first dielectric film 11 of the first exemplary embodiment.

A combination of third dielectric film 14a with first dielectric film 11 may be, for example, ZrO₂ (third dielectric film 14a)/Nb₂O₅ (first dielectric film 11), ZrO₂/NbOₓ, ZrO₂/MoO₃, ZrO₂/Ta₂O₅, SiO₂/Nb₂O₅, SiO₂/NbOₓ, SiO₂/MoO₃, SiO₂/Ta₂O₅, In₂O₃/Nb₂O₅, In₂O₃/NbOₓ, In₂O/MoO₃, In₂O₃/Ta₂O₅, SnO₂/Nb₂O₅, SnO₂/NbOₓ, SnO₂/MoO₃, SnO₂/Ta₂O₅, ZrO₂—SiO₂/Nb₂O₅, ZrO₂—SiO₂/NbOₓ, ZrO₂—SiO₂/MoO₃, ZrO₂—SiO₂/Ta₂O₅, ZrO₂—In₂O₃/Nb₂O₅, ZrO₂—In₂O₃/NbOₓ, ZrO₂—In₂O₃/MoO₃, ZrO₂—In₂O₃/Ta₂O₅, ZrO₂/In₂O₃/WO₃, ZrO₂—In₂O₃/TiO₂, ZrO₂—In₂O₃/TiOₓ, ZrO₂—In₂O₃/Bi₂O₃, ZrO₂—In₂O₃/CeO₂, ZrO₂—SnO₂/Nb₂O₅, ZrO₂—SnO₂/NbOₓ, ZrO₂—SnO₂/MoO₃, ZrO₂—SnO₂/Ta₂O₅, In₂O₃—SiO₂/Nb₂O₅, In₂O₃—SiO₂/NbOₓ, In₂O₃—SiO₂/MoO₃, In₂O₃—SiO₂/Ta₂O₅, In₂O₃—SnO₂/Nb₂O₅, In₂O₃—SnO₂/NbOₓ, In₂O₃—SnO₂/MoO₃, In₂O₃—SnO₂/Ta₂O₅, In₂O₃—SnO₂/WO₃, In₂O₃—SnO₂/TiO₂, In₂O₃—SnO₂/TiOₓ, In₂O₃—SnO₂/Bi₂O₃, In₂O₃—SnO₂/CeO₂, SnO₂—SiO₂/Nb₂O₅, SnO₂—SiO₂/NbOₓ, SnO₂—SiO₂/MoO₃, SnO₂—SiO₂/Ta₂O₅, ZrO₂—SiO₂—In₂O₃/Nb₂O₅, ZrO₂—SiO₂—In₂O₃/NbOₓ, ZrO₂—SiO₂—In₂O₃/MoO₃, ZrO₂—SiO₂—In₂O₃/Ta₂O₅, ZrO₂—SiO₂—In₂O₃/WO₃, ZrO₂—SiO₂—In₂O₃/TiO₂, ZrO₂—SiO₂—In₂O₃/TiOₓ, ZrO₂—SiO₂—In₃O₃/Bi₂O₃, ZrO₂—SiO₂—In₂O₃/CeO ZrO₂—SiO₂—SiO₂/Nb₂O₅, ZrO₂—SiO₂—SnO₂/NbOₓ, ZrO₂—SiO₂—SnO₂/MoO₃, ZrO₂—SiO₂—SnO₂/Ta₂O₅, ZrO₂—In₂O₃—SnO₂/Nb₂O₅, ZrO₂—In₂O₃—SnO₂/NbOₓ, ZrO₂—In₂O₃—SnO₂/MoO₃, ZrO₂—In₂O₃—SnO₂/Ta₂O₅, In₂O₃—SnO₂—SiO₂Nb₂O₅, In₂O₃—SnO₂—SiO₂/NbOₓ, In₂O₃—SnO₂—SiO₂/MoO₃, or In₂O₃—SnO₂—SiO₂/Ta₂O₅.

Particularly, the combination of third dielectric film 14a with first dielectric film 11 may be ZrO₂—SiO₂—In₂O₃/Nb₂O₅, ZrO₂—SiO₂—In₂O₃/NbOₓ, In₂O₃—SnO₂/Nb₂O₅, or In₂O₃—SnO₂/NbOₓ. These combinations are combinations that allow formation of both third dielectric film 14a and first dielectric film 11 by DC sputtering. Accordingly, use of these combinations enables production of information recording medium 200 by DC sputtering with good productivity.

Even when first dielectric film 11 has a binary, ternary, or quaternary composition exemplified before, third dielectric film 14a may be provided.

Third dielectric film 14a may have a thickness ranging from 3 nm to 35 nm, inclusive. Third dielectric film 14a that has a thickness of less than 3 nm is sometimes incapable of sufficiently improving the adhesiveness between substrate 1 and first dielectric film 11. Third dielectric film 14a that has a thickness of more than 35 nm sometimes lowers the reflectance of L0 layer 10.

The configurations of the films and the layers other than third dielectric film 14a are identical to described in the first exemplary embodiment and are thus not described here.

In the second exemplary embodiment, third dielectric film 14a is formed between substrate 1 and first dielectric film 11. As a modified example, however, third dielectric film 14a may be formed between intermediate separation layer 2 and first dielectric film 21 or between intermediate separation layer 3 and first dielectric film 31. That is, in information recording medium 100 shown in FIG. 1, it is possible to form third dielectric film 14a between intermediate separation layer 2 and first dielectric film 21 or between intermediate separation layer 3 and first dielectric film 31.

### Third Exemplary Embodiment

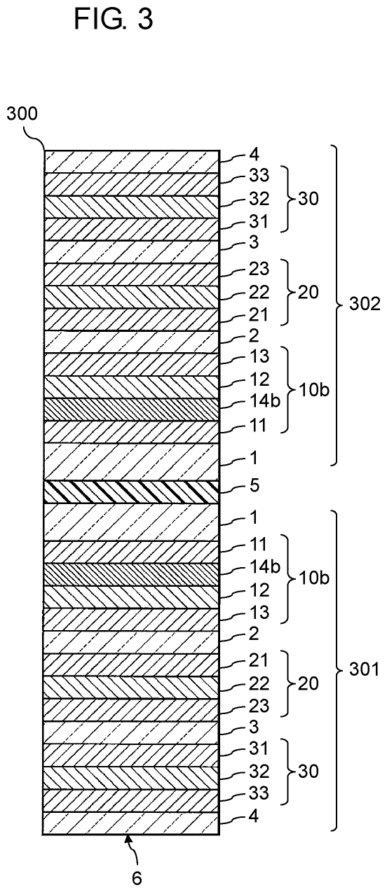

As a second exemplary embodiment, another example of the information recording medium according to the present disclosure is described. As the third exemplary embodiment, one example of the information recording medium is described that records and reproduces information with a laser beam. FIG. 3 shows a sectional view of the optical information recording medium. Information recording medium 300 according to the present exemplary embodiment is different from the first exemplary embodiment only in including A-side information recording medium 301 and B-side information recording medium 302 and including third dielectric film 14b between first dielectric film 11 and recording film 12 in L0 layer 10b.

L0 layer 10b may include first dielectric film 11, third dielectric film 14b, recording film 12, and second dielectric film 13 in this order from an L0 layer 10b's farther end toward the laser beam 6-irradiation side. Third dielectric film 14b is provided to improve the reproduction durability and increase the power for reproduction of L0 layer 10b.

When the composition of first dielectric film 11 is selected as described above to be capable of improving the reflectance of L0 layer 10 but to be hardly capable of raising the power for reproduction or to decrease the power for reproduction, third dielectric film 14b may be provided as necessary. Continuous irradiation with laser beam 6 at prescribed power to reproduce a signal recorded on the L0 layer may possibly cause peeling or atom diffusion between first dielectric film 11 and recording film 12. Third dielectric film 14b may be provided to suppress such peeling or atom diffusion and thus secure good adhesiveness between first dielectric film 11 and recording film 12.

Examples of a material constituting third dielectric film 14b are the same as the examples of the material for third dielectric film 14a described in the second exemplary embodiment. Examples of a combination of third dielectric film 14b with first dielectric film 11 are the same as the examples of the combination of third dielectric film 14a with first dielectric film 11 described in the second exemplary embodiment.

Third dielectric film 14b may have a thickness ranging from 3 nm to 35 nm, inclusive. Third dielectric film 14b that has a thickness of less than 3 nm is sometimes incapable of sufficiently improving the adhesiveness between first dielectric film 11 and recording film 12. Third dielectric film 14b that has a thickness of more than 35 nm sometimes lowers the reflectance of L0 layer 10.

Other configurations of third dielectric film 14b are identical to the configurations of third dielectric film 14a described before in the second exemplary embodiment and are thus not described here. The configurations of the films and the layers other than third dielectric film 14b are identical to described in the first exemplary embodiment and are thus not described here.

### Fourth Exemplary Embodiment

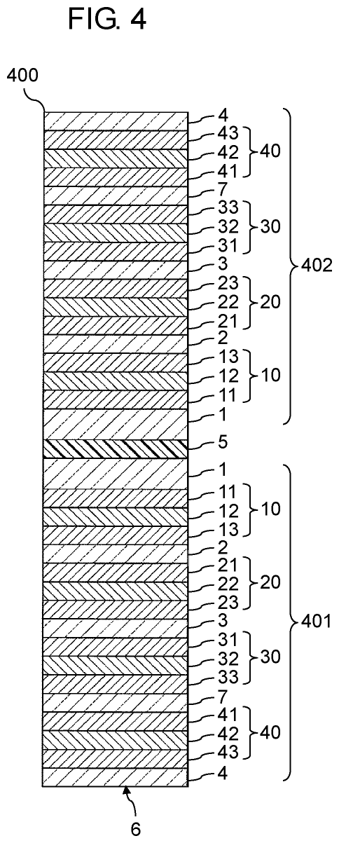

As a fourth exemplary embodiment, another example of the information recording medium according to the present disclosure is described. As the fourth exemplary embodiment, one example of the information recording medium is described that records and reproduces information with a laser beam. FIG. 4 shows a sectional view of the optical information recording medium. Information recording medium 400 according to the present exemplary embodiment is different from the first exemplary embodiment in further including L3 layer 40 as another information layer, in addition to three information layers L0 layer 10, L1 layer 20, and L2 layer 30. Intermediate separation layer 7 is provided between L3 layer 40 and L2 layer 30. A-side information recording medium 401 and B-side information recording medium 402 both include four information layers, so that information recording medium 400 include eight information layers in total.

L0 layer 10, L1 layer 20, and L2 layer 30 are the same as described in the first exemplary embodiment and are thus not described here. Functions, a shape, and a material for intermediate separation layer 7 are the same as the functions, the shape, and the material for intermediate separation layers 2 and 3 and are thus not described here. Intermediate separation layer 7 may have a different value for thickness from the values for the thickness of intermediate separation layers 2 and 3.

A configuration of L3 layer is described. L3 layer 40 is formed by stacking, on a surface of intermediate separation layer 7, at least first dielectric film 41, recording film 42, and second dielectric film 43 in this order. L3 layer 40 basically has an identical configuration to the L1 layer (and the L2 layer having the same configuration as the L1 layer).

First dielectric film 41 has the same functions as first dielectric film 21 in L1 layer 20 described in the first exemplary embodiment. First dielectric film 41 also has a role of making L3 layer 40 adhere to intermediate separation layer 7. Composition of first dielectric film 41 is not particularly limited similarly to first dielectric film 21. This is because L3 layer 40 that is positioned on an outermost end of the information recording medium easily secures the effective reflectance and the amount of light for reproduction of L3 layer 40 without specification of the composition of first dielectric film 41. Accordingly, it is possible to form first dielectric film 41 using the same materials as exemplified in relation to first dielectric film 11 and second dielectric film 13 in L0 layer 10 of the first exemplary embodiment. Alternatively, first dielectric film 41 may be formed using another material. First dielectric film 41 may be formed using, for example, a material having a smaller refractive index than the material used for first dielectric film 11. In that case, first dielectric film 41 may be formed of the materials described in relation to first dielectric film 21 in L1 layer 20 of the first exemplary embodiment.

First dielectric film 41 may have a thickness ranging from 10 nm to 50 nm, inclusive. First dielectric film 41 that has a thickness of less than 10 nm lowers adhesiveness to intermediate separation layer 7 to sometimes lower a protection function of suppressing ingress of moisture into recording film 42. First dielectric film 41 that has a thickness of more than 50 nm sometimes lowers the reflectance of L3 layer 40.

Recording film 42 has the same functions as recording film 22 in L1 layer 20 described in the first exemplary embodiment and therefore has the same functions as recording film 12 in L0 layer 10. As described above, L3 layer 40 that is positioned on the outermost end easily gives a larger amount of light for reproduction than L0 layer 10 or L2 layer 30, so that unlike recording film 12 in L0 layer 10 of the first exemplary embodiment, composition of recording film 42 is not limited. Accordingly, it is possible to form recording film 42 using, similarly to recording film 22 of the first exemplary embodiment, the materials exemplified in relation to recording film 12 in L0 layer 10 of the first exemplary embodiment. Alternatively, recording film 42 may be formed using another material, for example, a material containing W, Cu, and Mn but not the M. Recording film 42 may further contain Zn.

More specifically, recording film 42 may be, similarly to recording film 12 of the first exemplary embodiment, formed of a material containing W, Cu, Mn, the M, and oxygen, with composition of the W, the Cu, the Mn, and the M represented by WₓCu_{y}Mn_{z}M_{100-x-y-z} (atom %) (in the formula, 15≤x≤60, y≤z, 0<z≤40, and 60≤x+y+z≤98). In that case, it is possible to increase the transmittance of L3 layer 40 and thus improve the reflectance of L0 layer 10, that is, to increase the amount of light for reproduction of L0 layer 10.

L3 layer 40 that is positioned nearest to laser beam 6 easily increases the effective reflectance of L3 layer 40. Therefore, recording film 42 may be formed of a material having a smaller value of z (amount of Mn) than recording film 12 in L0 layer 10, recording film 22 in L1 layer 20, and recording film 32 in L2 layer 30, to prioritize securement of a high transmittance. In the formula, z may satisfy, for example, 5 z≤30. A value of x (amount of W) may be increased by a reduced amount of z.

Alternatively, recording film 42 may be formed of the same material as the recording film of the first-generation Archival Disc. In that case, it is possible to use, in production of the information recording medium according to the present exemplary embodiment, a sputtering target used in production of the first-generation Archival Disc and thus to sometimes improve the productivity or reduce costs. More specifically, recording film 42 may be formed of, for example, W—Cu—Mn—Zn—O.

A proportion of the oxygen contained in recording film 42 may range, for example, from 60 atom % to 80 atom %, inclusive, particularly from 65 atom % to 75 atom %, inclusive, with a total number of atoms of the metal elements and the oxygen defined as 100%.

Recording film 42 may have a film thickness ranging from 15 nm to 50 nm, inclusive, particularly from 25 nm to 45 nm, inclusive. Recording film 42 that has a film thickness of less than 15 nm is not sufficiently expanded not to allow formation of a good recording mark, resulting in degradation of the channel bit error rate. Recording film 42 that has a film thickness of more than 50 nm becomes good in recording sensitivity to decrease the power for recording, lowering, due to the decrease, the power for reproduction to sometimes decrease the amount of light for reproduction. Further, recording film 42 that has a thickness of more than 50 nm prolongs time (sputtering time) required for forming recording film 42 to sometimes lower the productivity.

Second dielectric film 43 has the same functions as second dielectric film 23 in L1 layer 20 described in the first exemplary embodiment and therefore has the same functions as second dielectric film 13 in L0 layer 10. Composition of second dielectric film 43 is not particularly limited similarly to second dielectric film 23. This is because L3 layer 40 that is positioned on the outermost end easily gives a larger amount of light for reproduction than L2 layer 30 or L0 layer 10 and easily secures the effective reflectance and the amount of light for reproduction of L3 layer 40 without specification of the composition of second dielectric film 43. Accordingly, it is possible to form second dielectric film 43 using the materials exemplified in relation to first dielectric film 11 and second dielectric film 13 in L0 layer 10 of the first exemplary embodiment. Alternatively, second dielectric film 43 may be formed using another material. Second dielectric film 43 may be formed of, for example, a material having a smaller refractive index than the material used for first dielectric film 11. In that case, second dielectric film 43 may be formed of the materials described in relation to second dielectric film 23 in L1 layer 20 of the first exemplary embodiment.

Second dielectric film 43 may have a thickness ranging from 5 nm to 30 nm, inclusive. Second dielectric film 43 that has a thickness of less than 5 nm lowers a protection function and is thus sometimes incapable of suppressing ingress of moisture into recording film 42. Second dielectric film 43 that has a thickness of more than 30 nm sometimes lowers the reflectance of L2 layer 30.

In a modified example of information recording medium 400, a combination of the first dielectric film having a specific composition with the recording film having a specific composition may be attained in another information layer in addition to or in place of the L0 layer. The combination of the first dielectric film having a specific composition with the recording film having a specific composition is effective to improve the amount of light for reproduction of the L0 layer that easily lowers the amount of light for reproduction, and when such a combination is used in another information layer, it is possible to improve the amount of light for reproduction in the other information layer. For example, the combination of the first dielectric film having a specific composition with the recording film having a specific composition may be employed only in any one of the L1, layer, the L2, layer, and the L3 layer.

Use of the combination of the first dielectric film having a specific composition with the recording film having a specific composition in any one of the L1 layer to the L3 layer enables an increase in the transmittance of the information layer to be capable of increasing the amount of laser beam 6 that reaches the L0 layer and thus improving the effective reflectance of the L0 layer, resulting in an improvement of the amount of light for reproduction of the L0 layer. That is, it is possible to increase the S/N ratio of a short mark recorded on the L0 layer also by application of the first dielectric film having a specific composition and the recording film having a specific composition to any one of the L1 layer to the L3 layer.

In another modified example of information recording medium 400, third dielectric film 14a may be provided between substrate 1 or intermediate separation layer 2, 3, 7 and first dielectric film 11, 21, 31, 41 having a specific composition. Alternatively, in another modified example, third dielectric film 14b may be provided between first dielectric film 11, 21, 31, 41 having a specific composition and recording film 12, 22, 32, 42 having a specific composition. The functions, the shape, and the material for third dielectric films 14a, 14b are as described before in the second and third exemplary embodiments.

### Fifth Exemplary Embodiment

Next, a method for producing information recording medium 100 described in the first exemplary embodiment is described as a fifth exemplary embodiment.

It is possible to form first dielectric film 11, recording film 12, and second dielectric film 13 that constitute L0 layer 10 by a sputtering method that is one of vapor-phase film forming methods.

First, substrate 1 (for example, thickness: 0.5 mm, diameter: 120 mm) is disposed in a film forming apparatus.

Subsequently, first dielectric film 11 is formed. At this time, when substrate 1 includes a spiral guide groove, first dielectric film 11 is formed on substrate 1's guide-groove side. First dielectric film 11 is formed by sputtering in a rare-gas atmosphere or in a mixed-gas atmosphere of a rare gas with a reactive gas (for example, an oxygen gas), using a target containing D1 which represents at least one element selected from a first group consisting of Nb, Mo, Ta, W, Ti, Bi, and Ce according to the composition of first dielectric film 11 to be obtained. The rare gas is, for example, an Ar gas, a Kr gas, or a Xe gas, and an Ar gas is advantageous in terms of costs. This also applies to any sputtering that employs, as an atmosphere gas for sputtering, a rare gas or a mixed gas of a rare gas.

The sputtering target may contain the D1 in an oxide form or in an elemental metal or alloy form. When a target that is made of a metal (also an alloy) is used, an oxide may be formed by reactive sputtering performed in an atmosphere containing an oxygen gas.

DC (DC: Direct Current) sputtering or pulse DC sputtering performed using a conductive sputtering target (preferably with a specific resistance value of less than or equal to 1 Ωcm) is capable of achieving a higher film-forming rate than RF sputtering.

Specifically, the sputtering target may have a composition of, for example,
NbOₓ, Nb₂O₅, MoO₃, Ta₂O₅, WO₃, TiOₓ, TiO₂, Bi₂O₃, CeO₂,
NbOₓ—MoO₃, Nb₂O₅—MoO₃, NbOₓ—Ta₂O₅, Nb₂O₅—Ta₂O₅, NbOₓ—WO₃, Nb₂O₅—WO₃, NbOₓ—TiO₂, NbOₓ—TiOₓ, Nb₂O₅—TiO₂, Nb₂O₅—TiOₓ, NbOₓ—Bi₂O₃, Nb₂O₅—Bi₂O₃, Nb₂O₅—CeO₂, NbOₓ—CeO₂, MoO₃—Ta₂O₅, MoO₃—WO₃, MoO₃—TiOₓ, MoO₃—TiO₂, MoO₃—Bi₂O₃, MoO₃—CeO₂, Ta₂O₅—WO₃, Ta₂O₅—TiOₓ, Ta₂O₅—TiO₂, Ta₂O₅—Bi₂O₃, Ta₂O₅—CeO₂, WO₃—TiO₂, WO₃—TiOₓ, WO₃—Bi₂O₃, WO₃—CeO₂, TiOₓ—Bi₂O₃, TiO₂—Bi₂O₃, TiOₓ—CeO₂, TiO₂—CeO₂, Bi₂O₃—CeO₂,
NbOₓ—MoO₃—Ta₂O₅, Nb₂O₅—MoO₃—Ta₂O₅, NbOₓ—MoO₃—WO₃, Nb₂O₅—MoO₃—WO₃, NbOₓ—MoO₃—TiO₂, NbOₓ—MoO₃—TiOₓ, Nb₂O₅—MoO₃—TiOₓ, Nb₂O₅—MoO₃—TiO₂, NbOₓ—MoO₃—Bi₂O₃, Nb₂O₅—MoO₃—Bi₂O₃, NbOₓ—MoO₃—CeO₂, Nb₂O₅—MoO₃—CeO₂, NbOₓ—Ta₂O₅—WO₃, Nb₂O₅—Ta₂O₅—WO₃, NbOₓ—Ta₂O₅—TiO₂, NbOₓ—Ta₂O₅—TiOₓ, Nb₂O₅—Ta₂O₅—TiOₓ, Nb₂O₅—Ta₂O₅—TiO₂, NbOₓ—Ta₂O₅—Bi₂O₃, Nb₂O₅—Ta₂O₅—Bi₂O₃, Nb₂O₅—Ta₂O₅—CeO₂, NbOₓ—Ta₂O₅—CeO₂,
NbOₓ—MoO₃—Ta₂O₅—WO₃, Nb₂O₅—MoO₃—Ta₂O₅—WO₃, NbOₓ—MoO₃—Ta₂O₅—TiO₂, NbOₓ—MoO₃—Ta₂O₅—TiOₓ, Nb₂O₅—MoO₃—Ta₂O₅—TiOₓ, Nb₂O₅—MoO₃—Ta₂O₅—TiO₂, NbOₓ—MoO₃—Ta₂O₅—Bi₂O₃, Nb₂O₅—MoO₃—Ta₂O₅—Bi₂O₃, NbOₓ—MoO₃—Ta₂O₅—CeO₂, Nb₂O₅—MoO₃—Ta₂O₅—CeO₂,
ZrO₂—NbOₓ, ZrO₂—Nb₂O₅, ZrO₂—MoO₃, ZrO₂—Ta₂O₅, ZrO₂—WO₃, ZrO₂—TiO₂, ZrO₂—Bi₂O₃, ZrO₂—CeO₂, ZrO₂—NbOₓ—MoO₃, ZrO₂—Nb₂O₅—MoO₃, ZrO₂—NbOₓ—Ta₂O₅, ZrO₂—Nb₂O₅—Ta₂O₅, ZrO₂—NbOₓ—WO₃, ZrO₂—Nb₂O₅—WO₃, ZrO₂—NbOₓ—TiO₂, ZrO₂—NbOₓ—TiOₓ, ZrO₂—Nb₂O₅—TiOₓ, ZrO₂—Nb₂O₅—TiO₂, ZrO₂—NbOₓ—Bi₂O₃, ZrO₂—Nb₂O₅—Bi₂O₃, ZrO₂—NbOₓ—CeO₂, or ZrO₂—Nb₂O₅—CeO₂.

Use of these sputtering targets enables formation of a thin film having nearly the same composition as the sputtering targets. Further, a sputtering target that has a composition including NbOₓ and/or TiOₓ is highly conductive to enable stable formation of first dielectric film 11 by DC sputtering. Accordingly, use of a sputtering target that has a composition including NbOₓ and/or TiOₓ is expected to give a high film-forming rate during formation of first dielectric film 11.

When first dielectric film 11 is formed of a plurality of dielectric materials, multi-sputtering that simultaneously deposits dielectric materials from a plurality of cathodes may be performed using sputtering targets of the dielectric materials. In the multi-sputtering, it is possible to obtain a desired composition ratio in a thin film by adjusting sputtering power of each of the cathodes.

For example, when a thin film formed of Nb₂O₅—MoO₃ is formed as first dielectric film 11, it is possible to use (NbOₓ, MoO₃) or (Nb₂O₅, MoO₃) as a combination of sputtering targets. Similarly, it is possible to form binary to quaternary thin films exemplified below by combinations of sputtering targets indicated below, respectively (a plurality of oxides described in parentheses correspond to a combination of targets).
—Nb₂O₅—Ta₂O₅: (NbOₓ, Ta₂O₅) or (Nb₂O₅, Ta₂O₅)
Nb₂O₅—WO₃: (NbOₓ, WO₃) or (Nb₂O₅, WO₃)
Nb₂O₅—TiO₂: (NbOₓ, TiO₂), (NbOₓ, TiO₂), (Nb₂O₅, TiO₂), or (Nb₂O₅, TiOₓ)
Nb₂O₅—Bi₂O₃: (NbOₓ, Bi₂O₃) or (Nb₂O₅, Bi₂O₃)
Nb₂O₅—CeO₂: (NbOₓ, CeO₂) or (Nb₂O₅, CeO₂)
MoO₃—Ta₂O₅: (MoO₃, Ta₂O₅)
MoO₃—WO₃: (MoO₃, WO₃)
MoO₃—TiO₂: (MoO₃, TiOₓ) or (MoO₃, TiO₂)
MoO₃—Bi₂O₃: (MoO₃, Bi₂O₃)
MoO₃—CeO₂: (MoO₃, CeO₂)
Ta₂O₅—WO₃: (Ta₂O₅, WO₃)
Ta₂O₅—TiO₂: (Ta₂O₅, TiOₓ) or (Ta₂O₅, TiO₂)
Ta₂O₅—Bi₂O₃: (Ta₂O₅, Bi₂O₃)
Ta₂O₅—CeO₂: (Ta₂O₅, CeO₂)
WO₃—TiO₂: (WO₃—TiOₓ) or (WO₃, TiO₂)
WO₃—Bi₂O₃: (WO₃, Bi₂O₃)
WO₃—CeO₂: (WO₃, CeO₂)
TiO₂—Bi₂O₃: (TiOₓ, Bi₂O₃) or (TiO₂, Bi₂O₃)
TiO₂—CeO₂: (TiOₓ, CeO₂) or (TiO₂, CeO₂)
Bi₂O₃—CeO₂: (Bi₂O₃—CeO₂)
Nb₂O₅—MoO₃—Ta₂O₅: (NbOₓ, MoO₃, Ta₂O₅) or (Nb₂O₅, MoO₃, Ta₂O₅)
Nb₂O₅—MoO₃—WO₃: (NbOₓ, MoO₃, WO₃) or (Nb₂O₅, MoO₃, WO₃)
Nb₂O₅—MoO₃—TiO₂: (NbOₓ, MoO₃, TiO₂), (NbOₓ, MoO₃, TiOₓ), (Nb₂O₅, MoO₃, TiOₓ), or (Nb₂O₅, MoO₃, TiO₂)
Nb₂O₅—MoO₃—Bi₂O₃: (NbOₓ, MoO₃, Bi₂O₃) or (Nb₂O₅, MoO₃, Bi₂O₃)
Nb₂O₅—MoO₃—CeO₂: (NbOₓ, MoO₃, CeO₂) or (Nb₂O₅, MoO₃, CeO₂)
Nb₂O₅—Ta₂O₅—WO₃: (NbOₓ, Ta₂O₅, WO₃) or (Nb₂O₅, Ta₂O₅, WO₃)
Nb₂O₅—Ta₂O₅—TiO₂: (NbOₓ, Ta₂O₅, TiO₂), (NbOₓ, Ta₂O₅, TiOₓ), (Nb₂O₅, Ta₂O₅, TiOₓ), or (Nb₂O₅, Ta₂O₅, TiO₂)
Nb₂O₅—Ta₂O₅—Bi₂O₃: (NbOₓ, Ta₂O₅, Bi₂O₃) or (Nb₂O₅, Ta₂O₅, Bi₂O₃)
NbOₓ—Ta₂O₅—CeO₂: (Nb₂O₅, Ta₂O₅, CeO₂), (NbOₓ, Ta₂O₅, CeO₂)

Subsequently, recording film 12 is formed on first dielectric film 11. It is possible to form recording film 12 by sputtering in a rare-gas atmosphere or in a mixed-gas atmosphere of a rare gas with a reactive gas, using a sputtering target made of a metal alloy or a metal-oxide mixture according to the composition of recording film 12. Recording film 12 is thicker than the dielectric films such as first dielectric film 11, so that it is preferable, in consideration of the productivity, to form recording film 12 by DC sputtering or pulse DC sputtering that is expected to give a high film-forming rate than RF sputtering. In order to make recording film 12 contain much oxygen, it is preferable to mix a large amount of an oxygen gas in an atmosphere gas.

The sputtering target may be one containing W, Cu, Mn, and the M, with the W, the Cu, the Mn, and the M except oxygen satisfying a following formula (1):

WₓCu_{y}Mn_{z}M_{100-x-y-z} (atom %) (1)
wherein x, y, and z satisfy 15≤x≤60, y≤z, 0<z≤40, and 60≤x+y+z≤98. Particularly, a sputtering target may be used in which x and z in the formula (1) satisfy 0.5≤(x/z)≤3.0.

With a total number of atoms of the W, the Cu, the Mn, and the M in the sputtering target defined as 100%, the sputtering target that has a content of W of less than 15 atom % makes DC or pulse DC sputtering unstable to easily cause abnormal electrical discharge. When a content of W is less than 20 atom % in recording film 12 to be formed, multi-sputtering may be performed that simultaneously sputters targets made of elementary substances or oxides of metals constituting recording film 12. In the multi-sputtering, it is possible to obtain a desired composition ratio in a thin film by adjusting sputtering power of each of the cathodes.

Specifically, when an alloy target or a mixture target is used for forming recording film 12, the target may have a composition of, for example, W—Cu—Mn—Nb, W—Cu—Mn₃O₄—Nb, W—Cu—Mn₃O₄—NbOₓ, W—Cu—Mn—Mo, W—Cu—Mn₃O₄—Mo, W—Cu—Mn—Ta, W—Cu—Mn₃O₄—Ta, W—Cu—Mn—Ti, W—Cu—Mn₃O₄—Ti, W—Cu—Mn₃O₄—TiOₓ, W—Cu—Mn—Nb—Zn, W—Cu—Mn₃O₄—Nb—ZnO, W—Cu—Mn₃O₄—NbOₓ—ZnO, W—Cu—Mn₃O₄—Nb—Mo, W—Cu—Mn₃O₄—NbOₓ—Mo, W—Cu—Mn₃O₄—Nb—Mo—ZnO, W—Cu—Mn₃O₄—NbOₓ—Mo—ZnO, W—Cu—Mn₃O₄—Nb—Mo—Ta, W—Cu—Mn₃O₄—NbOₓ—Mo—Ta, W—Cu—Mn₃O₄—Nb—Mo—Ta—Zn—O, W—Cu—Mn₃O₄—NbOₓ—Mo—Ta—Zn—O, W—Cu—Mn₃O₄—Nb—Mo—Ta—Ti, W—Cu—Mn₃O₄—NbOₓ—Mo—Ta—TiOₓ, W—Cu—Mn₃O₄—Nb—Mo—Ta—Ti—ZnO, W—Cu—Mn₃O₄—Nb—Mo—Ta—Ti—ZnO, W—Cu—Mn₃O₄—NbOₓ—Mo—Ta—TiOₓ—ZnO, W—Cu—Mn₃O₄—Nb—Mo—Ti, W—Cu—Mn₃O₄—NbOₓ—Mo—TiOₓ, W—Cu—Mn₃O₄—Nb—Mo—Ti—ZnO, W—Cu—Mn₃O₄—NbOₓ—Mo—TiOₓ—ZnO, W—Cu—Mn₃O₄—Nb—Ta, W—Cu—Mn₃O₄—NbOₓ—Ta, W—Cu—Mn₃O₄—Nb—Ta—ZnO, W—Cu—Mn₃O₄—NbOₓ—Ta—ZnO, W—Cu—Mn₃O₄—NbOₓ—Ta—TiOₓ, W—Cu—Mn₃O₄—Nb—Ta—Ti, W—Cu—Mn₃O₄—NbOₓ—Ta—TiOₓ—ZnO, W—Cu—Mn₃O₄—Nb—Ti, W—Cu—Mn₃O₄—Nb—Ti, W—Cu—Mn₃O₄—NbOₓ—TiOₓ, W—Cu—Mn₃O₄—Nb—Ti—ZnO, W—Cu—Mn₃O₄—Nb—Ti—ZnO, W—Cu—Mn₃O₄—NbOₓ—TiOₓ—ZnO, W—Cu—Mn₃O₄—Mo—ZnO, W—Cu—Mn₃O₄—Mo—Ta, W—Cu—Mn₃O₄—Mo—Ta—ZnO, W—Cu—Mn₃O₄—Mo—Ta—Ti, W—Cu—Mn₃O₄—Mo—Ta—TiOₓ, W—Cu—Mn₃O₄—Mo—Ta—Ti—ZnO, W—Cu—Mn₃O₄—Mo—Ta—TiOₓ—ZnO, W—Cu—Mn₃O₄—Mo—Ti, W—Cu—Mn₃O₄—Mo—TiOₓ, W—Cu—Mn₃O₄—Mo—Ti—ZnO, W—Cu—Mn₃O₄—Mo—TiOₓ—ZnO, W—Cu—Mn₃O₄—Ta—ZnO, W—Cu—Mn₃O₄—Ta—Ti, W—Cu—Mn₃O₄—Ta—TiOₓ, W—Cu—Mn₃O₄—Ta—Ti—ZnO, W—Cu—Mn₃O₄—Ta—TiOₓ—ZnO, W—Cu—Mn₃O₄—Ti, W—Cu—Mn₃O₄—TiOₓ, W—Cu—Mn₃O₄—Ti—ZnO, or W—Cu—Mn₃O₄—TiOₓ—ZnO.

When a thin film made of, for example, W—Cu—Mn—Nb—O is formed as recording film 12 by multi-sputtering, it is possible to use, for example, (W, Cu, Mn, Nb) or (W, Cu, Mn, NbO) as a combination of sputtering targets. In order to further stabilize electrical discharge and obtain high productivity, it is preferable to use a metal elementary-substance target. Similarly, it is possible to form thin films having compositions exemplified below by combinations of sputtering targets indicated below, respectively (a plurality of metals described in parentheses correspond to a combination of targets).
W—Cu—Mn—Mo—O: (W, Cu, Mn, Mo)
W—Cu—Mn—Ta—O: (W, Cu, Mn, Ta)
W—Cu—Mn—Ti—O: (W, Cu, Mn, Ti)
W—Cu—Mn—Nb—Zn—O: (W, Cu, Mn, Nb, Zn)
W—Cu—Mn—Nb—Mo—O: (W, Cu, Mn, Nb, Mo)
W—Cu—Mn—Nb—Mo—Zn—O: (W, Cu, Mn, Nb, Mo, Zn)
W—Cu—Mn—Nb—Mo—Ta—O: (W, Cu, Mn, Nb, Mo, Ta)
W—Cu—Mn—Nb—Mo—Ta—Zn—O: (W, Cu, Mn, Nb, Mo, Ta, Zn)
W—Cu—Mn—Nb—Mo—Ta—Ti—O: (W, Cu, Mn, Nb, Mo, Ta, Ti)
W—Cu—Mn—Nb—Mo—Ta—Ti—Zn—O: (W, Cu, Mn, Nb, Mo, Ta, Ti, Zn)
W—Cu—Mn—Nb—Mo—Ti—O: (W, Cu, Mn, Nb, Mo, Ti)
W—Cu—Mn—Nb—Mo—Ti—Zn—O: (W, Cu, Mn, Nb, Mo, Ti, Zn)
W—Cu—Mn—Nb—Ta—O: (W, Cu, Mn, Nb, Ta)
W—Cu—Mn—Nb—Ta—Zn—O: (W, Cu, Mn, Nb, Ta, Zn)
W—Cu—Mn—Nb—Ta—Ti—O: (W, Cu, Mn, Nb, Ta, Ti)
W—Cu—Mn—Nb—Ta—Ti—Zn—O: (W, Cu, Mn, Nb, Ta, Ti, Zn)
W—Cu—Mn—Nb—Ti—O: (W, Cu, Mn, Nb, Ti)
W—Cu—Mn—Nb—Ti—Zn—O: (W, Cu, Mn, Nb, Ti, Zn)
W—Cu—Mn—Mo—Zn—O: (W, Cu, Mn, Mo, Zn)
W—Cu—Mn—Mo—Ta—O: (W, Cu, Mn, Mo, Ta)
W—Cu—Mn—Mo—Ta—Zn—O: (W, Cu, Mn, Mo, Ta, Zn)
W—Cu—Mn—Mo—Ta—Ti—O: (W, Cu, Mn, Mo, Ta, Ti)
W—Cu—Mn—Mo—Ta—Ti—Zn—O: (W, Cu, Mn, Mo, Ta, Ti, Zn)
W—Cu—Mn—Mo—Ti—O: (W, Cu, Mn, Mo, Ti)
W—Cu—Mn—Mo—Ti—Zn—O: (W, Cu, Mn, Mo, Ti, Zn)
W—Cu—Mn—Ta—Zn—O: (W, Cu, Mn, Ta, Zn)
W—Cu—Mn—Ta—Ti—O: (W, Cu, Mn, Ta, Ti)
W—Cu—Mn—Ta—Ti—Zn—O: (W, Cu, Mn, Ta, Ti, Zn)
W—Cu—Mn—Ti—Zn—O: (W, Cu, Mn, Ti, Zn)

Subsequently, second dielectric film 13 is formed on recording film 12. It is possible to form second dielectric film 13 by sputtering in a rare-gas atmosphere or in a mixed-gas atmosphere of a rare gas with a reactive gas, using a sputtering target corresponding to the composition of second dielectric film 13. When second dielectric film 13 is formed of a plurality of dielectric materials, multi-sputtering may be performed using sputtering targets of the dielectric materials.

As the sputtering target used for forming second dielectric film 13, the sputtering targets that form first dielectric film 11 described above may be used. Alternatively, the sputtering target used for forming second dielectric film 13 may have a composition of, for example, NbOₓ—In₂O₃, Nb₂O₅—In₂O₃, NbOₓ—SnO₂, Nb₂O₅—SnO₂, NbOₓ—SiO₂, Nb₂O₅—SiO₂, MoO₃—In₂O₃, MoO₃—SnO₂, MoO₃—SiO₂, Ta₂O₅—In₂O₃, Ta₂O₅—SnO₂, Ta₂O₅—SiO₂, WO₃—In₂O₃, WO₃—SnO₂, WO₃—SiO₂, TiO₂—In₂O₃, TiOₓ—In₂O₃, TiO₂—SnO₂, TiOₓ—SnO₂, TiO₂—SiO₂, TiOₓ—SiO₂, Bi₂O₃—In₂O₃, Bi₂O₃—SnO₂, Bi₂O₃—SiO₂, CeO₂—In₂O₃, CeO₂—SnO₂, CeO₂—SiO₂, ZrO₂—SiO₂, ZrO₂—In₂O₃, ZrO₂—SnO₂, In₂O₃—SiO₂, In₂O₃—SnO₂, SnO₂—SiO₂, NbOₓ—ZrO₂—SiO₂, Nb₂O₅—ZrO₂—SiO₂, MoO₃—ZrO₂—SiO₂, Ta₂O₅—ZrO₂—SiO₂, WO₃—ZrO₂—SiO₂, TiO₂—ZrO₂—SiO₂, TiOₓ—ZrO₂—SiO₂, Bi₂O₃—ZrO₂—SiO₂, CeO₂—ZrO₂—SiO₂, ZrO₂—SiO₂—In₂O₃, ZrO₂—SiO₂—SnO₂, ZrO₂—In₂O₃—SnO₂, or In₂O₃—SnO₂—SiO₂.

Subsequently, intermediate separation layer 2 is formed on second dielectric film 13. It is possible to form intermediate separation layer 2 by applying a resin such as a photo-curable resin (particularly, an ultraviolet-curable resin) or a slow-acting thermosetting resin (for example, an acrylic resin) onto L0 layer 10, followed by spin coating, and then curing the resin. When a guide groove is provided in intermediate separation layer 2, intermediate separation layer 2 may be formed by a method for performing spin coating while allowing a transfer substrate (mold), whose surface includes a groove with a prescribed shape, to adhere to an uncured resin, then curing the resin, and thereafter peeling the transfer substrate from the cured resin. Alternatively, intermediate separation layer 2 may be formed in two steps. Specifically, a large-thickness portion is first formed by a spin coating method and a portion having a guide groove is next formed by a combination of a spin coating method with transfer using a transfer substrate.

Subsequently, L1 layer 20 is formed. Specifically, first dielectric film 21 is formed on intermediate separation layer 2. It is possible to form first dielectric film 21 by the same method as described above for first dielectric film 11, using a sputtering target corresponding to the composition of first dielectric film 21 to be obtained. Subsequently, recording film 22 is formed on first dielectric film 21. It is possible to form recording film 22 by the same method as described above for recording film 12, using a sputtering target corresponding to the composition of recording film 22 to be obtained. Subsequently, second dielectric film 23 is formed on recording film 22. It is possible to form second dielectric film 23 by the same method as described above for second dielectric film 13, using a sputtering target corresponding to the composition of second dielectric film 23 to be obtained. Subsequently, intermediate separation layer 3 is formed on second dielectric film 23. It is possible to form intermediate separation layer 3 by the same method as described above for intermediate separation layer 2.

Subsequently, L2 layer 30 is formed. It is possible to form L2 layer 30 basically by the same method as described above for L1 layer 20. First, first dielectric film 31 is formed on intermediate separation layer 3. It is possible to form first dielectric film 31 by the same method as described above for first dielectric film 11, using a sputtering target corresponding to the composition of first dielectric film 31 to be obtained. Subsequently, recording film 32 is formed on first dielectric film 31. It is possible to form recording film 32 by the same method as described above for recording film 12, using a sputtering target corresponding to the composition of recording film 32 to be obtained. Subsequently, second dielectric film 33 is formed on recording film 32. It is possible to form second dielectric film 33 by the same method as described above for second dielectric film 13, using a sputtering target corresponding to the composition of second dielectric film 33 to be obtained.

Any of the dielectric films and the recording films may be formed with supplied power during sputtering set at 10 W to 10 kW and pressure in a film-forming chamber at 0.01 Pa to 10 Pa.

Subsequently, cover layer 4 is formed on second dielectric film 33. It is possible to form cover layer 4 by applying a resin such as a photo-curable resin (particularly, an ultraviolet-curable resin) or a slow-acting thermosetting resin onto second dielectric film 33, followed by spin coating, and then curing the resin. Alternatively, cover layer 4 may be formed by a method for bonding a disk-shaped substrate made of a resin such as polycarbonate, an amorphous polyolefin, or polymethyl methacrylate (PMMA), or glass to second dielectric film 33. Specifically, it is possible to form cover layer 4 by a method for applying a resin such as a photo-curable resin (particularly, an ultraviolet-curable resin) or a slow-acting thermosetting resin to second dielectric film 33, performing spin coating while allowing a substrate to adhere to the applied resin to uniformly spread the resin, and thereafter curing the resin.

As a method for forming the layers, it is also possible to use, in addition to the sputtering method, vacuum vapor deposition, ion plating, chemical vapor deposition (CVD), and molecular beam epitaxy (MBE).

Thus, it is possible to produce A-side information recording medium 101. Substrate 1 and L0 layer 10 may be formed to include a disc identification code (for example, a burst cutting area (BCA)) as necessary. For example, when an identification code is assigned to polycarbonate-made substrate 1, it is possible to assign the identification code by dissolving and vaporizing polycarbonate of formed substrate 1, with use of, for example, a CO₂ laser. Alternatively, when an identification code is assigned to L0 layer 10, it is possible to assign the identification code by performing recording on recording film 12 or decomposing recording film 12 with use of, for example, a semiconductor laser. Assigning an identification code to L0 layer 10 may be performed after formation of second dielectric film 13, after formation of intermediate separation layer 2, after formation of cover layer 4, or after formation of bonding layer 5 described later.

Similarly, it is possible to produce B-side information recording medium 102. When a guide groove is provided in substrate 1 of B-side information recording medium 102, a spiral rotation direction of the guide groove may be opposite to or the same as a spiral rotation direction of the guide groove in substrate 1 of A-side information recording medium 101 described above.

Lastly, a photo-curable resin (particularly, an ultraviolet-curable resin) is uniformly applied to a surface opposite from the guide groove-provided surface of substrate 1 in A-side information recording medium 101, and the resin is bonded to a surface opposite from the guide groove-provided surface of substrate 1 in B-side information recording medium 102. Thereafter, the resin is irradiated with light and thus cured to form bonding layer 5. Alternatively, a slow-acting thermosetting photo-curable resin is uniformly applied to A-side information recording medium 101, then irradiated with light, and thereafter bonded to B-side information recording medium 102, to form bonding layer 5. Thus, it is possible to produce information recording medium 100 according to the first exemplary embodiment that includes the information layers on both sides of information recording medium 100.

### Sixth Exemplary Embodiment

A method for producing optical information recording medium 200 described in the second exemplary embodiment is described as a sixth exemplary embodiment. The method for producing optical information recording medium 200 is the same as the production method described in the fifth exemplary embodiment except that third dielectric film 14a is formed. Hereinafter, a method for forming third dielectric film 14a is described.

Third dielectric film 14a is formed on substrate 1. Third dielectric film 14a is formed by sputtering in a rare-gas atmosphere or in a mixed-gas atmosphere of a rare gas with a reactive gas (for example, an oxygen gas), using a sputtering target made of a single or mixed dielectric according to the composition of third dielectric film 14a to be obtained. DC sputtering or pulse DC sputtering performed using a conductive sputtering target (preferably with a specific resistance value of less than or equal to 1 Ωcm) is capable of achieving a higher film-forming rate than RF sputtering.

Specifically, the sputtering target may have a composition of, for example, ZrO₂, SiO₂, In₂O₃, SnO₂, ZrO₂—SiO₂, ZrO₂—In₂O₃, ZrO₂—SnO₂, In₂O₃—SiO₂, In₂O₃—SnO₂, SnO₂—SiO₂, ZrO₂—SiO₂—In₂O₃, ZrO₂—SiO₂—SnO₂, ZrO₂—In₂O₃—SnO₂, or In₂O₃—SnO₂—SiO₂.

When third dielectric film 14a is formed of a plurality of dielectric materials, multi-sputtering that simultaneously deposits dielectric materials from a plurality of cathodes may be performed using sputtering targets of the dielectric materials. In the multi-sputtering, it is possible to obtain a desired composition ratio in a thin film by adjusting sputtering power of each of the cathodes.

It is possible to produce information recording medium 200 according to the second exemplary embodiment by forming first dielectric film 11 and the like by the method described in the fifth exemplary embodiment, after the formation of third dielectric film 14a.

It is also possible to produce, by forming third dielectric film 14a on intermediate separation layer 2, 3, the information recording medium that is described as a modified example of the second exemplary embodiment and includes third dielectric film 14a between intermediate separation layer 2 and first dielectric film 21 or between intermediate separation layer 3 and first dielectric film 31.

### Seventh Exemplary Embodiment

A method for producing the optical information recording medium described in the third exemplary embodiment is described as a seventh exemplary embodiment. The method for producing optical information recording medium 300 is the same as the production method described in the fifth exemplary embodiment except that third dielectric film 14b is formed. Hereinafter, a method for forming third dielectric film 14b is described.

Third dielectric film 14b is formed on first dielectric film 11. The method for forming first dielectric film 11 is as described in the fifth exemplary embodiment. Third dielectric film 14b is formed by sputtering in a rare-gas atmosphere or in a mixed-gas atmosphere of a rare gas with a reactive gas (for example, an oxygen gas), using a sputtering target made of a single or mixed dielectric according to the composition of third dielectric film 14b to be obtained. DC sputtering or pulse DC sputtering performed using a conductive sputtering target (preferably with a specific resistance value of less than or equal to 1 Ωcm) is capable of achieving a higher film-forming rate than RF sputtering.

Specifically, the sputtering target may have a composition of, for example, ZrO₂, SiO₂, In₂O₃, SnO₂, ZrO₂—SiO₂, ZrO₂—In₂O₃, ZrO₂—SnO₂, In₂O₃—SiO₂, In₂O₃—SnO₂, SnO₂—SiO₂, ZrO₂—SiO₂—In₂O₃, ZrO₂—SiO₂—SnO₂, ZrO₂—In₂O₃—SnO₂, or In₂O₃—SnO₂—SiO₂.

When third dielectric film 14b is formed of a plurality of dielectric materials, multi-sputtering that simultaneously deposits dielectric materials from a plurality of cathodes may be performed using sputtering targets of the dielectric materials. In the multi-sputtering, it is possible to obtain a desired composition ratio in a thin film by adjusting sputtering power of each of the cathodes.

It is possible to produce information recording medium 300 according to the third exemplary embodiment by forming recording film 12 and the like by the method described in the fifth exemplary embodiment, after the formation of third dielectric film 14b.

### Eighth Exemplary Embodiment

The sputtering target for forming recording film 12 described in the first exemplary embodiment is described as an eighth exemplary embodiment. The sputtering target according to the present exemplary embodiment contains at least W, Cu, and Mn and further contains M. The M represents at least one element selected from a second group consisting of Nb, Mo, Ta, and Ti. The W, the Cu, the Mn, and the M except oxygen satisfying a following formula (1):

WₓCu_{y}Mn_{z}M_{100-x-y-z} (atom %) (1)
wherein x, y, and z satisfy 15≤x≤60, y≤z, 0<z≤40, and 60≤x+y+z≤98. In the formula (1), x and z may satisfy 0.5≤(x/z)≤3.0.

The target according to the present exemplary embodiment may be a sintered body obtained by sintering a powder at high temperature and high pressure. The target may have a filling rate (density) of more than or equal to 90%, particularly more than or equal to 95%.

The target that contains Nb as the M, with composition of the W, the Cu, the Mn, and the M represented by WₓCu_{y}Mn_{z}Nb_{100-x-y-z} (atom %), may be a metal and/or oxide sintered body. Specifically, the target may be, for example, an alloy target made of metals W, Cu, Mn, and Nb.

In this target, W may be contained in at least one powder (more accurately, sintered powder) form selected from a metal W powder, a WO₃ powder, a WO₂ powder, a WO₂—WO₃ intermediate oxide powder, and a Magneli-phase (WₙO₃ₙ₋₁) powder. W may be contained particularly in at least one powder form selected from a metal W powder and a WO₃ powder. Metal W has a melting point of 3400° C. and WO₃ has a melting point of 1473° C. (see, for example, 5th Edition of Iwanami Dictionary of Physics and Chemistry, the same applies hereinafter), so that it is possible to sinter powders of these materials at high temperature.

In this target, Cu may be contained in at least one powder (more accurately, sintered powder) form selected from a metal Cu powder, a CuO powder, and a Cu₂O powder. Cu may be contained particularly in at least one powder form selected from a metal Cu powder and a Cu₂O powder. Metal Cu has a melting point of 1083° C. and Cu₂O has a melting point of 1230° C., so that it is possible to sinter powders of these materials at high temperature.

In this target, Mn may be contained in at least one powder (more accurately, sintered powder) form selected from a metal Mn powder, a MnO powder, a Mn₃O₄ powder, a Mn₂O₃ powder, and a MnO₂ powder. Mn may be contained particularly in at least one powder form selected from a metal Mn powder, a MnO powder, and a Mn₃O₄ powder. Metal Mn has a melting point of 1240° C., MnO has a melting point of 1840° C., and Mn₃O₄ has a melting point of 1700° C., so that it is possible to sinter powders of these materials at high temperature.

In this target, Nb may be contained in at least one powder (more accurately, sintered powder) form selected from a metal Nb powder, a Nb₂O₅ powder, and a NbOₓ powder. Metal Nb has a melting point of 2470° C. and Nb₂O₅ has a melting point of 1485° C., so that it is possible to sinter powders of these materials at high temperature.

The target that contains Mo as the M, with composition of the W, the Cu, the Mn, and the M represented by WₓCu_{y}Mn_{z}Mo_{1oo-x-y-z} (atom %), may be a metal and/or oxide sintered body. Specifically, the target may be, for example, an alloy target made of metals W, Cu, Mn, and Mo.

The forms of W, Cu, and Mn contained in this target are as described before in relation to the target containing Nb as the M and are thus not described.

In this target, Mo may be contained in at least one powder (more accurately, sintered powder) form selected from a metal Mo powder and a MoO₃ powder. Mo may be contained particularly in a form of a metal Mo powder. Metal Mo has a melting point of 2620° C., so that it is possible to sinter a powder of the metal at high temperature.

The target that contains Ta as the M, with composition of the W, the Cu, the Mn, and the M represented by WₓCu_{y}Mn_{z}Ta_{100-x-y-z} (atom %), may be a metal and/or oxide sintered body. Specifically, the target may be, for example, an alloy target made of metals W, Cu, Mn, and Ta.

The forms of W, Cu, and Mn contained in this target are as described before in relation to the target containing Nb as the M and are thus not described.

In this target, Ta may be contained in at least one powder (more accurately, sintered powder) form selected from a metal Ta powder and a Ta₂O₅ powder. Ta has a melting point of 2990° C. and Ta₂O₅ has a melting point of 1870° C., so that it is possible to sinter powders of these materials at high temperature.

The target that contains Ti as the M, with composition of the W, the Cu, the Mn, and the M represented by WₓCu_{y}Mn_{z}Ti_{100-x-y-z} (mol %), may be a metal and/or oxide sintered body. Specifically, the target may be, for example, an alloy target made of metals W, Cu, Mn, and Ti.

The forms of W, Cu, and Mn contained in this target are as described before in relation to the target containing Nb as the M and are thus not described.

In this target, Ti may be contained in at least one powder (more accurately, sintered powder) form selected from a metal Ti powder, a TiO₂ powder, and a TiOₓ powder. Ti has a melting point of 1660° C. and TiO₂ has a melting point of 1840° C., so that it is possible to sinter powders of these materials at high temperature.

In any of the cases, the target that has the desired composition ratio is to be obtained by strictly weighing and sintering the elemental metal powder(s) and/or the oxide powder(s) so that x, y, and z satisfy the relationships described above.

Any of the targets having the compositions described above may be a molten target when production of the molten target is possible. A shape of the target is not particularly limited and may have, for example, a disk shape, a rectangular shape, or a cylindrical shape. The target may be, for example, a disk-shaped target having a diameter of 200 mm and a thickness of 10 mm. The target may be used by being, with In or In—Sn, bonded to a so-called backing plate containing copper as a main component. Sputtering with use of the target bonded to the backing plate may be performed by directly or indirectly cooling the backing plate with water in a sputtering device.

The target according to the present exemplary embodiment may be one that enables DC sputtering. Such a target has a specific resistance value of, for example, less than 1×10⁻² Ωcm, particularly a specific resistance value of less than or equal to 5×10⁻³ Ωcm.

### Ninth Exemplary Embodiment

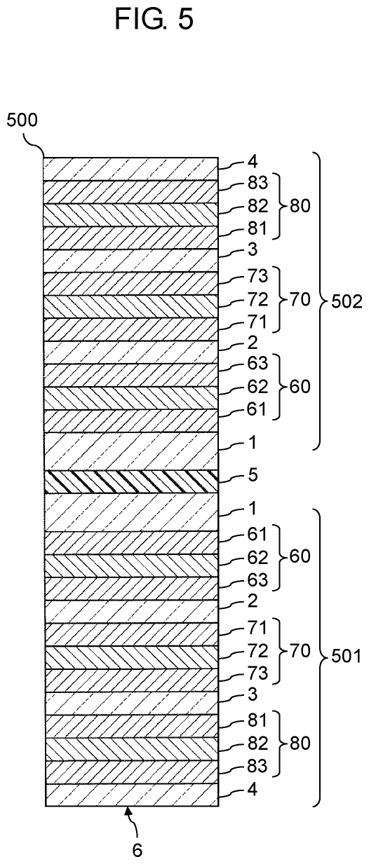

As a ninth exemplary embodiment, another example of the information recording medium according to the present disclosure is described. As the ninth exemplary embodiment, one example of the information recording medium is described that records and reproduces information with a laser beam. FIG. 5 shows a sectional view of the optical information recording medium. Information recording medium 500 according to the present exemplary embodiment is configured to include, as shown in FIG. 5, A-side information recording medium 501, bonding layer 5, and B-side information recording medium 502. A-side information recording medium 501 and B-side information recording medium 502 each include L0 layer 60, L1 layer 70, and L2 layer 80. Dielectric films and recording films that constitute these layers are different from the films of the first exemplary embodiment, but the other constituent parts such as substrate 1, intermediate separation layers 2, 3, cover layer 4, and bonding layer 5 are the same as the constituent parts of the first exemplary embodiment.

A configuration of L0 layer 60 is described. L0 layer 10 is formed by stacking, on a surface of substrate 1, first dielectric film 61, recording film 62, and second dielectric film 63 in this order.

First dielectric film 61 has an action of adjusting an optical phase difference to control signal amplitude and an action of adjusting a bulge of a recording mark to control signal amplitude. First dielectric film 61 also has an action of suppressing ingress of moisture into recording film 62 and an action of suppressing escape of oxygen in recording film 62 to exterior.

First dielectric film 11 is a film containing an oxide of D3. The D3 represents at least one element selected from a fourth group consisting of Zr, In, Sn, and Si. The first dielectric film preferably has a specific resistance value of less than or equal to 1 Ωcm. This also applies to first dielectric films 71, 81 described later. First dielectric film 61 may be made of a mixture of two or more oxides selected from these oxides or may be made of a composite oxide formed of two or more oxides selected from these oxides. First dielectric film 61 may have a composition of, for example, ZrO₂—In₂O₃, In₂O₅—SnO₂, or ZrO₂—SiO₂—In₂O₃.

First dielectric film 61 may have a thickness ranging, for example, from 5 nm to 40 nm, inclusive. First dielectric film 61 that has a thickness of less than 5 nm lowers a protection function and is thus sometimes incapable of suppressing ingress of moisture into recording film 62. First dielectric film 61 that has a thickness of more than 40 nm sometimes lowers the reflectance of L0 layer 60.

Recording film 62 contains W, Cu, Mn, Ti, and oxygen. An oxide of Ti has a high refractive index and a low extinction coefficient to be capable of increasing the reflectance, thus enabling an improvement in the amount of light for reproduction of the L0 layer.

With a total amount of the W, the Cu, the Mn, and the Ti contained in recording film 62 defined as 100 atom %, a ratio among the elements is represented by a following formula (2):

WₓCu_{y}Mn_{z}Ti_{100-x-y-z} (atom %) (2)
wherein x, y, and z satisfy 15≤x≤60, y≤z, 0<z≤40, and 60≤x+y+z≤98. Recording film 62 containing W, Cu, Mn, and Ti that satisfy the formula (2) makes the recording and reproduction characteristics of L0 layer 60 good.

Recording film 62 may further contain Zn. Addition of Zn enables a further improvement in stability of sputtering when recording film 62 is formed by DC sputtering. Therefore, even an increase in sputtering power or a decrease in Ar gas is less likely to cause abnormal electrical discharge to improve the productivity. A content of Zn may be less than or equal to 30 atom %, with a total number of atoms of the W, the Cu, the Mn, the M, and the Zn defined as 100, so as not to affect the refractive index and the extinction coefficient of recording film 62.

Recording film 62 may have a composition of, for example, W—Cu—Mn—Ti—O or W—Cu—Mn—Ti—Zn—O. In recording film 62, a composite oxide containing W, Cu, Mn, and Ti may exist.

When having a composition of, for example, W—Cu—Mn—Ti—O, recording film highly possibly has any one of systems WO₃—CuO—MnO₂—TiO₂, WO₃—CuO—Mn₂O₃—TiO₂, WO₃—CuO—Mn₃O₄—TiO₂, WO₃—CuO—MnO—TiO₂, WO₃—Cu₂O—MnO₂—TiO₂, WO₃—Cu₂O—Mn₂O₃—TiO₂, WO₃—Cu₂O—Mn₃O₄—TiO₂, and WO₃—Cu₂O—MnO—TiO₂. TiOₓ may exist in place of TiO₂ or both TiO₂ and TiOₓ may exist. Any of the systems exemplified above may contain Zn. In that case, Zn is considered to be contained in a ZnO form.

Recording film 62 may have a thickness ranging, for example, from 10 nm to 50 nm, inclusive, particularly from 20 nm to 40 nm, inclusive. Recording film 62 that has a thickness of less than 10 nm is not sufficiently expanded not to sometimes allow formation of a good recording mark, resulting in degradation of the channel bit error rate. Recording film 62 that has a thickness of more than 50 nm becomes good in recording sensitivity to decrease the power for recording, lowering, due to the decrease, the power for reproduction to sometimes decrease the amount of light for reproduction. Further, recording film 62 that has a thickness of more than 50 nm prolongs time (sputtering time) required for forming recording film 62 to sometimes lower the productivity.

Second dielectric film 63 has, similarly to first dielectric film 61, an action of adjusting an optical phase difference to control signal amplitude and an action of controlling a bulge of a recording pit to control signal amplitude. Second dielectric film 63 also has an action of suppressing ingress of moisture from intermediate separation layer 2 into recording film 62 and an action of suppressing escape of oxygen in recording film 62 to exterior. Second dielectric film 63 also has functions of suppressing incorporation of organic matter from intermediate separation layer 2 into recording film 62 and securing adhesiveness between L0 layer 60 and intermediate separation layer 2.

Second dielectric film 63 may have the same composition as first dielectric film 61. As described above, the composition of second dielectric film 63 has a smaller influence on the amount of light for reproduction of L0 layer 60 than the composition of first dielectric film 61, so that the composition of second dielectric film 63 is not particularly limited. Second dielectric film 63 may have, for example, the same composition as the dielectric film employed in the first-generation Archival Disc.

Second dielectric film 63 is a film containing an oxide of D3. The D3 represents at least one element selected from a fourth group consisting of Zr, In, Sn, and Si. The second dielectric film preferably has a specific resistance value of less than or equal to 1 Ωcm. This also applies to second dielectric films 73, 83 described later.

Second dielectric film 63 may be made of a mixture of two or more oxides selected from these oxides or may be made of a composite oxide formed of two or more oxides selected from these oxides. Second dielectric film 63 may have a composition of, for example, ZrO₂—In₂O₃, In₂O₅—SnO₂, or ZrO₂—SiO₂—In₂O₃.

Second dielectric film 63 may have a thickness ranging, for example, from 5 nm to 30 nm, inclusive. Second dielectric film 63 that has a thickness of less than 5 nm lowers a protection function and is thus sometimes incapable of suppressing ingress of moisture into recording film 62. Second dielectric film 63 that has a thickness of more than 30 nm decreases the reflectance of L0 layer 60

It is possible to design specific thickness of first dielectric film 61, recording film 62, and second dielectric film 63 by calculation based on a matrix method (for example, see “Wave Optics” by Hiroshi Kubota, Section 3, Iwanami Shoten, 1971). Adjustment of the thickness of each film enables adjustment of the reflectance of recorded or unrecorded recording film 62 and a phase difference of reflected light between a recorded portion and an unrecorded portion to optimize the signal quality of a reproduction signal.

Next, a configuration of L1 layer 70 is described. L1 layer 70 is formed by stacking, on a surface of intermediate separation layer 2, at least first dielectric film 71, recording film 72, and second dielectric film 73 in this order.

First dielectric film 71 has the same functions and composition as first dielectric film 61 in L0 layer 60 described above. First dielectric film 71 also has a role of making L1 layer 70 adhere to intermediate separation layer 2. It is possible to obtain higher power for reproduction by making an amount of Zr larger than an amount of Si in first dielectric film 71. This is because making the amount of Zr larger than the amount of Si enables alleviation of an adverse effect of organic matter and moisture desorbed from intermediate separation layer 2 on first dielectric film 71, to be capable of suppressing degradation of the reproduction durability.

First dielectric film 71 may have a thickness ranging from 10 nm to 50 nm, inclusive. First dielectric film 71 that has a thickness of less than 10 nm lowers adhesiveness to intermediate separation layer 2 to sometimes lower a protection function of suppressing ingress of moisture into recording film 72. First dielectric film 71 that has a thickness of more than 50 nm sometimes lowers the reflectance of L1 layer 70. Further, first dielectric film 71 that has a thickness of more than 50 nm prolongs time (sputtering time) required for forming first dielectric film 71 to sometimes lower the productivity.

Recording film 72 has the same functions and composition as recording film 62 in L0 layer 60 described above. Recording film 72 may have a film thickness ranging from 15 nm to 50 nm, inclusive, particularly from 25 nm to 45 nm, inclusive. Recording film 72 that has a film thickness of less than 15 nm is not sufficiently expanded not to allow formation of a good recording mark, resulting in degradation of the channel bit error rate. Recording film 72 that has a film thickness of more than 50 nm becomes good in recording sensitivity to decrease the power for recording, lowering, due to the decrease, the power for reproduction to sometimes decrease the amount of light for reproduction. Further, recording film 72 that has a thickness of more than 50 nm prolongs time (sputtering time) required for forming recording film 72 to sometimes lower the productivity.

Second dielectric film 73 has the same functions and composition as second dielectric film 63 in L0 layer 60 described above. Second dielectric film 73 may have a thickness ranging from 5 nm to 30 nm, inclusive. Second dielectric film 73 that has a thickness of less than 5 nm lowers a protection function and is thus sometimes incapable of suppressing ingress of moisture into recording film 72, and second dielectric film 73 that has a thickness of more than 30 nm sometimes decreases the reflectance of L1 layer 70.

Next, a configuration of L2 layer 80 is described. L2 layer 80 is formed by stacking, on a surface of intermediate separation layer 3, at least first dielectric film 81, recording film 82, and second dielectric film 83 in this order. The configuration of L2 layer 80 is basically the same as the configuration of L1 layer 70.

First dielectric film 81 has the same functions and composition as first dielectric film 71 in L1 layer 70 and therefore has the same functions and composition as first dielectric film 61 in L0 layer 60. First dielectric film 81 also has a role of making L2 layer 80 adhere to intermediate separation layer 3.

First dielectric film 81 may have a thickness ranging from 10 nm to 50 nm, inclusive. First dielectric film 81 that has a thickness of less than 10 nm lowers adhesiveness to intermediate separation layer 3 to sometimes lower a protection function of suppressing ingress of moisture into recording film 82. First dielectric film 81 that has a thickness of more than 50 nm sometimes lowers the reflectance of L2 layer 80. Further, first dielectric film 81 that has a thickness of more than 50 nm prolongs time (sputtering time) required for forming first dielectric film 81 to sometimes lower the productivity.

Recording film 82 has the same functions and composition as recording film 72 in L1 layer 70 and therefore has the same functions and composition as recording film 62 in L0 layer 60.

Recording film 82 may have a film thickness ranging from 15 nm to 50 nm, inclusive, particularly from 25 nm to 45 nm, inclusive. Recording film 82 that has a film thickness of less than 15 nm is not sufficiently expanded not to allow formation of a good recording mark, resulting in degradation of the channel bit error rate. Recording film 82 that has a film thickness of more than 50 nm becomes good in recording sensitivity to decrease the power for recording, lowering, due to the decrease, the power for reproduction to sometimes decrease the amount of light for reproduction. Further, recording film 82 that has a thickness of more than 50 nm prolongs time (sputtering time) required for forming recording film 82 to sometimes lower the productivity.

Second dielectric film 83 has the same functions and composition as second dielectric film 73 in L1 layer 70 and therefore has the same functions and composition as second dielectric film 63 in L0 layer 60.

Second dielectric film 83 may have a thickness ranging from 5 nm to 30 nm, inclusive. Second dielectric film 83 that has a thickness of less than 5 nm lowers a protection function and is thus sometimes incapable of suppressing ingress of moisture into recording film 82. Second dielectric film 83 that has a thickness of more than 30 nm sometimes lowers the reflectance of L2 layer 80.

First dielectric films 61, 71, 81, recording films 62, 72, 82, and second dielectric films 63, 73, 83 may be formed by RF sputtering or DC sputtering, using a sputtering target obtained by mixing oxides that constitute these films. Alternatively, these films may be formed by RF sputtering with introduction of oxygen or DC sputtering with introduction of oxygen, using an alloy sputtering target containing no oxygen. Alternatively, these films may be formed by a method for attaching sputtering targets of oxides to separate power sources, respectively and simultaneously performing RF sputtering or DC sputtering (multi-sputtering method). RF sputtering and DC sputtering may be performed simultaneously. Further, exemplified as another film forming method is a method for attaching sputtering targets made of metal elementary substances or alloys, or sputtering targets of oxides to separate power sources, respectively and simultaneously performing RF sputtering or DC sputtering with introduction of oxygen as necessary. Alternatively, these films may be formed by a method for performing RF sputtering or DC sputtering, using a sputtering target formed by mixing a metal with an oxide, with introduction of oxygen.

The exemplary embodiments have been heretofore described as examples of the technique according to the present disclosure. For that purpose, the accompanying drawings and the detailed description have been provided.

Accordingly, the constituent parts illustrated in the accompanying drawings and described in the detailed description can include constituent parts essential for solving the problems, as well as constituent parts that are necessary to exemplify the above technique but are inessential for solving the problems.

Therefore, it should not immediately be construed that these inessential constituent parts are essential based on a fact that the inessential constituent parts are illustrated in the accompanying drawings or described in the detailed description.

Since the exemplary embodiments are intended to illustrate the technique according to the present disclosure, various modifications, replacements, additions, removals, or the like are allowed within a scope of accompanying claims or an equivalent to the claims.

The information recording medium according to the present disclosure is applicable not only to a method for recording and reproducing presence or absence of a recording mark as data of 0 or 1 corresponding to one bit, but also to a multi-level recording method for recording information of recording marks as multi-level recording information such as four-level (corresponding to two-bit) data and eight-level (corresponding to three-bit) data to be capable of increasing the capacity by two or three times.

Next, the technique according to the present disclosure is described in detail by way of examples.

### EXAMPLES

### Example 1-1

In the present example, one example of information recording medium 100 shown in FIG. 1 is described. First, a configuration of A-side information recording medium 101 is described. As substrate 1, a polycarbonate substrate (diameter: 120 mm, thickness 0.5 mm) was prepared that included a spiral guide groove (depth: 30 nm, track pitch (land-groove distance): 0.225 μm). First dielectric film 11, recording film 12, and second dielectric film 13 are sequentially formed on substrate 1 by a sputtering method, with first dielectric film 11 formed as a dielectric film having a thickness of 17 nm and a composition shown in Tables 1 and 2, recording film 12 formed as a film having a thickness ranging from 31 nm to 34 nm and a composition shown in Tables 1 and 2, and second dielectric film 13 formed as (ZrO₂)₂₅(SiO₂)₂₅(In₂O₃)₅₀ (mol %) having a thickness of 9 nm.

As described in the exemplary embodiments, first dielectric film 11 may contain C derived from organic matter desorbed from substrate 1. In the present specification, however, C is not described in the composition of first dielectric film 11. The same applies to first dielectric films 11 below.

When C is contained, C tends to be contained in a large amount at a location that allows the film to start to be deposited and that is close to substrate 1.

Here, the composition of the recording film is expressed in a form representing, as an element ratio, only a metal element ratio (atom %), and the same expression applies below. For example, an oxide of W₁₉Cu₂₅Zn₂₀Mn₃₆ (atom %) is expressed as W₁₉Cu₂₅Zn₂₀Mn₃₆—O. For easy understanding, however, the tables show the composition in a form representing only the metal element ratio (atom %).

When irradiated with laser beam 6 having a wavelength of 405 nm, L0 layer 10 that is provided with neither L1 layer 20 nor L2 layer 30 and is unrecorded has a reflectance R_{g} of nearly equal to 7.0% to 15.0% and a reflectance Rₗ of nearly equal to 7.5% to 16.0%.

Formation of first dielectric film 11 is performed in an Ar atmosphere or an Ar and O₂ mixed-gas atmosphere, using a DC power source or an RF power source. Formation of recording film 12 is performed in an Ar and O₂ mixed-gas atmosphere, using a pulse DC power source. With a total amount of the metal elements defined as 100 atom %, recording film 12 that has a composition including 20 atom % to 50 atom % of W is formed by sputtering with use of an alloy target containing all the constituent elements. Recording film 12 that has a different composition is formed by multi-sputtering (cosputtering) that simultaneously sputters respective metal targets of the constituent elements. Formation of second dielectric film 13 is performed in an Ar atmosphere, using a DC power source or a pulse DC power source.

Subsequently, intermediate separation layer 2 provided with a spiral guide groove (depth: 30 nm, track pitch (land-groove distance): 0.225 μm) is formed on L0 layer 10. Specifically, a main portion that occupies most of the thickness of intermediate separation layer 2 is first formed by spin coating with an ultraviolet-curable resin and curing by irradiation with ultraviolet light. Next, a surface of the main portion is spin-coated with an ultraviolet-curable resin, a transfer substrate that includes a guide groove and is made of polycarbonate is bonded onto the resin, the resin is cured with ultraviolet light, and then the transfer substrate is peeled, to form intermediate separation layer 2 including a guide groove. Intermediate separation layer 2 has a thickness of about 25 μm.

L1 layer 20 is formed on intermediate separation layer 2. Specifically, first dielectric film 21, recording film 22, and second dielectric film 23 in L1 layer 20 are sequentially formed by a sputtering method, with first dielectric film 21 formed as (ZrO₂)₃₀(SiO₂)₃₀(In₂O₃)₄₀ (mol %) having a thickness of 17 nm, recording film 22 formed as W₃₃Cu₁₆Zn₃₄Mn₁₇—O having a thickness of 35 nm, and second dielectric film 23 formed as (ZrO₂)₂₅(SiO₂)₂₅(In₂O₃)₅₀ (mol %) having a thickness of 7 nm.

As described in the exemplary embodiments, first dielectric film 21 may contain C derived from organic matter desorbed from intermediate separation layer 2. In the present specification, however, C is not described in the composition of first dielectric film 21. The same applies to first dielectric films 21 below.

When C is contained, C tends to be contained in a large amount at a location that allows the film to start to be deposited and that is close to Intermediate separation layer 2.

Film thickness of first dielectric film 21 and second dielectric film 23 is determined by calculation based on a matrix method. Specifically, the film thickness is determined so that L1 layer 20 that is provided with no L2 layer 30 and is unrecorded has a reflectance R_{g} of nearly equal to 7.7%, a reflectance Rₗ of nearly equal to 8.2%, and a transmittance of about 72% when irradiated with 405-nm laser beam 6.

Formation of first dielectric film 21 and second dielectric film 23 is performed in an Ar atmosphere, using a DC power source or a pulse DC power source. Formation of recording film 22 is performed with an alloy target, in an Ar and O₂ mixed-gas atmosphere, using a pulse DC power source.

Subsequently, intermediate separation layer 3 provided with a spiral guide groove (depth: 30 nm, track pitch (land-groove distance): 0.225 μm) is formed on L1 layer 20. Intermediate separation layer 3 is formed by the same method as for intermediate separation layer 2. Intermediate separation layer 3 has a thickness of about 18 μm.

L2 layer 30 is formed on intermediate separation layer 3. First dielectric film 31, recording film 32, and second dielectric film 33 are sequentially formed by a sputtering method, with first dielectric film 31 formed as (ZrO₂)₃₀(SiO₂)₃₀(In₂O₃)₄₀ (mol %) having a thickness of 19 nm, recording film 32 formed as W₃₈Cu₁₀Zn₃₈Mn₁₄—O having a thickness of 38 nm, and second dielectric film 33 formed as (ZrO₂)₂₅(SiO₂)₂₅(In₂O₃)₅₀ (mol %) having a thickness of 9 nm.

As described in the exemplary embodiments, first dielectric film 31 may contain C derived from organic matter desorbed from intermediate separation layer 3. In the present specification, however, C is not described in the composition of first dielectric film 31. The same applies to first dielectric films 31 below.

When C is contained, C tends to be contained in a large amount at a location that allows the film to start to be deposited and that is close to Intermediate separation layer 3.

Film thickness of first dielectric film 31 and second dielectric film 33 is determined by calculation based on a matrix method. Specifically, the film thickness is determined so that unrecorded L2 layer 30 has a reflectance R_{g} of nearly equal to 6.4%, a reflectance Rₗ of nearly equal to 6.8%, and a transmittance of about 79% when irradiated with 405-nm laser beam 6.

Formation of first dielectric film 31 and second dielectric film 33 is performed in an Ar atmosphere, using a DC power source or a pulse DC power source. Formation of recording film 32 is performed with an alloy target, in an Ar and O₂ mixed-gas atmosphere, using a pulse DC power source.

Thereafter, an ultraviolet-curable resin is applied onto second dielectric film 33, followed by spin coating, and is then cured with ultraviolet light, to form cover layer 4 having a thickness of about 57 μm. This procedure completes preparation of A-side information recording medium 101.

Next, a configuration of B-side information recording medium 102 is described. As substrate 1, a polycarbonate substrate (diameter: 120 mm, thickness 0.5 mm) is prepared that includes a spiral guide groove (depth: 30 nm, track pitch (land-groove distance): 0.225 μm). A spiral rotation direction of the guide groove is made opposite to a spiral rotation direction of the guide groove formed in substrate 1 of A-side information recording medium 101 described above.

L0 layer 10, intermediate separation layer 2, L1 layer 20, intermediate separation layer 3, L2 layer 30, and cover layer 4 are formed on substrate 1. In B-side information recording medium 102, the films (the first dielectric films, the recording films, and the second dielectric films) that constitute the information layers are formed so that the information layers have the same configurations (e.g., the composition and the thickness of the films and the reflectances and the transmittances of the information layers) as the information layers of A-side information recording medium 101. The films are formed by the same methods as the methods employed in the formation of A-side information recording medium 101. Cover layer 4 is also made to have the same configuration as cover layer 4 of A-side information recording medium 101 and is formed by the same method. Intermediate separation layers 2 and 3 are also made to have the same configurations as the intermediate separation layers of A-side information recording medium 101 and are formed by the same method.

In B-side information recording medium 102, however, a rotation direction of the spiral guide groove provided in intermediate separation layers 2 and 3 is opposite to a spiral rotation direction of the guide groove provided in intermediate separation layers 2 and 3 of A-side information recording medium 101. When irradiated with laser beam 6 having a wavelength of 405 nm, L0 layer 10 that is provided with neither L1 layer 20 nor L2 layer 30 and is unrecorded has, similarly to L0 layer 10 of A-side information recording medium 101, a reflectance R_{g} of nearly equal to 7.0% to 15.0% and a reflectance Rₗ of nearly equal to 7.5% to 16.0%.

Lastly, an ultraviolet-curable resin is uniformly applied to a surface opposite from the guide groove-provided surface of substrate 1 in A-side information recording medium 101, and the applied resin is bonded to a surface opposite from the guide groove-provided surface of substrate 1 in B-side information recording medium 102. Then, the resin is cured with ultraviolet light to form bonding layer 5. Thus, information recording media 100 (Disc Nos. 1-101 to 112) of the present example are prepared.

### Comparative Example 1

An information recording medium (Disc No. 1-001) is prepared that has the same configuration as the information recording media of Example 1-1 except that first dielectric films 11 of A-side information recording medium 101 and B-side information recording medium 102 are formed as (ZrO₂)₁₅(SiO₂)₁₅(In₂O₃)₇₀ (mol %) having a thickness of 17 nm and recording films 12 are formed as W₁₉Cu₂₅Mn₃₆Zn₂₀—O having a thickness of 31 nm.

The information recording media of the example and the comparative example are evaluated for the groove reflectance, the reproduction durability, and the signal quality of the L0 layer. Tables 1 and 2 show results of the evaluation.

The discs having a one-side three-layer structure were evaluated for, for example, the reflectance by a following method. The reflectance is measured using a reflectance evaluation apparatus (manufactured by Pulstec Industrial Co., Ltd., trade name: ODU-1000). For measuring the reflectance, a laser beam source with a wavelength of 405 nm and an objective lens having a numerical aperture NA of 0.85.

An evaluation apparatus (manufactured by Pulstec Industrial Co., Ltd., trade name: ODU-1000) for signal evaluation, with laser beam having a wavelength of 405 nm and an objective lens having a numerical aperture NA of 0.91, records information on a groove and a land. Linear velocity of recording is set at 13.54 m/s (500 GB-sextuple speed) and linear velocity of reproduction is set at 9.03 m/s (500 GB-quadruple speed). Data bit length is set at 51.3 nm and 83.4-GB information is recorded per one information layer. The power during reproduction is set at 1.6 mW for L0 layer 10 and L1 layer 20 and at 1.2 mW for L2 layer 30. Laser beam 6 subjected to high frequency superposition (modulation) at 2:1 is used as light for reproduction. Recording with random signals (2 T to 12T) is performed and the signal quality is evaluated as a channel bit error rate (c-bER). In the present example, reference value 2×E-3 was set as a standard for determining the signal quality. Signals having a c-bER of less than or equal to 2×E-3 were determined to be good in signal quality.

The reproduction durability is evaluated by size of the power for reproduction (upper limit of the power of a laser beam during reproduction). Specifically, random signals are recorded on adjacent grooves and lands, and a groove on which the recording has been performed and that is positioned at a center of a track is reproduced at a linear velocity of 9.03 m/s one million times, and the c-bER is measured. The c-bER after one-million-time reproduction is measured while changing the power during reproduction, and power that gives a c-bER of 2×E-3 is set as the power for reproduction. The groove exhibits a higher light absorptance than the land and has worse reproduction durability than the land, so that the evaluation is performed not by reproduction of the land but by reproduction of the groove. The power for reproduction is evaluated not by an absolute value but by a value standardized with a reference value, with the power for reproduction of one disc set as the reference value (1.00) (that is, by how many times larger or smaller the power for reproduction is than the reference value). In the present example, the power for reproduction of Disc no. 1-001 is set as the reference value. Disc No. 1-001 has an amount of light for reproduction (reflectance R×power for reproduction Pr) of 0.030 with which it is impossible to obtain good reproduction signal quality.

After the measurement of the reflectance, the reproduction durability, and the signal quality, the discs were comprehensively evaluated by following criteria. The evaluation criteria are as follows.

⊙: The disc has a higher or the same power for reproduction as the disc of the comparative example, has a larger amount of light for reproduction (R×Pr) than the disc of the comparative example, and has a c-bER of less than 1.0×E-3.
∘: The disc has lower power for reproduction than the disc of the comparative example and has a larger amount of light for reproduction (R×Pr) than the disc of the comparative example. Otherwise, the disc has a c-bER ranging from 1.0×E-3 to 2.0×E-3, inclusive.
x: The disc has the same or a smaller amount of light for reproduction (R×Pr) than the disc of the comparative example. Otherwise, the disc has a c-bER of more than 2.0×E-3.

In the present example, Disc No. 1-001 is used as an object for comparison in the comprehensive evaluation.

### [Table 1]

TABLE 1

| | A-side information | A-side information | | | Amount of | | |
|---|---|---|---|---|---|---|---|
| | recording medium | recording medium | Groove | Power for | light for | | Compre- |
| Disc | 101/First dielectric | 101/Recording | reflectance | repro- | reproduction | | hensive |
| No. | film 11 (L0 layer) | film 12 (L0 layer) | R (%) | duction Pr | R × Pr | c-bER | evaluation |
| 1-101 | Nb₂O₅ | W₁₉Cu₂₅Mn₃₆Mo₂₀ (atom %) | 3.7 | 1.00 | 0.037 | 8.3 × E−4 | ⊙ |
| 1-102 | Nb₂O₅ | W₁₉Cu₂₅Mn₃₆Nb₂₀ (atom %) | 3.9 | 1.00 | 0.039 | 8.2 × E−4 | ⊙ |
| 1-103 | Nb₂O₅ | W₁₉Cu₂₅Mn₃₆Ta₂₀ (atom %) | 3.7 | 1.00 | 0.037 | 8.5 × E−4 | ⊙ |
| 1-104 | Nb₂O₅ | W₁₉Cu₂₅Mn₃₆Ti₂₀ (atom %) | 4.1 | 0.80 | 0.033 | 1.2 × E−3 | ◯ |
| 1-001 | (ZrO₂)₁₅(SiO₂)₁₅(In₂O₃)₇₀ (mol %) | W₁₉Cu₂₅Mn₃₆Zn₂₀ (atom %) | 3.0 | 1.00 | 0.030 | 4.0 × E−3 | X |

### [Table 2]

TABLE 2

| | A-side information | A-side information | | | Amount of | | |
|---|---|---|---|---|---|---|---|
| | recording medium | recording medium | Groove | Power for | light for | | Compre- |
| Disc | 101/First dielectric | 101/Recording | reflectance | repro- | reproduction | | hensive |
| No. | film 11 (L0 layer) | film 12 (L0 layer) | R (%) | duction Pr | R × Pr | c-bER | evaluation |
| 1-105 | Nb₂O₅ | W₁₉Cu₂₅Mn₃₆Mo₂₀ (atom %) | 3.7 | 1.00 | 0.037 | 8.3 × E−4 | ⊙ |
| 1-106 | (ZrO₂)₅₀(Nb₂O₅)₅₀ (mol %) | W₁₉Cu₂₅Mn₃₆Mo₂₀ (atom %) | 3.5 | 1.05 | 0.037 | 8.2 × E−4 | ⊙ |
| 1-107 | MoO₃ | W₁₉Cu₂₅Mn₃₆Mo₂₀ (atom %) | 3.4 | 1.00 | 0.034 | 8.4 × E−4 | ⊙ |
| 1-108 | Ta₂O₅ | W₁₉Cu₂₅Mn₃₆Mo₂₀ (atom %) | 3.4 | 1.00 | 0.034 | 8.7 × E−4 | ⊙ |
| 1-109 | WO₃ | W₁₉Cu₂₅Mn₃₆Mo₂₀ (atom %) | 3.6 | 0.90 | 0.032 | 1.0 × E−3 | ◯ |
| 1-110 | TiO₂ | W₁₉Cu₂₅Mn₃₆Mo₂₀ (atom %) | 3.9 | 0.80 | 0.031 | 9.5 × E−4 | ◯ |
| 1-111 | Bi₂O₃ | W₁₉Cu₂₅Mn₃₆Mo₂₀ (atom %) | 3.7 | 0.85 | 0.031 | 1.3 × E−3 | ◯ |
| 1-112 | CeO₂ | W₁₉Cu₂₅Mn₃₆Mo₂₀ (atom %) | 3.6 | 0.85 | 0.031 | 9.7 × E−4 | ◯ |
| 1-001 | (ZrO₂)₁₅(SiO₂)₁₅(In₂O₃)₇₀ (mol %) | W₁₉Cu₂₅Mn₃₆Zn₂₀ (atom %) | 3.0 | 1.00 | 0.030 | 4.0 × E−3 | X |

Comparison of Disc Nos. 1-101 to 104 with Disc No. 1-001 clarifies that first dielectric film 11 formed as Nb₂O₅ and recording film 12 containing W, Cu, Mn, and the M improve the reflectance of L0 layer 10 and thus improve the amount of light for reproduction (R×Pr). B-side information recording medium 102 is also observed to similarly improve the amount of light for reproduction of L0 layer 10.

Disc Nos. 1-105 to 112 are ones obtained by changing a type and a proportion of the oxide of the D1 contained in first dielectric film 11. Comparison of these discs with Disc No. 1-001 clarifies that addition of an oxide of the D1 improves the reflectance of L0 layer 10 to improve the amount of light for reproduction. When first dielectric film 11 contains WO₃, TiO₂, Bi₂O₃, or CeO₂, the power for reproduction tended to be lowered. When first dielectric film 11 contains Nb₂O₅, MoO₃, and Ta₂O₅, the disc is not observed to lower the power for reproduction, in comparison with Disc No. 1-001. These tendencies are also observed in L0 layer 10 of B-side information recording medium 102.

### Example 1-2

Information recording media 100 (Disc Nos. 1-113 to 122) are prepared similarly to Example 1-1 except that first dielectric film 11 is formed as Nb₂O₅ having a thickness of 17 nm, recording film 12 is formed as W₁₉Cu₂₅Mn₃₆Mo₂₀—O having a thickness ranging from 31 nm to 34 nm, and second dielectric film 13 is formed as a dielectric film having a thickness of 9 nm and a composition shown in Table 3. These discs are evaluated for the groove reflectance, the reproduction durability, and the signal quality of L0 layer 10. The power for reproduction of Disc Nos. 1-113 to 122 shows standardized values, with the power for reproduction of Disc No. 1-001 set as the reference value. Disc No. 1-001 is used as an object for comparison in the comprehensive evaluation. Table 3 shows results of the comprehensive evaluation.

TABLE 3

| | A-side information | A-side information | A-side information | Groove | | Amount of | | |
|---|---|---|---|---|---|---|---|---|
| | recording medium | recording medium | recording medium | reflectance | Power for | light for | | |
| Disc | 101/First dielectric | 101/Recording | 101/Second dielectric | R | reproduction | reproduction | | Comprehensive |
| No. | film 11 (L0 layer) | film 12 (L0 layer) | film 13 (L0 layer) | ( %) | Pr | R × Pr | c-bER | evaluation |
| 1-113 | Nb₂O₅ | W₁₉Cu₂₅Mn₃₆Mo₂₀ | Nb₂O₅ | 4.0 | 1.00 | 0.040 | 8.8 × E−4 | ⊚ |
| | | (atom %) | | | | | | |
| 1-114 | Nb₂O₅ | W₁₉Cu₂₅Mn₃₆Mo₂₀ | MoO₃ | 3.9 | 1.00 | 0.039 | 8.6 × E−4 | ⊚ |
| | | (atom %) | | | | | | |
| 1-115 | Nb₂O₅ | W₁₉Cu₂₅Mn₃₆Mo₂₀ | Ta₂O₅ | 3.8 | 1.00 | 0.038 | 8.6 × E−4 | ⊚ |
| | | (atom %) | | | | | | |
| 1-116 | Nb₂O₅ | W₁₉Cu₂₅Mn₃₆Mo₂₀ | WO₃ | 3.9 | 0.90 | 0.035 | 9.8 × E−4 | ◯ |
| | | (atom %) | | | | | | |
| 1-117 | Nb₂O₅ | W₁₉Cu₂₅Mn₃₆Mo₂₀ | TiO₂ | 4.2 | 0.80 | 0.034 | 9.5 × E−4 | ◯ |
| | | (atom %) | | | | | | |
| 1-118 | Nb₂O₅ | W₁₉Cu₂₅Mn₃₆Mo₂₀ | Bi₂O₃ | 4.1 | 0.80 | 0.033 | 1.1 × E−3 | ◯ |
| | | (atom %) | | | | | | |
| 1-119 | Nb₂O₅ | W₁₉Cu₂₅Mn₃₆Mo₂₀ | CeO₂ | 4.0 | 0.80 | 0.032 | 1.2 × E−3 | ◯ |
| | | (atom %) | | | | | | |
| 1-120 | Nb₂O₅ | W₁₉Cu₂₅Mn₃₆Mo₂₀ | (ZrO₂)₂₅(SiO₂)₂₅ | 3.7 | 1.00 | 0.037 | 8.3 × E−4 | ⊚ |
| | | (atom %) | (In₂O₃)₅₀(mol %) | | | | | |
| 1-121 | Nb₂O₅ | W₁₉Cu₂₅Mn₃₆Mo₂₀ | (ZrO₂)₅₀(Nb₂O₅)₅₀ | 3.8 | 1.00 | 0.038 | 8.4 × E−4 | ⊚ |
| | | (atom %) | (mol %) | | | | | |
| 1-122 | Nb₂O₅ | W₁₉Cu₂₅Mn₃₆Mo₂₀ | (In₂O₃)₈₇(SnO₂)₁₃ | 3.7 | 1.00 | 0.037 | 7.8 × E−4 | ⊚ |
| | | (atom %) | (mol %) | | | | | |
| 1-001 | (ZrO₂)₁₅(SiO₂)₁₅ | W₁₉Cu₂₅Mn₃₆Zn₂₀ | (ZrO₂)₂₅(SiO₂)₂₅ | 3.0 | 1.00 | 0.030 | 4.0 × E−3 | X |
| | (In₂O3)₇₀(mol %) | (atom %) | (In₂O₃)₅₀(mol %) | | | | | |

Any of the discs that includes second dielectric film 13 containing an oxide of the D2 was higher in the reflectance and thus also higher in the amount of light for reproduction than Disc No. 1-001. Particularly, when second dielectric film 13 contains oxides of Nb, Mo, Ta, Zr, In, Sn, and Si, the discs shows no lowering of the power for reproduction in comparison with Disc No. 1-001, to give a larger amount of light for reproduction. B-side information recording medium 102 is also observed to similarly improve the amount of light for reproduction of L0 layer 10.

### Example 1-3

Information recording media 100 (Disc Nos. 1-123 to 133) are prepared similarly to Example 1-1 except that first dielectric film 11 is formed as a dielectric film having a thickness of 17 nm and a composition shown in Tables 4 and 5 and recording film 12 is formed as W₁₉Cu₂₅Mn₃₆Mo₂₀—O having a thickness ranging from 31 nm to 34 nm. These discs are evaluated for the groove reflectance, the reproduction durability, and the signal quality of L0 layer 10. The power for reproduction of Disc Nos. 1-123 to 133 shows standardized values, with the power for reproduction of Disc No. 1-001 set as the reference value. Disc No. 1-001 is used as an object for comparison in the comprehensive evaluation. Tables 4 and 5 show results of the comprehensive evaluation.

TABLE 4

| | | | Groove | | Amount of | | |
|---|---|---|---|---|---|---|---|
| | A-side information recording | A-side information recording | reflectance | Power for | light for | | |
| Disc | medium 101/First dielectric | medium 101/Recording | R | reproduction | reproduction | | Comprehensive |
| No. | film 11 (L0 layer) | film 12 (L0 layer) | (%) | Pr | R × Pr | c-bER | evaluation |
| 1-123 | (ZrO₂)₅₀(Nb₂O₅)₅₀(mol %) | W₁₉Cu₂₅Mn₃₆Mo₂₀ (atom %) | 3.5 | 1.05 | 0.037 | 8.2 × E−4 | ⊚ |
| 1-124 | (ZrO₂)₅₀(MoO₃)₅₀(mol %) | W₁₉Cu₂₅Mn₃₆Mo₂₀ (atom %) | 3.3 | 1.05 | 0.035 | 8.4 × E−4 | ⊚ |
| 1-125 | (ZrO₂)₅₀(Ta₂O₅)₅₀(mol %) | W₁₉Cu₂₅Mn₃₆Mo₂₀ (atom %) | 3.4 | 1.05 | 0.036 | 8.0 × E−4 | ⊚ |
| 1-126 | (ZrO₂)₅₀(WO₃)₅₀(mol %) | W₁₉Cu₂₅Mn₃₆Mo₂₀ (atom %) | 3.5 | 0.95 | 0.033 | 8.8 × E−4 | ◯ |
| 1-127 | (ZrO₂)₅₀(TiO₂)₅₀(mol %) | W₁₉Cu₂₅Mn₃₆Mo₂₀ (atom %) | 3.7 | 0.85 | 0.031 | 9.0 × E−4 | ◯ |
| 1-128 | (ZrO₂)₅₀(Bi₂O₃)₅₀(mol %) | W₁₉Cu₂₅Mn₃₆Mo₂₀ (atom %) | 3.6 | 0.90 | 0.032 | 1.5 × E−3 | ◯ |
| 1-129 | (ZrO₂)₅₀(CeO₂)₅₀(mol %) | W₁₉Cu₂₅Mn₃₆Mo₂₀ (atom %) | 3.6 | 0.90 | 0.032 | 1.6 × E−3 | ◯ |
| 1-001 | (ZrO₂)₁₅(SiO₂)₁₅(In₂O₃)₇₀(mol %) | W₁₉Cu₂₅Mn₃₆Zn₂₀ (atom %) | 3.0 | 1.00 | 0.030 | 4.0 × E−3 | X |

TABLE 5

| | | | Groove | | Amount of | | |
|---|---|---|---|---|---|---|---|
| | A-side information recording | A-side information recording | reflectance | Power for | light for | | |
| Disc | medium 101/First dielectric | medium 101/Recording | R | reproduction | reproduction | | Comprehensive |
| No. | film 11 (L0 layer) | film 12 (L0 layer) | (%) | Pr | R × Pr | c-bER | evaluation |
| 1-130 | (ZrO₂)₇₁(Nb₂O₅)₂₉(mol %) | W₁₉Cu₂₅Mn₃₆Mo₂₀ (atom %) | 3.1 | 1.05 | 0.033 | 1.2 × E−3 | ◯ |
| 1-131 | (ZrO₂)₇₀(Nb₂O₅)₃₀(mol %) | W₁₉Cu₂₅Mn₃₆Mo₂₀ (atom %) | 3.2 | 1.05 | 0.034 | 9.8 × E−4 | ⊚ |
| 1-132 | (ZrO₂)₅₀(Nb₂O₅)₅₀(mol %) | W₁₉Cu₂₅Mn₃₆Mo₂₀ (atom %) | 3.5 | 1.05 | 0.037 | 8.2 × E−4 | ⊚ |
| 1-133 | (ZrO₂)₃₀(Nb₂O₅)₇₀(mol %) | W₁₉Cu₂₅Mn₃₆Mo₂₀ (atom %) | 3.8 | 1.03 | 0.039 | 8.2 × E−4 | ⊚ |
| 1-001 | (ZrO₂)₁₅(SiO₂)₁₅(In₂O₃)₇₀(mol %) | W₁₉Cu₂₅Mn₃₆Zn₂₀ (atom %) | 3.0 | 1.00 | 0.030 | 4.0 × E−3 | X |

Comparison of Disc Nos. 1-123 to 129 with Disc Nos. 1-105, 107 to 112 (see Table 2) shows that first dielectric film 11 containing an oxide of Zr in addition to an oxide of the D1 improves the power for reproduction of L0 layer 10, in comparison with the cases in which first dielectric film 11 contains only an oxide of the D1. Further, according to the evaluation results of Disc Nos. 1-130 to 133, the reflectance lowers more easily along with an increase in the ratio of the oxide of Zr, but the discs still gave a higher reflectance and power for reproduction than Disc No. 1-001. B-side information recording medium 102 is also observed to similarly improve the power for reproduction of L0 layer 10.

### Example 1-4

In the present example, one example of information recording medium 200 shown in FIG. 2 is described. Information recording medium 200 in FIG. 2 is an information recording medium that includes L0 layer 10a provided with third dielectric film 14a between and in contact with substrate 1 and first dielectric film 11.

In the present example, information recording media 100 (Disc Nos. 1-134 to 145 and 171 to 173) are prepared similarly to Example 1-1 except that third dielectric film 14a is formed as (ZrO₂)₂₅(SiO₂)₂₅(In₂O₃)₅₀ (mol %) having a thickness of 5 nm, first dielectric film 11 is formed as Nb₂O₅ having a thickness of 12 nm, and recording film 12 is formed as a film having a thickness ranging from 31 nm to 34 nm and a composition shown in Table 6. Formation of third dielectric film 14a is performed in an Ar atmosphere or an Ar and O₂ atmosphere, using a DC power source or a pulse DC power source.

As described in the exemplary embodiments, third dielectric film 14a may contain C derived from organic matter desorbed from substrate 1. In the present specification, however, C is not described in the composition of third dielectric film 14a. The same applies to third dielectric films 14a below.

When C is contained, C tends to be contained in a large amount at a location that allows the film to start to be deposited and that is close to substrate 1.

The discs of the example and the comparative example are evaluated for the groove reflectance, the reproduction durability, and the signal quality of the L0 layer. The power for reproduction of Disc Nos. 1-134 to 145 and 171 to 173 shows standardized values, with the power for reproduction of Disc No. 1-001 set as the reference value. Disc No. 1-001 is used as an object for comparison in the comprehensive evaluation. Table 6 shows results of the comprehensive evaluation.

TABLE 6

| | A-side information | A-side information | A-side information | Groove | | Amount of | | |
|---|---|---|---|---|---|---|---|---|
| | recording medium | recording medium | recording medium | reflectance | Power for | light for | | |
| Disc | 201/Third dielectric | 201/First dielectric | 201/Recording | R | reproduction | reproduction | | Comprehensive |
| No. | film 14a (L0 layer) | film 11 (L0 layer) | film 12 (L0 layer) | (%) | Pr | R × Pr | c-bER | evaluation |
| 1-134 | (ZrO₂)₂₅(SiO₂)₂₅ | Nb₂O₅ | W₁₉Cu₂₅Mn₃₆Mo₂₀ | 3.6 | 1.45 | 0.052 | 8.0 × E−4 | ⊚ |
| | (In₂O₃)₅₀(mol %) | | (atom %) | | | | | |
| 1-135 | (ZrO₂)₂₅(SiO₂)₂₅ | Nb₂O₅ | W₁₉Cu₂₅Mn₃₆Nb₂₀ | 3.4 | 1.35 | 0.046 | 8.3 × E−4 | ⊚ |
| | (In₂O₃)₅₀(mol %) | | (atom %) | | | | | |
| 1-136 | (ZrO₂)₂₅(SiO₂)₂₅ | Nb₂O₅ | W₁₉Cu₂₅Mn₃₆Ta₂₀ | 3.5 | 1.35 | 0.047 | 8.1 × E−4 | ⊚ |
| | (In₂O₃)₅₀(mol %) | | (atom %) | | | | | |
| 1-137 | (ZrO₂)₂₅(SiO₂)₂₅ | Nb₂O₅ | W₂₇Cu₁₈Mn₂₆Mo₂₉ | 3.3 | 1.65 | 0.054 | 9.5 × E−4 | ⊚ |
| | (In₂O₃)₅₀(mol %) | | (atom %) | | | | | |
| 1-138 | (ZrO₂)₂₅(SiO₂)₂₅ | Nb₂O₅ | W₂₇Cu₁₈Mn₂₆Nb₂₉ | 3.2 | 1.60 | 0.051 | 9.4 × E−4 | ⊚ |
| | (In₂O₃)₅₀(mol %) | | (atom %) | | | | | |
| 1-139 | (ZrO₂)₂₅(SiO₂)₂₅ | Nb₂O₅ | W₂₇Cu₁₈Mn₂₆Ta₂₉ | 3.3 | 1.55 | 0.051 | 9.5 × E−4 | ⊚ |
| | (In₂O₃)₅0(mol %) | | (atom %) | | | | | |
| 1-140 | (ZrO₂)₂₅(SiO₂)₂₅ | Nb₂O₅ | W₃₅Cu₁₄Mn₂₆Mo₂₁ | 3.1 | 1.70 | 0.053 | 9.6 × E−4 | ⊚ |
| | (In₂O₃)₅₀(mol %) | | (atom %) | | | | | |
| 1-141 | (ZrO₂)₂₅(SiO₂)₂₅ | Nb₂O₅ | W₃₅Cu₁₄Mn₂₆Nb₂₁ | 3.2 | 1.65 | 0.053 | 9.6 × E−4 | ⊚ |
| | (In₂O₃)₅₀(mol %) | | (atom %) | | | | | |
| 1-142 | (ZrO₂)₂₅(SiO₂)₂₅ | Nb₂O₅ | W₃₅Cu₁₄Mn₂₆Ta₂₁ | 3.1 | 1.65 | 0.051 | 9.2 × E−4 | ⊚ |
| | (In₂O₃)₅₀(mol %) | | (atom %) | | | | | |
| 1-143 | (ZrO₂)₂₅(SiO₂)₂₅ | Nb₂O₅ | W₃₃Cu₁₆Mn₁₇Mo₃₄ | 2.7 | 2.15 | 0.058 | 9.2 × E−4 | ⊚ |
| | (In₂O₃)₅₀(mol %) | | (atom %) | | | | | |
| 1-144 | (ZrO₂)₂₅(SiO₂)₂₅ | Nb₂O₅ | W₃₃Cu₁₆Mn₁₇Nb₃₄ | 2.6 | 2.10 | 0.055 | 9.0 × E−4 | ⊚ |
| | (In₂O₃)₅₀(mol %) | | (atom %) | | | | | |
| 1-145 | (ZrO₂)₂₅(SiO₂)₂₅ | Nb₂O₅ | W₃₃Cu₁₆Mn₁₇Ta₃₄ | 2.6 | 2.15 | 0.056 | 8.3 × E−4 | ⊚ |
| | (In₂O₃)₅₀(mol %) | | (atom %) | | | | | |
| 1-171 | (ZrO₂)₂₅(SiO₂)₂₅ | Nb₂O₅ | W₂₅Cu₂₁Mn₂₈Mo₂₆ | 3.5 | 1.45 | 0.051 | 9.4 × E−4 | ⊚ |
| | (In₂O₃)₅₀(mol %) | | (atom %) | | | | | |
| 1-172 | (ZrO₂)₂₅(SiO₂)₂₅ | Nb₂O₅ | W₂₅Cu₂₁Mn₂₈Nb₂₆ | 3.6 | 1.45 | 0.052 | 8.8 × E−4 | ⊚ |
| | (In₂O₃)₅₀(mol %) | | (atom %) | | | | | |
| 1-173 | (ZrO₂)₂₅(SiO₂)₂₅ | Nb₂O₅ | W₂₅Cu₂₁Mn₂₈Ta₂₆ | 3.5 | 1.48 | 0.052 | 8.0 × E−4 | ⊚ |
| | (In₂O₃)₅₀(mol %) | | (atom %) | | | | | |
| 1-001 | — | (ZrO₂)₁₅(SiO₂)₁₅ | W₁₉Cu₂₅Mn₃₆Zn₂₀ | 3.0 | 1.00 | 0.030 | 4.0 × E−3 | X |
| | | (In₂O₃)₇₀(mol %) | (atom %) | | | | | |

Any of the discs of the example gave a larger amount of light for reproduction than the disc of the comparative example. Comparison of Disc Nos. 1-134 to 136 with Disc Nos. 1-101 to 103 (see Table 1) clarifies that provision of third dielectric film 14a makes the power for reproduction (reproduction durability) higher to improve the amount of light for reproduction. B-side information recording medium 202 is also observed to similarly improve the power for reproduction of L0 layer 10a.

### Example 1-5

In the present example, one example of information recording medium 200 shown in FIG. 2 is described. Information recording medium 200 in FIG. 2 is an information recording medium that includes L0 layer 10a provided with third dielectric film 14a between and in contact with substrate 1 and first dielectric film 11.

In the present example, information recording media 200 (Disc Nos. 1-146 to 163) are prepared similarly to Example 1-1 except that third dielectric film 14a is formed as (ZrO₂)₂₅(SiO₂)₂₅(In₂O₃)₅₀ (mol %) having a thickness of 5 nm, first dielectric film 11 is formed as Nb₂O₅ having a thickness of 12 nm, and recording film 12 is formed as a film having a thickness ranging from 31 nm to 34 nm and a composition shown in Table 7. Formation of third dielectric film 14a is performed in an Ar atmosphere or an Ar and O₂ atmosphere, using a DC power source or a pulse DC power source. These discs are evaluated for the groove reflectance, the reproduction durability, and the signal quality of L0 layer 10a. The power for reproduction of Disc Nos. 1-146 to 163 shows standardized values, with the power for reproduction of Disc No. 1-001 set as the reference value. Disc No. 1-001 is used as an object for comparison in the comprehensive evaluation. Table 7 shows results of the comprehensive evaluation.

TABLE 7

| | A-side information | A-side information | A-side information | Groove | | Amount of | | |
|---|---|---|---|---|---|---|---|---|
| | recording medium | recording medium | recording medium | reflectance | Power for | light for | | |
| Disc | 201/Third dielectric | 201/First dielectric | 201/Recording | R | reproduction | reproduction | | Comprehensive |
| No. | film 14a (L0 layer) | film 11 (L0 layer) | film 12 (L0 layer) | (%) | Pr | R × Pr | c-bER | evaluation |
| 1-146 | (ZrO₂)₂₅(SiO₂)₂₅ | Nb₂O₅ | W₁₉Cu₂₅Mn₃₆Mo₂₀ | 3.7 | 1.45 | 0.054 | 8.3 × E−4 | ⊚ |
| | (In₂O₃)₅₀(mol %) | | (atom %) | | | | | |
| 1-147 | (ZrO₂)₂₅(SiO₂)₂₅ | Nb₂O₅ | W₁₅Cu₂₅Mn₃₀Mo₃₀ | 3.6 | 1.50 | 0.054 | 2.0 × E−3 | ◯ |
| | (In₂O₃)₅₀(mol %) | | (atom %) | | | | | |
| 1-148 | (ZrO₂)₂₅(SiO₂)₂₅ | Nb₂O₅ | W₁₄Cu₂₅Mn₂₈Mo₃₃ | 3.6 | 1.50 | 0.054 | 2.4 × E−3 | X |
| | (In₂O₃)₅₀(mol %) | | (atom %) | | | | | |
| 1-149 | (ZrO₂)₂₅(SiO₂)₂₅ | Nb₂O₅ | W₁₆Cu₂₅Mn₃₃Mo₂₆ | 3.7 | 1.45 | 0.054 | 1.8 × E−3 | ◯ |
| | (In₂O₃)₅₀(mol %) | | (atom %) | | | | | |
| 1-150 | (ZrO₂)₂₅(SiO₂)₂₅ | Nb₂O₅ | W₃₃Cu₁₆Mn₁₇Mo₃₄ | 3.1 | 1.95 | 0.060 | 9.5 × E−4 | ⊚ |
| | (In₂O₃)₅₀(mol %) | | (atom %) | | | | | |
| 1-151 | (ZrO₂)₂₅(SiO₂)₂₅ | Nb₂O₅ | W₄₅Cu₁₆Mn₁₇Mo₂₂ | 2.8 | 2.15 | 0.060 | 9.3 × E−4 | ⊚ |
| | (In₂O₃)₅₀(mol %) | | (atom %) | | | | | |
| 1-152 | (ZrO₂)₂₅(SiO₂)₂₅ | Nb₂O₅ | W₆₀Cu₉Mn₂₁Mo₁₀ | 2.5 | 2.35 | 0.059 | 1.6 × E−3 | ◯ |
| | (In₂O₃)₅₀(mol %) | | (atom %) | | | | | |
| 1-153 | (ZrO₂)₂₅(SiO₂)₂₅ | Nb₂O₅ | W₆₁Cu₉Mn₂₁Mo₁₁ | 2.4 | 2.45 | 0.059 | 2.6 × E−3 | X |
| | (In₂O₃)₅₀(mol %) | | (atom %) | | | | | |
| 1-154 | (ZrO₂)₂₅(SiO₂)₂₅ | Nb₂O₅ | W₅₂Cu₁₅Mn₁₇Mo₁₆ | 2.4 | 2.45 | 0.059 | 1.5 × E−3 | ◯ |
| | (In₂O₃)₅₀(mol %) | | (atom %) | | | | | |
| 1-155 | (ZrO₂)₂₅(SiO₂)₂₅ | Nb₂O₅ | W₁₉Cu₃₀Mn₃₁Mo₂₀ | 3.5 | 1.15 | 0.040 | 1.4 × E−3 | ◯ |
| | (In₂O₃)₅₀(mol %) | | (atom %) | | | | | |
| 1-156 | (ZrO₂)₂₅(SiO₂)₂₅ | Nb₂O₅ | W₁₉Cu₃₁Mn₃₀Mo₂₀ | 3.3 | 0.90 | 0.030 | 2.0 × E−3 | X |
| | (In₂O₃)₅₀(mol %) | | (atom %) | | | | | |
| 1-156 | (ZrO₂)₂₅(SiO₂)₂₅ | Nb₂O₅ | W₃₅Cu₁₀Mn₁₁Mo₃₅ | 2.6 | 2.00 | 0.052 | 9.6 × E−4 | ⊚ |
| A | (In₂O₃)₅₀(mol %) | | (atom %) | | | | | |
| 1-156 | (ZrO₂)₂₅(SiO₂)₂₅ | Nb₂O₅ | W₄₂Cu₁₀Mn₁₀Mo₃₈ | 2.5 | 2.05 | 0.051 | 9.8 × E−4 | ⊚ |
| B | (In₂O₃)₅₀(mol %) | | (atom %) | | | | | |
| 1-156 | (ZrO₂)₂₅(SiO₂)₂₅ | Nb₂O₅ | W₅₂Cu₅Mn₅Mo₃₈ | 2.4 | 2.10 | 0.050 | 1.7 × E−3 | ◯ |
| C | (In₂O₃)₅₀(mol %) | | (atom %) | | | | | |
| 1-157 | (ZrO₂)₂₅(SiO₂)₂₅ | Nb₂O₅ | W₅₅Cu₁Mn₁Mo₃₅ | 2.2 | 2.10 | 0.046 | 2.0 × E−3 | ◯ |
| | (In₂O₃)₅₀(mol %) | | (atom %) | | | | | |
| 1-158 | (ZrO₂)₂₅(SiO₂)₂₅ | Nb₂O₅ | W₂₁Cu₂₅Mn₄₀Mo₁₄ | 3.8 | 0.90 | 0.034 | 8.9 × E−4 | ◯ |
| | (In₂O₃)₅₀(mol %) | | (atom %) | | | | | |
| 1-159 | (ZrO₂)₂₅(SiO₂)₂₅ | Nb₂O₅ | W₂₁Cu₂₅Mn₄₁Mo₁₃ | 3.7 | 0.80 | 0.030 | 1.9 × E−3 | X |
| | (In₂O₃)₅₀(mol %) | | (atom %) | | | | | |
| 1-160 | (ZrO₂)₂₅(SiO₂)₂₅ | Nb₂O₅ | W₃₇Cu₂₅Mn₃₆Mo₂ | 3.4 | 1.05 | 0.036 | 1.1 × E−3 | ◯ |
| | (In₂O₃)₅₀(mol %) | | (atom %) | | | | | |
| 1-161 | (ZrO₂)₂₅(SiO₂)₂₅ | Nb₂O₅ | W₃₈Cu₂₅Mn₃₆Mo₁ | 3.2 | 0.90 | 0.029 | 1.8 × E−3 | X |
| | (In₂O₃)₅₀(mol %) | | (atom %) | | | | | |
| 1-162 | (ZrO₂)₂₅(SiO₂)₂₅ | Nb₂O₅ | W₁₉Cu₂₀Mn₂₁Mo₄₀ | 3.0 | 1.80 | 0.054 | 1.7 × E−3 | ◯ |
| | (In₂O₃)₅₀(mol %) | | (atom %) | | | | | |
| 1-163 | (ZrO₂)₂₅(SiO₂)₂₅ | Nb₂O₅ | W₁₉Cu₂₀Mn₂₀Mo₄₁ | 3.0 | 1.85 | 0.056 | 2.4 × E−3 | X |
| | (In₂O₃)₅₀(mol %) | | (atom %) | | | | | |
| 1-001 | — | (ZrO₂)₁₅(SiO₂)₁₅ | W₁₉Cu₂₅Mn₃₆Zn₂₀ | 3.0 | 1.00 | 0.030 | 4.0 × E−3 | X |
| | | (In₂O₃)₇₀(mol %) | (atom %) | | | | | |

In the present example, evaluated are the reflectance, the power for reproduction, the amount of light for reproduction, and the signal quality when the composition of recording film 12 is changed. In the formula (1) expressed as WₓCu_{y}Mn_{z}M_{100-x-y-z} (atom %), when x is less than 15 (Disc Nos. 1-148) or more than 60 (Disc No. 1-153), the signal quality is lowered. When y is larger than z (Disc Nos. 1-156, 1-163), the power for reproduction or the signal quality is observed to be lowered. When z is more than 40 (Disc No. 1-159), the power for reproduction is observed to be lowered. When x+y+z is more than 98 (Disc No. 1-161), the power for reproduction and the amount of light for reproduction are observed to be lowered. The same tendencies are observed also in L0 layer 10a of B-side information recording medium 202.

### Example 1-6

In the present example, one example of information recording medium 200 shown in FIG. 2 is described. Information recording medium 200 in FIG. 2 is an information recording medium that includes L0 layer 10a provided with third dielectric film 14a between and in contact with substrate 1 and first dielectric film 11.

In the present example, information recording media 200 (Disc Nos. 1-174 to 185) are prepared similarly to Example 1-1 except that third dielectric film 14a is formed as (ZrO₂)₂₅(SiO₂)₂₅(In₂O₃)₅₀ (mol %) having a thickness of 5 nm, first dielectric film 11 is formed as Nb₂O₅ having a thickness of 12 nm, and recording film 12 is formed as a film having a thickness ranging from 31 nm to 34 nm and a composition shown in Table 8. Formation of third dielectric film 14a is performed in an Ar atmosphere or an Ar and O₂ atmosphere, using a DC power source or a pulse DC power source. These discs are evaluated for the groove reflectance, the reproduction durability, and the signal quality of L0 layer 10a. The power for reproduction of Disc Nos. 1-174 to 185 shows standardized values, with the power for reproduction of Disc No. 1-001 set as the reference value. Disc No. 1-001 is used as an object for comparison in the comprehensive evaluation. Table 8 shows results of the comprehensive evaluation.

TABLE 8

| | A-side information | A-side information | A-side information | Groove | | Amount of | | |
|---|---|---|---|---|---|---|---|---|
| | recording medium | recording medium | recording medium | reflectance | Power for | light for | | |
| Disc | 201/Third dielectric | 201/First dielectric | 201/Recording | R | reproduction | reproduction | | Comprehensive |
| No. | film 14a (L0 layer) | film 11 (L0 layer) | film 12 (L0 layer) | (%) | Pr | R × Pr | c-bER | evaluation |
| 1-174 | (ZrO₂)₂₅(SiO₂)₂₅ | Nb₂O₅ | W₂₇Cu₁₈Mn₂₆Mo₂₄ | 3.1 | 1.60 | 0.050 | 9.0 × E−4 | ⊚ |
| | (In₂O₃)₅₀(mol %) | | Zn₅ (atom %) | | | | | |
| 1-175 | (ZrO₂)₂₅(SiO₂)₂₅ | Nb₂O₅ | W₂₇Cu₁₈Mn₂₆Nb₂₄ | 3.4 | 1.55 | 0.053 | 8.8 × E−4 | ⊚ |
| | (In₂O₃)₅₀(mol %) | | Zn₅ (atom %) | | | | | |
| 1-176 | (ZrO₂)₂₅(SiO₂)₂₅ | Nb₂O₅ | W₂₇Cu₁₈Mn₂₆Ta₂₄ | 3.3 | 1.52 | 0.050 | 7.5 × E−4 | ⊚ |
| | (In₂O₃)₅₀(mol %) | | Zn₅ (atom %) | | | | | |
| 1-177 | (ZrO₂)₂₅(SiO₂)₂₅ | Nb₂O₅ | W₂₇Cu₁₈Mn₂₆Ta₂₀ | 3.2 | 1.50 | 0.048 | 7.2 × E−4 | ⊚ |
| | (In₂O₃)₅₀(mol %) | | Zn₉ (atom %) | | | | | |
| 1-178 | (ZrO₂)₂₅(SiO₂)₂₅ | Nb₂O₅ | W₂₂Cu₁₈Mn₂₆Ta₂₀ | 3.2 | 1.47 | 0.047 | 8.0 × E−4 | ⊚ |
| | (In₂O₃)₅₀(mol %) | | Zn₁₄ (atom %) | | | | | |
| 1-179 | (ZrO₂)₂₅(SiO₂)₂₅ | Nb₂O₅ | W₂₅Cu₂₁Mn₂₈Ta₂₁ | 3.4 | 1.45 | 0.049 | 7.2 × E−4 | ⊚ |
| | (In₂O₃)₅₀(mol %) | | Zn₅ (atom %) | | | | | |
| 1-180 | (ZrO₂)₂₅(SiO₂)₂₅ | Nb₂O₅ | W₂₅Cu₂₁Mn₂₈Ta₁₆ | 3.3 | 1.43 | 0.047 | 7.2 × E−4 | ⊚ |
| | (In₂O₃)₅₀(mol %) | | Zn₁₀ (atom %) | | | | | |
| 1-181 | (ZrO₂)₂₅(SiO₂)₂₅ | Nb₂O₅ | W₂₅Cu₂₁Mn₂₈Ta₁₁ | 3.2 | 1.40 | 0.045 | 7.7 × E−4 | ⊚ |
| | (In₂O₃)₅₀(mol %) | | Zn₁₅ (atom %) | | | | | |
| 1-182 | (ZrO₂)₂₅(SiO₂)₂₅ | Nb₂O₅ | W₂₀Cu₂₁Mn₂₈Ta₂₆ | 3.3 | 1.43 | 0.047 | 7.5 × E−4 | ⊚ |
| | (In₂O₃)₅₀(mol %) | | Zn₅ (atom %) | | | | | |
| 1-183 | (ZrO₂)₂₅(SiO₂)₂₅ | Nb₂O₅ | W₁₅Cu₂₁Mn₂₈Ta₂₆ | 3.3 | 1.40 | 0.046 | 7.5 × E−4 | ⊚ |
| | (In₂O₃)₅₀(mol %) | | Zn₁₀ (atom %) | | | | | |
| 1-184 | (ZrO₂)₂₅(SiO₂)₂₅ | Nb₂O₅ | W₁₅Cu₂₁Mn₂₈Ta₂₁ | 3.2 | 1.38 | 0.044 | 8.0 × E−4 | ⊚ |
| | (In₂O₃)₅₀(mol %) | | Zn₁₅ (atom %) | | | | | |
| 1-185 | (ZrO₂)₂₅(SiO₂)₂₅ | Nb₂O₅ | W₁₅Cu₂₁Mn₂₈Ta₁₆ | 3.2 | 1.35 | 0.043 | 8.5 × E−4 | ⊚ |
| | (In₂O₃)₅₀(mol %) | | Zn₂₀ (atom %) | | | | | |
| 1-001 | — | (ZrO₂)₁₅(SiO₂)₁₅ | W₁₉Cu₂₅Mn₃₆Zn₂₀ | 3.0 | 1.00 | 0.030 | 4.0 × E−3 | X |
| | | (In₂O₃)₇₀(mol %) | (atom %) | | | | | |

Any of the discs of the example gave a larger amount of light for reproduction than the disc of the comparative example. B-side information recording medium 202 is also observed to similarly improve the reproduction durability and the amount of light for reproduction of L0 layer 10a.

### Example 1-7

In the present example, one example of information recording medium 300 shown in FIG. 3 is described. Information recording medium 300 in FIG. 3 is an information recording medium that includes L0 layer 10b provided with third dielectric film 14b between and in contact with first dielectric film 11 and recording film 12.

In the present example, information recording media 300 (Disc Nos. 1-164 to 170) are prepared similarly to Example 1-1 except that first dielectric film 11 is formed as a dielectric film having a thickness of 12 nm and a composition shown in Table 9, third dielectric film 14b is formed as (ZrO₂)₂₅(SiO₂)₂₅(In₂O₃)₅₀ (mol %) having a thickness of 5 nm, and recording film 12 is formed as W₁₉Cu₂₅Mn₃₆Mo₂₀—O having a thickness ranging from 31 nm to 34 nm. Formation of third dielectric film 14b is performed in an Ar atmosphere or an Ar and O₂ atmosphere, using a DC power source or a pulse DC power source. These discs are evaluated for the groove reflectance, the reproduction durability, and the signal quality of L0 layer 10b. The power for reproduction of Disc Nos. 1-164 to 170 shows standardized values, with the power for reproduction of Disc No. 1-001 set as the reference value. Disc No. 1-001 is used as an object for comparison in the comprehensive evaluation. Table 9 shows results of the comprehensive evaluation.

TABLE 9

| | A-side information | A-side information | A-side information | Groove | | Amount of | | |
|---|---|---|---|---|---|---|---|---|
| | recording medium | recording medium | recording medium | reflectance | Power for | light for | | |
| Disc | 301/First dielectric | 301/Third dielectric | 301/Recording | R | reproduction | reproduction | | Comprehensive |
| No. | film 11 (L0 layer) | film 14b (L0 layer) | film 12 (L0 layer) | (%) | Pr | R × Pr | c-bER | evaluation |
| 1-164 | Nb₂O₅ | (ZrO₂)₂₅(SiO₂)₂₅ | W₁₉Cu₂₅Mn₃₆Mo₂₀ | 3.6 | 1.05 | 0.038 | 8.4 × E−4 | ⊚ |
| | | (In₂O₃)₅₀(mol %) | (atom %) | | | | | |
| 1-165 | MoO₃ | (ZrO₂)₂₅(SiO₂)₂₅ | W₁₉Cu₂₅Mn₃₆Mo₂₀ | 3.4 | 1.05 | 0.036 | 8.3 × E−4 | ⊚ |
| | | (In₂O₃)₅₀(mol %) | (atom %) | | | | | |
| 1-166 | Ta₂O₅ | (ZrO₂)₂₅(SiO₂)₂₅ | W₁₉Cu₂₅Mn₃₆Mo₂₀ | 3.5 | 1.05 | 0.037 | 8.3 × E−4 | ⊚ |
| | | (In₂O3)₅₀(mol %) | (atom %) | | | | | |
| 1-167 | WO₃ | (ZrO₂)₂₅(SiO₂)₂₅ | W₁₉Cu₂₅Mn₃₆Mo₂₀ | 3.6 | 0.95 | 0.034 | 1.1 × E−3 | ◯ |
| | | (In₂O₃)₅₀(mol %) | (atom %) | | | | | |
| 1-168 | TiO₂ | (ZrO₂)₂₅(SiO₂)₂₅ | W₁₉Cu₂₅Mn₃₆Mo₂₀ | 3.8 | 0.85 | 0.032 | 8.8 × E−4 | ◯ |
| | | (In₂O₃)₅₀(mol %) | (atom %) | | | | | |
| 1-169 | Bi₂O₃ | (ZrO₂)₂₅(SiO₂)₂₅ | W₁₉Cu₂₅Mn₃₆Mo₂₀ | 3.6 | 0.90 | 0.032 | 1.0 × E−3 | ◯ |
| | | (In₂O₃)₅₀(mol %) | (atom %) | | | | | |
| 1-170 | CeO₂ | (ZrO₂)₂₅(SiO₂)₂₅ | W₁₉Cu₂₅Mn₃₆Mo₂₀ | 3.7 | 0.90 | 0.033 | 1.4 × E−3 | ◯ |
| | | (In₂O₃)₅₀(mol %) | (atom %) | | | | | |
| 1-001 | (ZrO₂)₁₅(SiO₂)₁₅ | — | W₁₉Cu₂₅Mn₃₆Zn₂₀ | 3.0 | 1.00 | 0.030 | 4.0 × E−3 | X |
| | (In₂O₃)₇₀(mol %) | | (atom %) | | | | | |

Any of the discs of the example gave a larger amount of light for reproduction than the disc of the comparative example. B-side information recording medium 302 is also observed to similarly improve the reproduction durability and the amount of light for reproduction of L0 layer 10b.

### Example 2-1

In the present example, one example of information recording medium 100 shown in FIG. 1 is described. First, a configuration of A-side information recording medium 101 is described. As substrate 1, a polycarbonate substrate (diameter: 120 mm, thickness 0.5 mm) is prepared that includes a spiral guide groove (depth: 30 nm, track pitch (land-groove distance): 0.225 μm). First dielectric film 11, recording film 12, and second dielectric film 13 are sequentially formed on substrate 1 by a sputtering method, with first dielectric film 11 formed as Nb₂O₅ having a thickness of 17 nm, recording film 12 formed as W₁₉Cu₂₅Zn₂₀Mn₃₆—O having a thickness of 31 nm, and second dielectric film 13 formed as (ZrO₂)₂₅(SiO₂)₂₅(In₂O₃)₅₀ (mol %) having a thickness of 9 nm. When irradiated with laser beam 6 having a wavelength of 405 nm, L0 layer 10 that is provided with neither L1 layer 20 nor L2 layer 30 and is unrecorded has a reflectance R_{g} of nearly equal to 11.5% and a reflectance Rₗ of nearly equal to 12.3%.

Formation of first dielectric film 11 is performed in an Ar and O₂ mixed-gas atmosphere, using a DC power source or a pulse DC power source. Recording film 12 is formed in an Ar and O₂ mixed-gas atmosphere, using a DC power source, by multi-sputtering (cosputtering) that simultaneously sputters respective metal targets of the constituent elements. Formation of second dielectric film 13 is performed in an Ar atmosphere, using a DC power source or a pulse DC power source.

Subsequently, intermediate separation layer 2 provided with a spiral guide groove (depth: 30 nm, track pitch (land-groove distance): 0.225 μm) is formed on L0 layer 10. Specifically, a main portion that occupies most of the thickness of intermediate separation layer 2 is first formed by spin coating with an ultraviolet-curable resin and curing by irradiation with ultraviolet light. Next, a surface of the main portion is spin-coated with an ultraviolet-curable resin, a transfer substrate that includes a guide groove and is made of polycarbonate is bonded onto the resin, the resin is cured with ultraviolet light, and then the transfer substrate is peeled, to form intermediate separation layer 2 including a guide groove. Intermediate separation layer 2 has a thickness of about 25 μm.

L1 layer 20 is formed on intermediate separation layer 2. Specifically, first dielectric film 21, recording film 22, and second dielectric film 23 in L1 layer 20 are sequentially formed by a sputtering method, with first dielectric film 21 formed as a dielectric film having a thickness of 17 nm and a composition shown in Table 10, recording film 22 formed as a film having a thickness of 35 nm and a composition shown in Table 10, and second dielectric film 23 formed as (ZrO₂)₂₅(SiO₂)₂₅(In₂O₃)₅₀ (mol %) having a thickness of 7 nm.

When irradiated with 405-nm laser beam 6, L1 layer 20 that is provided with no L2 layer 30 and is unrecorded has a reflectance R_{g} of nearly equal to 7.0% to 10.0%, a reflectance Rₗ of nearly equal to 7.5% to 11.0%, and a transmittance of 65% to 77%.

Formation of first dielectric film 21 is performed in an Ar atmosphere or an Ar and O₂ mixed-gas atmosphere, using a DC power source, a pulse DC power source, or an RF power source. Formation of recording film 22 is performed in an Ar and O₂ mixed-gas atmosphere, using a pulse DC power source. With a total amount of the metal elements defined as 100 atom %, recording film 22 that has a composition including 20 atom % to 50 atom % of W is formed by sputtering with use of an alloy target containing all the constituent elements. Recording film 22 that has a different composition is formed by multi-sputtering (cosputtering) that simultaneously sputters respective metal targets of the constituent elements. Formation of second dielectric film 23 is performed in an Ar atmosphere, using a DC power source or a pulse DC power source.

Subsequently, intermediate separation layer 3 provided with a spiral guide groove (depth: 30 nm, track pitch (land-groove distance): 0.225 μm) is formed on L1 layer 20. Intermediate separation layer 3 is formed by the same method as for intermediate separation layer 2. Intermediate separation layer 3 has a thickness of about 18 μm.

L2 layer 30 is formed on intermediate separation layer 3. First dielectric film 31, recording film 32, and second dielectric film 33 are sequentially formed by a sputtering method, with first dielectric film 31 formed as (ZrO₂)₃₀(SiO₂)₃₀(In₂O₃)₄₀ (mol %) having a thickness of 19 nm, recording film 32 formed as W₃₈Cu₁₀Zn₃₈Mn₁₄—O having a thickness of 38 nm, and second dielectric film 33 formed as (ZrO₂)₂₅(SiO₂)₂₅(In₂O₃)₅₀ (mol %) having a thickness of 9 nm.

Film thickness of first dielectric film 31 and second dielectric film 33 is determined by calculation based on a matrix method. Specifically, the film thickness is determined so that unrecorded L2 layer 30 has a reflectance R_{g} of nearly equal to 6.4%, a reflectance Rₗ of nearly equal to 6.8%, and a transmittance of about 79% when irradiated with 405-nm laser beam 6.

Formation of first dielectric film 31 and second dielectric film 33 is performed in an Ar atmosphere, using a DC power source or a pulse DC power source. Formation of recording film 32 is performed with an alloy target, in an Ar and O₂ mixed-gas atmosphere, using a pulse DC power source.

Thereafter, an ultraviolet-curable resin is applied onto second dielectric film 33, followed by spin coating, and is then cured with ultraviolet light, to form cover layer 4 having a thickness of about 57 μm. This procedure completes preparation of A-side information recording medium 101.

Next, a configuration of B-side information recording medium 102 is described. As substrate 1, a polycarbonate substrate (diameter: 120 mm, thickness 0.5 mm) is prepared that includes a spiral guide groove (depth: 30 nm, track pitch (land-groove distance): 0.225 μm). A spiral rotation direction of the guide groove is made opposite to a spiral rotation direction of the guide groove formed in substrate 1 of A-side information recording medium 101 described above.

L0 layer 10, intermediate separation layer 2, L1 layer 20, intermediate separation layer 3, L2 layer 30, and cover layer 4 are formed on substrate 1. In B-side information recording medium 102, the films (the first dielectric films, the recording films, and the second dielectric films) that constitute the information layers are formed so that the information layers have the same configurations (e.g., the composition and the thickness of the films and the reflectances and the transmittances of the information layers) as the information layers of A-side information recording medium 101. The films are formed by the same methods as the methods employed in the formation of A-side information recording medium 101. Cover layer 4 is also made to have the same configuration as cover layer 4 of A-side information recording medium 101 and is formed by the same method. Intermediate separation layers 2 and 3 also have the same configurations as the intermediate separation layers of A-side information recording medium 101. In B-side information recording medium 102, however, a rotation direction of the spiral guide groove provided in intermediate separation layers 2 and 3 is opposite to a spiral rotation direction of the guide groove provided in intermediate separation layers 2 and 3 of A-side information recording medium 101.

Lastly, an ultraviolet-curable resin is uniformly applied to a surface opposite from the guide groove-provided surface of substrate 1 in A-side information recording medium 101, and the applied resin is bonded to a surface opposite from the guide groove-provided surface of substrate 1 in B-side information recording medium 102. Then, the resin is cured with ultraviolet light to form bonding layer 5. Thus, information recording media 100 (Disc Nos. 2-101 to 104) of the present example are prepared.

### Comparative Example 2

An information recording medium (Disc No. 2-001) is prepared that has the same configuration as the information recording media of Example 2-1 except that first dielectric films 21 of A-side information recording medium 101 and B-side information recording medium 102 are formed as (ZrO₂)₁₅(SiO₂)₁₅(In₂O₃)₇₀ (mol %) having a thickness of 17 nm and recording films 22 are formed as W₃₃Cu₁₆Mn₁₇Zn₃₄—O having a thickness of 35 nm.

The information recording media of the example and the comparative example are evaluated for the groove reflectance, the reproduction durability, and the signal quality of the L1 layer. The power for reproduction of Disc Nos. 2-101 to 104 shows standardized values, with the power for reproduction of Disc No. 2-001 set as the reference value. Disc No. 2-001 is used as an object for comparison in the comprehensive evaluation. Disc No. 2-001 has an amount of light for reproduction (reflectance R×power for reproduction Pr) of 0.048 with which it is impossible to obtain good reproduction signal quality. Table 10 shows results of the comprehensive evaluation.

TABLE 10

| | | | Groove | | Amount of | | |
|---|---|---|---|---|---|---|---|
| | A-side information recording | A-side information recording | reflectance | Power for | light for | | |
| Disc | medium 101/First dielectric | medium 101/Recording | R | reproduction | reproduction | | Comprehensive |
| No. | film 21 (L1 layer) | film 22 (L1 layer) | (%) | Pr | R × Pr | c-bER | evaluation |
| 2-101 | Nb₂O₅ | W₃₃Cu₁₆Mn₁₇Mo₃₄ (atom %) | 5.6 | 1.00 | 0.056 | 8.8 × E−4 | ⊚ |
| 2-102 | Nb₂O₅ | W₃₃Cu₁₆Mn₁₇Nb₃₄ (atom %) | 5.8 | 1.00 | 0.058 | 8.6 × E−4 | ⊚ |
| 2-103 | Nb₂O₅ | W₃₃Cu₁₆Mn₁₇Ta₃₄ (atom %) | 5.7 | 1.00 | 0.057 | 8.8 × E−4 | ⊚ |
| 2-104 | Nb₂O₅ | W₃₃Cu₁₆Mn₁₇Ti₃₄ (atom %) | 6.0 | 0.85 | 0.051 | 1.2 × E−3 | ◯ |
| 2-001 | (ZrO₂)₁₅(SiO₂)₁₅(In₂O₃)₇₀(mol %) | W₃₃Cu₁₆Mn₁₇Zn₃₄ (atom %) | 4.8 | 1.00 | 0.048 | 3.2 × E−3 | X |

Comparison of Disc Nos. 2-101 to 104 with Disc No. 2-001 clarifies that first dielectric film 21 containing an oxide of the D1 and recording film 22 containing W, Cu, Mn, and the M improve the reflectance and thus improve the amount of light for reproduction. That is, when applied to L1 layer 20, a combination of the first dielectric film having a specific composition with the recording film having a specific composition is confirmed to be capable of improving the amount of light for reproduction of L1 layer 20. B-side information recording medium 102 is also observed to similarly, for example, improve the amount of light for reproduction of L1 layer 20.

### Example 2-2

In the present example, an information recording medium is described that is configured by forming, as described as a modified example of the second exemplary embodiment, the third dielectric film between and in contact with intermediate separation layer 2 and first dielectric film 21.

In the present example, information recording media (Disc Nos. 2-113 to 124) are prepared similarly to Example 2-1 except that the third dielectric film is formed as (ZrO₂)₃₀(SiO₂)₃₀(In₂O₃)₄₀ (mol %) having a thickness of 5 nm, first dielectric film 21 is formed as a dielectric film having a thickness of 17 nm and a composition shown in Table 1, and recording film 22 is formed as a film having a thickness of 35 nm and a composition shown in Table 11. Formation of the third dielectric film is performed in an Ar atmosphere or an Ar and O₂ atmosphere, using a DC power source or a pulse DC power source.

As described in the exemplary embodiments, the third dielectric film may contain C derived from organic matter desorbed from intermediate separation layer 2. In the present specification, however, C is not described in the composition of the third dielectric film. The same applies to the third dielectric films below.

When C is contained, C tends to be contained in a large amount at a location that allows the film to start to be deposited and that is close to Intermediate separation layer 2.

These discs are evaluated for the groove reflectance, the reproduction durability, and the signal quality of the L1 layer. The power for reproduction of Disc Nos. 2-113 to 124 shows standardized values, with the power for reproduction of Disc No. 2-001 set as the reference value. Disc No. 2-001 is used as an object for comparison in the comprehensive evaluation. Table 11 shows results of the comprehensive evaluation.

TABLE 11

| | A-side information | A-side information | A-side information | | | | | |
|---|---|---|---|---|---|---|---|---|
| | recording | recording | recording | Groove | | Amount of | | |
| | medium/Third | medium/First | medium/Recording | reflectance | Power for | light for | | |
| Disc | dielectric film | dielectric film 21 | film 22 | R | reproduction | reproduction | | Comprehensive |
| No. | (L1 layer) | (L1 layer) | (L1 layer) | (%) | Pr | R × Pr | c-bER | evaluation |
| 2-113 | (ZrO₂)₃₀(SiO₂)₃₀ | Nb₂O₅ | W₃₃Cu₁₆Mn₁₇Mo₃₄ | 5.7 | 1.45 | 0.083 | 8.6 × E−4 | ⊚ |
| | (In₂O₃)₄₀(mol %) | | (atom %) | | | | | |
| 2-114 | (ZrO₂)₃₀(SiO₂)₃₀ | Nb₂O₅ | W₃₃Cu₁₆Mn₁₇Nb₃₄ | 5.9 | 1.45 | 0.086 | 8.4 × E−4 | ⊚ |
| | (In₂O₃)₄₀(mol %) | | (atom %) | | | | | |
| 2-115 | (ZrO₂)₃₀(SiO₂)₃₀ | Nb₂O₅ | W₃₃Cu₁₆Mn₁₇Ta₃₄ | 5.8 | 1.50 | 0.087 | 8.1 × E−4 | ⊚ |
| | (In₂O₃)₄₀(mol %) | | (atom %) | | | | | |
| 2-116 | (ZrO₂)₃₀(SiO₂)₃₀ | Nb₂O₅ | W₃₃Cu₁₆Mn₁₇Ti₃₄ | 6.1 | 1.25 | 0.076 | 9.6 × E−4 | ⊚ |
| | (In₂O₃)₄₀(mol %) | | (atom %) | | | | | |
| 2-117 | (ZrO₂)₃₀(SiO₂)₃₀ | MoO₃ | W₃₃Cu₁₆Mn₁₇Mo₃₄ | 5.4 | 1.45 | 0.078 | 9.8 × E−4 | ⊚ |
| | (In₂O₃)₄₀(mol %) | | (atom %) | | | | | |
| 2-118 | (ZrO₂)₃₀(SiO₂)₃₀ | Ta₂O₅ | W₃₃Cu₁₆Mn₁₇Mo₃₄ | 5.5 | 1.50 | 0.083 | 8.6 × E−4 | ⊚ |
| | (In₂O₃)₄₀(mol %) | | (atom %) | | | | | |
| 2-119 | (ZrO₂)₃₀(SiO₂)₃₀ | Nb₂O₅ | W₃₀Cu₂₀Mn₂₀Mo₃₀ | 5.9 | 1.40 | 0.083 | 8.0 × E−4 | ⊚ |
| | (In₂O₃)₄₀(mol %) | | (atom %) | | | | | |
| 2-120 | (ZrO₂)₃₀(SiO₂)₃₀ | Nb₂O₅ | W₃₀Cu₂₀Mn₂₀Nb₃₀ | 6.1 | 1.40 | 0.085 | 7.6 × E−4 | ⊚ |
| | (In₂O₃)₄₀(mol %) | | (atom %) | | | | | |
| 2-121 | (ZrO₂)₃₀(SiO₂)₃₀ | Nb₂O₅ | W₃₀Cu₂₀Mn₂₀Ta₃₀ | 6.0 | 1.40 | 0.084 | 7.8 × E−4 | ⊚ |
| | (In₂O₃)₄₀(mol %) | | (atom %) | | | | | |
| 2-122 | (ZrO₂)₃₀(SiO₂)₃₀ | Nb₂O₅ | W₃₀Cu₂₀Mn₂₀Ti₃₀ | 6.3 | 1.15 | 0.072 | 9.0 × E−4 | ⊚ |
| | (In₂O₃)₄₀(mol %) | | (atom %) | | | | | |
| 2-123 | (ZrO₂)₃₀(SiO₂)₃₀ | MoO₃ | W₃₀Cu₂₀Mn₂₀Mo₃₀ | 5.6 | 1.40 | 0.078 | 9.3 × E−4 | ⊚ |
| | (In₂O₃)₄₀(mol %) | | (atom %) | | | | | |
| 2-124 | (ZrO₂)₃₀(SiO₂)₃₀ | Ta₂O₅ | W₃₀Cu₂₀Mn₂₀Mo₃₀ | 5.7 | 1.45 | 0.083 | 8.4 × E−4 | ⊚ |
| | (In₂O₃)₄₀(mol %) | | (atom %) | | | | | |
| 2-001 | — | (ZrO₂)₁₅(SiO₂)₁₅ | W₃₃Cu₁₆Mn₁₇Zn₃₄ | 4.8 | 1.00 | 0.048 | 3.2 × E−3 | X |
| | | (In₂O₃)₇₀(mol %) | (atom %) | | | | | |

Any of the discs of the example gave a larger amount of light for reproduction than the disc of the comparative example. Comparison of Disc Nos. 2-101 to 104 (see Table 10) with Disc Nos. 2-113 to 116 clarifies that provision of the third dielectric film makes the reflectance and the power for reproduction (reproduction durability) higher to improve the amount of light for reproduction. Further, comparison of Disc Nos. 2-113 to 118 with Disc Nos. 2-119 to 124 clarifies that recording film 22 containing more Cu and Mn improves the reflectance. The B-side information recording medium is also observed to similarly improve the reflectance and the power for reproduction of the L1 layer.

### Example 2-3

In the present example, one example of information recording medium 200 shown in FIG. 2 is described. First, a configuration of A-side information recording medium 201 is described. As substrate 1, a polycarbonate substrate (diameter: 120 mm, thickness 0.5 mm) is prepared that includes a spiral guide groove (depth: 30 nm, track pitch (land-groove distance): 0.225 μm). Third dielectric film 14a, first dielectric film 11, recording film 12, and second dielectric film 13 are sequentially formed on substrate 1 by a sputtering method, with third dielectric film 14a formed as (ZrO₂)₂₅(SiO₂)₂₅(In₂O₃)₅₀ (mol %) having a thickness of 5 nm, first dielectric film 11 formed as Nb₂O₅ having a thickness of 12 nm, recording film 12 formed as W₂₅Cu₂₁Mn₂₈TA₂₁Zn₅—O having a thickness of 31 nm, and second dielectric film 13 formed as (ZrO₂)₂₅(SiO₂)₂₅(In₂O₂)₅₀ (mol %) having a thickness of 9 nm. When irradiated with laser beam 6 having a wavelength of 405 nm, L0 layer 10a that is provided with neither L1 layer 20 nor L2 layer 30 and is unrecorded has a reflectance R_{g} of nearly equal to 10.0% and a reflectance Rₗ of nearly equal to 11.0%.

Formation of third dielectric film 14a and second dielectric film 13 is performed in an Ar atmosphere, using a DC power source or a pulse DC power source. Formation of first dielectric film 11 is performed in an Ar atmosphere or an Ar and O₂ mixed-gas atmosphere, using a DC power source or a pulse DC power source. Formation of recording film 12 is performed with an alloy target containing all the constituent elements, in an Ar and O₂ mixed-gas atmosphere, using a pulse DC power source.

Subsequently, intermediate separation layer 2 provided with a spiral guide groove (depth: 30 nm, track pitch (land-groove distance): 0.225 μm) is formed on L0 layer 10a. Specifically, a main portion that occupies most of the thickness of intermediate separation layer 2 is first formed by spin coating with an ultraviolet-curable resin and curing by irradiation with ultraviolet light. Next, a surface of the main portion is spin-coated with an ultraviolet-curable resin, a transfer substrate that includes a guide groove and is made of polycarbonate is bonded onto the resin, the resin is cured with ultraviolet light, and then the transfer substrate is peeled, to form intermediate separation layer 2 including a guide groove. Intermediate separation layer 2 has a thickness of about 25 μm.

L1 layer 20 is formed on intermediate separation layer 2. Specifically, first dielectric film 21, recording film 22, and second dielectric film 23 in L1 layer 20 are sequentially formed by a sputtering method, with first dielectric film 21 formed as (ZrO₂)₃₀(SiO₂)₃₀(In₂O₃)₄₀ (mol %) having a thickness of 20 nm, recording film 22 formed as a film having a thickness of 35 nm and a composition shown in Table 12, and second dielectric film 23 formed as (ZrO₂)₂₅(SiO₂)₂₅(In₂O₃)₅₀ (mol %) having a thickness of 12 nm. When irradiated with 405-nm laser beam 6, L1 layer 20 that is provided with no L2 layer 30 and is unrecorded has a reflectance R_{g} of nearly equal to 5.5% to 8.0%, a reflectance Rₗ of nearly equal to 6.0% to 8.5%, and a transmittance of 67% to 78%.

Formation of first dielectric film 21 and second dielectric film 23 is performed in an Ar atmosphere, using a DC power source or a pulse DC power source. Formation of recording film 22 is performed in an Ar and O₂ mixed-gas atmosphere, using a pulse DC power source. With a total amount of the metal elements defined as 100 atom %, recording film 22 that has a composition including 20 atom % to 50 atom % of W is formed by sputtering with use of an alloy target containing all the constituent elements. Recording film 22 that has a different composition is formed by multi-sputtering (cosputtering) that simultaneously sputters respective metal targets of the constituent elements.

Subsequently, intermediate separation layer 3 provided with a spiral guide groove (depth: 30 nm, track pitch (land-groove distance): 0.225 μm) is formed on L1 layer 20. Intermediate separation layer 3 is formed by the same method as for intermediate separation layer 2. Intermediate separation layer 3 has a thickness of about 18 μm.

L2 layer 30 is formed on intermediate separation layer 3. First dielectric film 31, recording film 32, and second dielectric film 33 are sequentially formed by a sputtering method, with first dielectric film 31 formed as (ZrO₂)₃₀(SiO₂)₃₀(In₂O₃)₄₀ (mol %) having a thickness of 21 nm, recording film 32 formed as W₃₁Cu₁₈Mn₁₉Ta₂₁Zn₁₁—O having a thickness of 34 nm, and second dielectric film 33 formed as (ZrO₂)₂₅(SiO₂)₂₅(In₂O₃)₅₀ (mol %) having a thickness of 19 nm.

Film thickness of first dielectric film 31 and second dielectric film 33 is determined by calculation based on a matrix method. Specifically, the film thickness is determined so that unrecorded L2 layer 30 has a reflectance R_{g} of nearly equal to 5.8%, a reflectance Rₗ of nearly equal to 6.3%, and a transmittance of about 79% when irradiated with 405-nm laser beam 6.

Formation of first dielectric film 31 and second dielectric film 33 is performed in an Ar atmosphere, using a DC power source or a pulse DC power source. Formation of recording film 32 is performed with an alloy target containing all the constituent elements, in an Ar and O₂ mixed-gas atmosphere, using a pulse DC power source.

Thereafter, an ultraviolet-curable resin is applied onto second dielectric film 33, followed by spin coating, and is then cured with ultraviolet light, to form cover layer 4 having a thickness of about 57 μm. This procedure completes preparation of A-side information recording medium 201.

Next, a configuration of B-side information recording medium 202 is described. As substrate 1, a polycarbonate substrate (diameter: 120 mm, thickness 0.5 mm) is prepared that includes a spiral guide groove (depth: 30 nm, track pitch (land-groove distance): 0.225 μm). A spiral rotation direction of the guide groove is made opposite to a spiral rotation direction of the guide groove formed in substrate 1 of A-side information recording medium 201 described above.

L0 layer 10a, intermediate separation layer 2, L1 layer 20, intermediate separation layer 3, L2 layer 30, and cover layer 4 are formed on substrate 1. In B-side information recording medium 102, the films (the first dielectric films, the recording films, and the second dielectric films) that constitute the information layers are formed so that the information layers have the same configurations (e.g., the composition and the thickness of the films and the reflectances and the transmittances of the information layers) as the information layers of A-side information recording medium 201. The films are formed by the same methods as the methods employed in the formation of A-side information recording medium 201. Cover layer 4 is also made to have the same configuration as cover layer 4 of A-side information recording medium 201 and is formed by the same method. Intermediate separation layers 2 and 3 also have the same configurations as the intermediate separation layers of A-side information recording medium 201. In B-side information recording medium 202, however, a rotation direction of the spiral guide groove provided in intermediate separation layers 2 and 3 is opposite to a spiral rotation direction of the guide groove provided in intermediate separation layers 2 and 3 of A-side information recording medium 201.

Lastly, an ultraviolet-curable resin is uniformly applied to a surface opposite from the guide groove-provided surface of substrate 1 in A-side information recording medium 201, and the applied resin is bonded to a surface opposite from the guide groove-provided surface of substrate 1 in B-side information recording medium 202. Then, the resin is cured with ultraviolet light to form bonding layer 5. Thus, information recording media 200 (Disc Nos. 2-125 to 138) of the present example are prepared.

The information recording media of the example and the comparative example are evaluated for the groove reflectance, the reproduction durability, and the signal quality of the L1 layer. The power for reproduction of Disc Nos. 2-125 to 138 shows standardized values, with the power for reproduction of Disc No. 2-001 set as the reference value. Disc No. 2-001 is used as an object for comparison in the comprehensive evaluation. Table 12 shows results of the comprehensive evaluation.

TABLE 12

| | | | Groove | | Amount of | | |
|---|---|---|---|---|---|---|---|
| | A-side information recording | A-side information recording | reflectance | Power for | light for | | |
| Disc | medium 201/First dielectric | medium 201/Recording | R | reproduction | reproduction | | Comprehensive |
| No. | film 21 (L1 layer) | film 22 (L1 layer) | (%) | Pr | R × Pr | c-bER | evaluation |
| 2-125 | (ZrO₂)₃₀(SiO₂)₃₀(In₂O₃)₄₀ | W₃₃Cu₁₆Mn₁₇Mo₃₄ (atom %) | 4.9 | 1.43 | 0.070 | 9.8 × E−4 | ⊚ |
| | (mol %) | | | | | | |
| 2-126 | (ZrO₂)₃₀(SiO₂)₃₀(In₂O₃)₄₀ | W₃₃Cu₁₆Mn₁₇Nb₃₄ (atom %) | 5.1 | 1.38 | 0.070 | 8.8 × E−4 | ⊚ |
| | (mol %) | | | | | | |
| 2-127 | (ZrO₂)₃₀(SiO₂)₃₀(In₂O₃)₄₀ | W₃₃Cu₁₆Mn₁₇Ta₃₄ (atom %) | 4.9 | 1.38 | 0.068 | 8.2 × E−4 | ⊚ |
| | (mol %) | | | | | | |
| 2-128 | (ZrO₂)₃₀(SiO₂)₃₀(In₂O₃)₄₀ | W₃₃Cu₁₆Mn₁₇Ti₃₄ (atom %) | 5.4 | 1.25 | 0.068 | 1.3 × E−3 | ◯ |
| | (mol %) | | | | | | |
| 2-129 | (ZrO₂)₃₀(SiO₂)₃₀(In₂O₃)₄₀ | W₃₀Cu₂₀Mn₂₀Mo₃₀ (atom %) | 5.0 | 1.40 | 0.070 | 9.3 × E−4 | ⊚ |
| | (mol %) | | | | | | |
| 2-130 | (ZrO₂)₃₀(SiO₂)₃₀(In₂O₃)₄₀ | W₃₀Cu₂₀Mn₂₀Nb₃₀ (atom %) | 5.3 | 1.35 | 0.072 | 8.2 × E−4 | ⊚ |
| | (mol %) | | | | | | |
| 2-131 | (ZrO₂)₃₀(SiO₂)₃₀(In₂O₃)₄₀ | W₃₀Cu₂₀Mn₂₀Ta₃₀ (atom %) | 5.1 | 1.33 | 0.068 | 7.8 × E−4 | ⊚ |
| | (mol %) | | | | | | |
| 2-132 | (ZrO₂)₃₀(SiO₂)₃₀(In₂O₃)₄₀ | W₃₀Cu₂₀Mn₂₀Ti₃₀ (atom %) | 5.5 | 1.22 | 0.067 | 1.2 × E−3 | ◯ |
| | (mol %) | | | | | | |
| 2-133 | (ZrO₂)₃₀(SiO₂)₃₀(In₂O₃)₄₀ | W₃₀Cu₂₀Mn₂₀Ta₂₅Zn₅ (atom %) | 5.0 | 1.33 | 0.067 | 7.5 × E−4 | ⊚ |
| | (mol %) | | | | | | |
| 2-134 | (ZrO₂)₃₀(SiO₂)₃₀(In₂O₃)₄₀ | W₃₁Cu₁₈Mn₁₉Mo₂₁Zn₁₁ | 4.9 | 1.40 | 0.069 | 9.4 × E−4 | ⊚ |
| | (mol %) | (atom %) | | | | | |
| 2-135 | (ZrO₂)₃₀(SiO₂)₃₀(In₂O₃)₄₀ | W₃₁Cu₁₈Mn₁₉Nb₂₁Zn₁₁ | 5.1 | 1.37 | 0.070 | 8.0 × E−4 | ⊚ |
| | (mol %) | (atom %) | | | | | |
| 2-136 | (ZrO₂)₃₀(SiO₂)₃₀(In₂O₃)₄₀ | W₃₁Cu₁₈Mn₁₉Ta₂₁Zn₁₁ | 5.0 | 1.32 | 0.066 | 7.3 × E−4 | ⊚ |
| | (mol %) | (atom %) | | | | | |
| 2-137 | (ZrO₂)₃₀(SiO₂)₃₀(In₂O₃)₄₀ | W₂₁Cu₁₈Mn₁₉Ta₂₁Zn₂₁ (atom %) | 5.0 | 1.30 | 0.065 | 7.5 × E−4 | ⊚ |
| | (mol %) | | | | | | |
| 2-138 | (ZrO₂)₃₀(SiO₂)₃₀(In₂O₃)₄₀ | W₂₁Cu₁₈Mn₁₉Ta₁₆Zn₂₆ (atom %) | 4.9 | 1.26 | 0.062 | 7.7 × E−4 | ⊚ |
| | (mol %) | | | | | | |
| 2-001 | (ZrO₂)₁₅(SiO₂)₁₅(In₂O₃)₇₀ | W₃₃Cu₁₆Mn₁₇Zn₃₄ (atom %) | 4.8 | 1.00 | 0.048 | 3.2 × E−3 | X |
| | (mol %) | | | | | | |

Any of the discs of the example gave a larger amount of light for reproduction than the disc of the comparative example. B-side information recording medium 202 is also observed to similarly, for example, improve the amount of light for reproduction of L1 layer 20.

### Example 2-4

In the present example, one example of information recording medium 200 shown in FIG. 2 is described. In the present example, information recording media 200 (Disc Nos. 2-139 to 150) are prepared similarly to Example 2-3 except that first dielectric film 21 in L1 layer 20 is formed as a film that has a thickness of 20 nm and is shown in Table 13 and recording film 22 is formed as W₃₁Cu₁₈Mn₁₉Ta₂₁Zn₁₁—O having a thickness of 35 nm.

These discs are evaluated for the groove reflectance, the reproduction durability, and the signal quality of L1 layer 20. The power for reproduction of Disc Nos. 2-139 to 150 shows standardized values, with the power for reproduction of Disc No. 2-001 set as the reference value. Disc No. 2-001 is used as an object for comparison in the comprehensive evaluation. Table 13 shows results of the comprehensive evaluation.

TABLE 13

| | | | Groove | | Amount of | | |
|---|---|---|---|---|---|---|---|
| | A-side information recording | A-side information recording | reflectance | Power for | light for | | |
| Disc | medium 201/First dielectric | medium 201/Recording | R | reproduction | reproduction | | Comprehensive |
| No. | film 21 (L1 layer) | film 22 (L1 layer) | (%) | Pr | R × Pr | c-bER | evaluation |
| 2-139 | (ZrO₂)₂₅(SiO₂)₃₅(In₂O₃)₄₀ | W₃₁Cu₁₈Mn₁₉Ta₂₁Zn₁₁ | 4.8 | 1.26 | 0.060 | 7.8 × E−4 | ⊚ |
| | (mol %) | (atom %) | | | | | |
| 2-140 | (ZrO₂)₃₀(SiO₂)₃₀(In₂O₃)₄₀ | W₃₁Cu₁₈Mn₁₉Ta₂₁Zn₁₁ | 5.0 | 1.32 | 0.066 | 7.3 × E−4 | ⊚ |
| | (mol %) | (atom %) | | | | | |
| 2-141 | (ZrO₂)₃₅(SiO₂)₂₅(In₂O₃)₄₀ | W₃₁Cu₁₈Mn₁₉Ta₂₁Zn₁₁ | 5.0 | 1.37 | 0.069 | 7.5 × E−4 | ⊚ |
| | (mol %) | (atom %) | | | | | |
| 2-142 | (ZrO₂)₄₀(SiO₂)₂₀(In₂O₃)₄₀ | W₃₁Cu₁₈Mn₁₉Ta₂₁Zn₁₁ | 5.1 | 1.44 | 0.073 | 7.3 × E−4 | ⊚ |
| | (mol %) | (atom %) | | | | | |
| 2-143 | (ZrO₂)₄₅(SiO₂)₁₅(In₂O₃)₄₀ | W₃₁Cu₁₈Mn₁₉Ta₂₁Zn₁₁ | 5.1 | 1.50 | 0.077 | 7.8 × E−4 | ⊚ |
| | (mol %) | (atom %) | | | | | |
| 2-144 | (ZrO₂)₅₀(SiO₂)₁₀(In₂O₃)₄₀ | W₃₁Cu₁₈Mn₁₉Ta₂₁Zn₁₁ | 5.2 | 1.53 | 0.080 | 7.8 × E−4 | ⊚ |
| | (mol %) | (atom %) | | | | | |
| 2-145 | (ZrO₂)₃₅(SiO₂)₂₀(In₂O₃)₄₅ | W₃₁Cu₁₈Mn₁₉Ta₂₁Zn₁₁ | 5.1 | 1.40 | 0.071 | 7.7 × E−4 | ⊚ |
| | (mol %) | (atom %) | | | | | |
| 2-146 | (ZrO₂)₄₀(SiO₂)₁₅(In₂O₃)₄₅ | W₃₁Cu₁₈Mn₁₉Ta₂₁Zn₁₁ | 5.2 | 1.44 | 0.075 | 8.0 × E−4 | ⊚ |
| | (mol %) | (atom %) | | | | | |
| 2-147 | (ZrO₂)₄₅(SiO₂)₁₀(In₂O₃)₄₅ | W₃₁Cu₁₈Mn₁₉Ta₂₁Zn₁₁ | 5.3 | 1.48 | 0.078 | 7.7 × E−4 | ⊚ |
| | (mol %) | (atom %) | | | | | |
| 2-148 | (ZrO₂)₃₅(SiO₂)₁₅(In₂O₃)₅₀ | W₃₁Cu₁₈Mn₁₉Ta₂₁Zn₁₁ | 5.2 | 1.35 | 0.070 | 7.4 × E−4 | ⊚ |
| | (mol %) | (atom %) | | | | | |
| 2-149 | (ZrO₂)₄₀(SiO₂)₁₀(In₂O₃)₅₀ | W₃₁Cu₁₈Mn₁₉Ta₂₁Zn₁₁ | 5.3 | 1.40 | 0.074 | 7.5 × E−4 | ⊚ |
| | (mol %) | (atom %) | | | | | |
| 2-150 | (ZrO₂)₄₅(SiO₂)₅(In₂O₃)₅₀ | W₃₁Cu₁₈Mn₁₉Ta₂₁Zn₁₁ | 5.4 | 1.43 | 0.077 | 8.0 × E−4 | ⊚ |
| | (mol %) | (atom %) | | | | | |
| 2-001 | (ZrO₂)₁₅(SiO₂)₁₅(In₂O₃)₇₀ | W₃₃Cu₁₆Mn₁₇Zn₃₄ | 4.8 | 1.00 | 0.048 | 3.2 × E−3 | X |
| | (mol %) | (atom %) | | | | | |

Any of the discs of the example gave a larger amount of light for reproduction than the disc of the comparative example. According to comparison of Disc No. 2-139 with Disc Nos. 2-140 to 144, first dielectric films 21 having the same amount of In₂O₃ improve the power for reproduction along with an increase of the amount of ZrO₂. According to this fact, it is possible to obtain L1 layer 20 having higher power for reproduction (reproduction durability) by making the amount of Zr larger than the amount of Si in first dielectric film 21.

### Example 3-1

In the present example, one example of information recording medium 100 shown in FIG. 1 is described. First, a configuration of A-side information recording medium 101 is described. As substrate 1, a polycarbonate substrate (diameter: 120 mm, thickness 0.5 mm) is prepared that includes a spiral guide groove (depth: 30 nm, track pitch (land-groove distance): 0.225 μm). First dielectric film 11, recording film 12, and second dielectric film 13 are sequentially formed on substrate 1 by a sputtering method, with first dielectric film 11 formed as Nb₂O₅ having a thickness of 17 nm, recording film 12 formed as W₁₉Cu₂₅Zn₂₀Mn₃₆—O having a thickness of 31 nm, and second dielectric film 13 formed as (ZrO₂)₂₅(SiO₂)₂₅(In₂O₃)₅₀ (mol %) having a thickness of 9 nm. When irradiated with laser beam 6 having a wavelength of 405 nm, L0 layer 10 that is provided with neither L1 layer 20 nor L2 layer 30 and is unrecorded has a reflectance R_{g} of nearly equal to 11.5% and a reflectance Rₗ of nearly equal to 12.3%.

Formation of first dielectric film 11 is performed in an Ar and O₂ mixed-gas atmosphere, using a DC power source or a pulse DC power source. Recording film 12 is formed in an Ar and O₂ mixed-gas atmosphere, using a DC power source, by multi-sputtering (cosputtering) that simultaneously sputters respective metal targets of the constituent elements. Formation of second dielectric film 13 is performed in an Ar atmosphere, using a DC power source or a pulse DC power source.

Subsequently, intermediate separation layer 2 provided with a spiral guide groove (depth: 30 nm, track pitch (land-groove distance): 0.225 μm) is formed on L0 layer 10. Specifically, a main portion that occupies most of the thickness of intermediate separation layer 2 is first formed by spin coating with an ultraviolet-curable resin and curing by irradiation with ultraviolet light. Next, a surface of the main portion is spin-coated with an ultraviolet-curable resin, a transfer substrate that includes a guide groove and is made of polycarbonate is bonded onto the resin, the resin is cured with ultraviolet light, and then the transfer substrate is peeled, to form intermediate separation layer 2 including a guide groove. Intermediate separation layer 2 has a thickness of about 25 μm.

L1 layer 20 is formed on intermediate separation layer 2. Specifically, first dielectric film 21, recording film 22, and second dielectric film 23 in L1 layer 20 are sequentially formed by a sputtering method, with first dielectric film 21 formed as (ZrO₂)₃₀(SiO₂)₃₀(In₂O₃)₄₀ (mol %) having a thickness of 17 nm, recording film 22 formed as W₃₃Cu₁₆Zn₃₄Mn₁₇—O having a thickness of 35 nm, and second dielectric film 23 formed as (ZrO₂)₂₅(SiO₂)₂₅(In₂O₃)₅₀ (mol %) having a thickness of 7 nm.

Film thickness of first dielectric film 21 and second dielectric film 23 is determined by calculation based on a matrix method. Specifically, the film thickness is determined so that L1 layer 20 that is provided with no L2 layer 30 and is unrecorded has a reflectance R_{g} of nearly equal to 7.8%, a reflectance Rₗ of nearly equal to 8.2%, and a transmittance of 72% when irradiated with 405-nm laser beam 6.

Formation of first dielectric film 21 and second dielectric film 23 is performed in an Ar atmosphere, using a DC power source or a pulse DC power source. Formation of recording film 22 is performed with an alloy target, in an Ar and O₂ mixed-gas atmosphere, using a pulse DC power source.

Subsequently, intermediate separation layer 3 provided with a spiral guide groove (depth: 30 nm, track pitch (land-groove distance): 0.225 μm) is formed on L1 layer 20. Intermediate separation layer 3 is formed by the same method as for intermediate separation layer 2. The intermediate separation layer has a thickness of about 18 μm.

L2 layer 30 is formed on intermediate separation layer 3. First dielectric film 31, recording film 32, and second dielectric film 33 are sequentially formed by a sputtering method, with first dielectric film 31 formed as a dielectric film having a thickness of 19 nm and a composition shown in Table 14, recording film 32 formed as a film having a thickness of 38 nm and a composition shown in Table 14, and second dielectric film 33 formed as (ZrO₂)₂₅(SiO₂)₂₅(In₂O₃)₅₀ (mol %) having a thickness of 9 nm. When irradiated with 405-nm laser beam 6, unrecorded L2 layer 30 has a reflectance R_{g} of nearly equal to 5.0% to 9.0%, a reflectance Rₗ of nearly equal to 5.5% to 9.0%, and a transmittance of about 68% to 83%.

Formation of first dielectric film 31 is performed in an Ar atmosphere or an Ar and O₂ mixed-gas atmosphere, using a DC power source, a pulse DC power source, or an RF power source. Formation of recording film 32 is performed in an Ar and O₂ mixed-gas atmosphere, using a pulse DC power source. With a total amount of the metal elements defined as 100 atom %, recording film 32 that has a composition including 20 atom % to 50 atom % of W is formed by sputtering with use of an alloy target containing all the constituent elements. Recording film 32 that has a different composition is formed by multi-sputtering (cosputtering) that simultaneously sputters respective metal targets of the constituent elements. Formation of second dielectric film 33 is performed in an Ar atmosphere, using a DC power source or a pulse DC power source.

Thereafter, an ultraviolet-curable resin is applied onto second dielectric film 33, followed by spin coating, and is then cured with ultraviolet light, to form cover layer 4 having a thickness of about 57 μm. This procedure completes preparation of A-side information recording medium 101.

Next, a configuration of B-side information recording medium 102 is described. As substrate 1, a polycarbonate substrate (diameter: 120 mm, thickness 0.5 mm) is prepared that includes a spiral guide groove (depth: 30 nm, track pitch (land-groove distance): 0.225 μm). A spiral rotation direction of the guide groove is made opposite to a spiral rotation direction of the guide groove formed in substrate 1 of A-side information recording medium 101 described above.

L0 layer 10, intermediate separation layer 2, L1 layer 20, intermediate separation layer 3, L2 layer 30, and cover layer 4 are formed on substrate 1. In B-side information recording medium 102, the films (the first dielectric films, the recording films, and the second dielectric films) that constitute the information layers are formed so that the information layers have the same configurations (e.g., the composition and the thickness of the films and the reflectances and the transmittances of the information layers) as the information layers of A-side information recording medium 101. The films are formed by the same methods as the methods employed in the formation of A-side information recording medium 101. Cover layer 4 is also made to have the same configuration as cover layer 4 of A-side information recording medium 101 and is formed by the same method. Intermediate separation layers 2 and 3 also have the same configurations as the intermediate separation layers of A-side information recording medium 101. In B-side information recording medium 102, however, a rotation direction of the spiral guide groove provided in intermediate separation layers 2 and 3 is opposite to a spiral rotation direction of the guide groove provided in intermediate separation layers 2 and 3 of A-side information recording medium 101.

Lastly, an ultraviolet-curable resin is uniformly applied to a surface opposite from the guide groove-provided surface of substrate 1 in A-side information recording medium 101, and the applied resin is bonded to a surface opposite from the guide groove-provided surface of substrate 1 in B-side information recording medium 102. Then, the resin is cured with ultraviolet light to form bonding layer 5. Thus, information recording media 100 (Disc Nos. 3-101 to 104) of the present example are prepared.

### Comparative Example 3

An information recording medium (Disc No. 3-001) is prepared that has the same configuration as the information recording media of Example 3-1 except that first dielectric films 31 of A-side information recording medium 101 and B-side information recording medium 102 are formed as (ZrO₂)₁₅(SiO₂)₁₅(In₂O₃)₇₀ (mol %) having a thickness of 19 nm and recording films 32 are formed as W₃₃Cu₁₆Mn₁₇Zn₃₄—O having a thickness of 38 nm.

The information recording media of the example and the comparative example are evaluated for the groove reflectance, the reproduction durability, and the signal quality of the L2 layer. The power for reproduction of Disc Nos. 3-101 to 104 shows standardized values, with the power for reproduction of Disc No. 3-001 set as the reference value. Disc No. 3-001 is used as an object for comparison in the comprehensive evaluation. Disc No. 3-001 has an amount of light for reproduction (reflectance R×power for reproduction Pr) of 0.060 with which it is impossible to obtain good reproduction signal quality. Table 14 shows results of the comprehensive evaluation.

TABLE 14

| | | | Groove | | Amount of | | |
|---|---|---|---|---|---|---|---|
| | A-side information recording | A-side information recording | reflectance | Power for | light for | | |
| Disc | medium 101/First dielectric | medium 101/Recording | R | reproduction | reproduction | | Comprehensive |
| No. | film 31 (L2 layer) | film 32 (L2 layer) | (%) | Pr | R × Pr | c-bER | evaluation |
| 3-101 | Nb₂O₅ | W₃₈Cu₁₀Mn₁₄Mo₃₈ (atom %) | 6.9 | 1.00 | 0.069 | 9.2 × E−4 | ⊚ |
| 3-102 | Nb₂O₅ | W₃₈Cu₁₀Mn₁₄Nb₃₈ (atom %) | 7.2 | 1.00 | 0.072 | 9.0 × E−4 | ⊚ |
| 3-103 | Nb₂O₅ | W₃₈Cu₁₀Mn₁₄Ta₃₈ (atom %) | 7.1 | 1.00 | 0.071 | 8.6 × E−4 | ⊚ |
| 3-104 | Nb₂O₅ | W₃₈Cu₁₀Mn₁₄Ti₃₈ (atom %) | 7.4 | 0.85 | 0.063 | 1.5 × E−3 | ⊚ |
| 3-001 | (ZrO₂)₁₅(SiO₂)₁₅(In₂O₃)₇₀ | W₃₃Cu₁₆Mn₁₇Zn₃₄ (atom %) | 6.0 | 1.00 | 0.060 | 2.6 × E−3 | X |
| | (mol %) | | | | | | |

Comparison of Disc Nos. 3-101 to 104 with Disc No. 3-001 clarifies that first dielectric film 31 containing an oxide of the D1 and recording film 32 containing W, Cu, Mn, and the M improve the reflectance and thus improve the amount of light for reproduction. That is, when applied to L2 layer 30, a combination of the first dielectric film having a specific composition with the recording film having a specific composition is confirmed to be capable of improving the amount of light for reproduction of L2 layer 30. B-side information recording medium 102 is also observed to similarly, for example, improve the amount of light for reproduction of L2 layer 30.

### Example 3-2

In the present example, an information recording medium is described that is configured by forming, as described as a modified example of the second exemplary embodiment, the third dielectric film between and in contact with intermediate separation layer 3 and first dielectric film 31.

In the present example, information recording media (Disc Nos. 3-113 to 124) are prepared similarly to Example 3-1 except that the third dielectric film is formed as (ZrO₂)₃₀(SiO₂)₃₀(In₂O₃)₄₀ (mol %) having a thickness of 5 nm, first dielectric film 31 is formed as a dielectric film having a thickness of 17 nm and a composition shown in Table 15, and recording film 32 is formed as a film having a thickness of 35 nm and a composition shown in Table 15. Formation of the third dielectric film is performed in an Ar atmosphere or an Ar and O₂ atmosphere, using a DC power source or a pulse DC power source.

As described in the exemplary embodiments, the third dielectric film may contain C derived from organic matter desorbed from intermediate separation layer 3. In the present specification, however, C is not described in the composition of the third dielectric film. The same applies to the third dielectric films below.

When C is contained, C tends to be contained in a large amount at a location that allows the film to start to be deposited and that is close to Intermediate separation layer 3.

These discs are evaluated for the groove reflectance, the reproduction durability, and the signal quality of the L2 layer. The power for reproduction of Disc Nos. 3-113 to 124 shows standardized values, with the power for reproduction of Disc No. 3-001 set as the reference value. Disc No. 3-001 is used as an object for comparison in the comprehensive evaluation. Table 15 shows results of the comprehensive evaluation.

TABLE 15

| | A-side information | A-side information | | | | | | |
|---|---|---|---|---|---|---|---|---|
| | recording | recording | A-side information | Groove | | Amount of | | |
| | medium/Third | medium/First | recording medium/ | reflectance | Power for | light for | | |
| Disc | dielectric film | dielectric film 31 | Recording film 32 | R | reproduction | reproduction | | Comprehensive |
| No | (L2 layer) | (L2 layer) | (L2 layer) | (%) | Pr | R × Pr | c-bER | evaluation |
| 3-113 | (ZrO₂)₃₀(SiO₂)₃₀ | Nb₂O₅ | W₃₈Cu₁₀Mn₁₄Mo₃₈ | 6.9 | 1.50 | 0.104 | 8.2 × E−4 | ⊚ |
| | (In₂O₃)₄₀(mol %) | | (atom %) | | | | | |
| 3-114 | (ZrO₂)₃₀(SiO₂)₃₀ | Nb₂O₅ | W₃₈Cu₁₀Mn₁₄Nb₃₈ | 7.1 | 1.45 | 0.103 | 8.2 × E−4 | ⊚ |
| | (In₂O₃)₄₀(mol %) | | (atom %) | | | | | |
| 3-115 | (ZrO₂)₃₀(SiO₂)₃₀ | Nb₂O₅ | W₃₈Cu₁₀Mn₁₄Ta₃₈ | 7.0 | 1.50 | 0.105 | 8.0 × E−4 | ⊚ |
| | (In₂O₃)₄₀(mol %) | | (atom %) | | | | | |
| 3-116 | (ZrO₂)₃₀(SiO₂)₃₀ | Nb₂O₅ | W₃₈Cu₁₀Mn₁₄Ti₃₈ | 7.6 | 1.20 | 0.091 | 9.4 × E−4 | ⊚ |
| | (In₂O₃)₄₀(mol %) | | (atom %) | | | | | |
| 3-117 | (ZrO₂)₃₀(SiO₂)₃₀ | MoO₃ | W₃₈Cu₁₀Mn₁₄Mo₃₈ | 6.8 | 1.45 | 0.099 | 9.0 × E−4 | ⊚ |
| | (In₂O₃)₄₀(mol %) | | (atom %) | | | | | |
| 3-118 | (ZrO₂)₃₀(SiO₂)₃₀ | Ta₂O₅ | W₃₈Cu₁₀Mn₁₄Mo₃₈ | 7.0 | 1.50 | 0.105 | 8.6 × E−4 | ⊚ |
| | (In₂O₃)₄₀(mol %) | | (atom %) | | | | | |
| 3-119 | (ZrO₂)₃₀(SiO₂)₃₀ | Nb₂O₅ | W₃₃Cu₁₆Mn₁₇Mo₃₄ | 7.2 | 1.40 | 0.101 | 8.0 × E−4 | ⊚ |
| | (In₂O₃)₄₀(mol %) | | (atom %) | | | | | |
| 3-120 | (ZrO₂)₃₀(SiO₂)₃₀ | Nb₂O₅ | W₃₃Cu₁₆Mn₁₇Nb₃₄ | 7.4 | 1.35 | 0.100 | 7.6 × E−4 | ⊚ |
| | (In₂O₃)₄₀(mol %) | | (atom %) | | | | | |
| 3-121 | (ZrO₂)₃₀(SiO₂)₃₀ | Nb₂O₅ | W₃₃Cu₁₆Mn₁₇Ta₃₄ | 7.3 | 1.40 | 0.102 | 7.8 × E−4 | ⊚ |
| | (In₂O₃)₄₀(mol %) | | (atom %) | | | | | |
| 3-122 | (ZrO₂)₃₀(SiO₂)₃₀ | Nb₂O₅ | W₃₃Cu₁₆Mn₁₇Ti₃₄ | 7.9 | 1.15 | 0.091 | 9.0 × E−4 | ⊚ |
| | (In₂O₃)₄₀(mol %) | | (atom %) | | | | | |
| 3-123 | (ZrO₂)₃₀(SiO₂)₃₀ | MoO₃ | W₃₃Cu₁₆Mn₁₇Mo₃₄ | 7.1 | 1.40 | 0.099 | 9.3 × E−4 | ⊚ |
| | (In₂O₃)₄₀(mol %) | | (atom %) | | | | | |
| 3-124 | (ZrO₂)₃₀(SiO₂)₃₀ | Ta₂O₅ | W₃₃Cu₁₆Mn₁₇Mo₃₄ | 7.2 | 1.40 | 0.101 | 8.4 × E−4 | ⊚ |
| | (In₂O₃)₄₀(mol %) | | (atom %) | | | | | |
| 3-001 | — | (ZrO₂)₁₅(SiO₂)₁₅ | W₃₃Cu₁₆Mn₁₇Zn₃₄ | 6.0 | 1.00 | 0.060 | 2.6 × E−3 | X |
| | | (In₂O₃)₇₀(mol %) | (atom %) | | | | | |

Any of the discs of the example gave a larger amount of light for reproduction than the disc of the comparative example. Comparison of Disc Nos. 3-113 to 116 with Disc Nos. 3-101 to 104 clarifies that provision of the third dielectric film makes the power for reproduction (reproduction durability) higher to improve the amount of light for reproduction. Further, comparison of Disc Nos. 3-113 to 118 with Disc Nos. 3-119 to 124 clarifies that recording film 32 containing more Cu and Mn improves the reflectance. The B-side information recording medium is also observed to similarly, for example, improve the power for reproduction of the L2 layer.

### Example 3-3

In the present example, one example of information recording medium 200 shown in FIG. 2 is described. First, a configuration of A-side information recording medium 201 is described. As substrate 1, a polycarbonate substrate (diameter: 120 mm, thickness 0.5 mm) is prepared that includes a spiral guide groove (depth: 30 nm, track pitch (land-groove distance): 0.225 μm). Third dielectric film 14a, first dielectric film 11, recording film 12, and second dielectric film 13 are sequentially formed on substrate 1 by a sputtering method, with third dielectric film 14a formed as (ZrO₂)₂₅(SiO₂)₂₅(In₂O₃)₅₀ (mol %) having a thickness of 5 nm, first dielectric film 11 formed as Nb₂O₅ having a thickness of 12 nm, recording film 12 formed as W₂₅Cu₂₁Mn₂₈Ta₂₁Zn₅—O having a thickness of 31 nm, and second dielectric film 13 formed as (ZrO₂)₂₅(SiO₂)₂₅(In₂O₃)₅₀ (mol %) having a thickness of 9 nm. When irradiated with laser beam 6 having a wavelength of 405 nm, L0 layer 10a that is provided with neither L1 layer 20 nor L2 layer 30 and is unrecorded has a reflectance R_{g} of nearly equal to 10.0% and a reflectance Rₗ of nearly equal to 11.0%.

Formation of third dielectric film 14a and second dielectric film 13 is performed in an Ar atmosphere, using a DC power source or a pulse DC power source. Formation of first dielectric film 11 is performed in an Ar atmosphere or an Ar and O₂ mixed-gas atmosphere, using a DC power source or a pulse DC power source. Formation of recording film 12 is performed with an alloy target containing all the constituent elements, in an Ar and O₂ mixed-gas atmosphere, using a pulse DC power source.

Subsequently, intermediate separation layer 2 provided with a spiral guide groove (depth: 30 nm, track pitch (land-groove distance): 0.225 μm) is formed on L0 layer 10a. Specifically, a main portion that occupies most of the thickness of intermediate separation layer 2 is first formed by spin coating with an ultraviolet-curable resin and curing by irradiation with ultraviolet light. Next, a surface of the main portion is spin-coated with an ultraviolet-curable resin, a transfer substrate that includes a guide groove and is made of polycarbonate is bonded onto the resin, the resin is cured with ultraviolet light, and then the transfer substrate is peeled, to form intermediate separation layer 2 including a guide groove. Intermediate separation layer 2 has a thickness of about 25 μm.

L1 layer 20 is formed on intermediate separation layer 2. Specifically, first dielectric film 21, recording film 22, and second dielectric film 23 in L1 layer 20 are sequentially formed by a sputtering method, with first dielectric film 21 formed as (ZrO₂)₃₀(SiO₂)₃₀(In₂O₃)₄₀ (mol %) having a thickness of 20 nm, recording film 22 formed as W₃₁Cu₁₈Mn₁₉Ta₂₁Zn₁₁—O having a thickness of 35 nm, and second dielectric film 23 formed as (ZrO₂)₂₅(SiO₂)₂₅(In₂O₃)₅₀ (mol %) having a thickness of 12 nm. When irradiated with 405-nm laser beam 6, L1 layer 20 that is provided with no L2 layer 30 and is unrecorded has a reflectance R_{g} of nearly equal to 6.8%, a reflectance Rₗ of nearly equal to 7.5%, and a transmittance of about 75%.

Formation of first dielectric film 21 and second dielectric film 23 is performed in an Ar atmosphere, using a DC power source or a pulse DC power source. Formation of recording film 22 is performed with an alloy target containing all the constituent elements, in an Ar and O₂ mixed-gas atmosphere, using a pulse DC power source.

Subsequently, intermediate separation layer 3 provided with a spiral guide groove (depth: 30 nm, track pitch (land-groove distance): 0.225 μm) is formed on L1 layer 20. Intermediate separation layer 3 is formed by the same method as for intermediate separation layer 2. Intermediate separation layer 3 has a thickness of about 18 μm.

L2 layer 30 is formed on intermediate separation layer 3. First dielectric film 31, recording film 32, and second dielectric film 33 are sequentially formed by a sputtering method, with first dielectric film 31 formed as (ZrO₂)₃₀(SiO₂)₃₀(In₂O₃)₄₀ (mol %) having a thickness of 21 nm, recording film 32 formed as a film having a thickness of 34 nm and a composition shown in Table 16, and second dielectric film 33 formed as (ZrO₂)₂₅(SiO₂)₂₅(In₂O₃)₅₀ (mol %) having a thickness of 13 nm. Film thickness of first dielectric film 31 and second dielectric film 33 is determined by calculation based on a matrix method. Specifically, the film thickness is determined so that unrecorded L2 layer 30 has a reflectance R_{g} of nearly equal to 5.0% to 7.0%, a reflectance Rₗ of nearly equal to 5.5% to 7.5%, and a transmittance of 70% to 80% when irradiated with 405-nm laser beam 6.

Formation of first dielectric film 31 and second dielectric film 33 is performed in an Ar atmosphere, using a DC power source or a pulse DC power source. Formation of recording film 32 is performed in an Ar and O₂ mixed-gas atmosphere, using a pulse DC power source. With a total amount of the metal elements defined as 100 atom %, recording film 22 that has a composition including 20 atom % to 50 atom % of W is formed by sputtering with use of an alloy target containing all the constituent elements. Recording film 32 that has a different composition is formed by multi-sputtering (cosputtering) that simultaneously sputters respective metal targets of the constituent elements.

Thereafter, an ultraviolet-curable resin is applied onto second dielectric film 33, followed by spin coating, and is then cured with ultraviolet light, to form cover layer 4 having a thickness of about 57 μm. This procedure completes preparation of A-side information recording medium 201.

Next, a configuration of B-side information recording medium 202 is described. As substrate 1, a polycarbonate substrate (diameter: 120 mm, thickness 0.5 mm) is prepared that includes a spiral guide groove (depth: 30 nm, track pitch (land-groove distance): 0.225 μm). A spiral rotation direction of the guide groove is made opposite to a spiral rotation direction of the guide groove formed in substrate 1 of A-side information recording medium 201 described above.

L0 layer 10a, intermediate separation layer 2, L1 layer 20, intermediate separation layer 3, L2 layer 30, and cover layer 4 are formed on substrate 1. In B-side information recording medium 202, the films (the first dielectric films, the recording films, and the second dielectric films) that constitute the information layers are formed so that the information layers have the same configurations (e.g., the composition and the thickness of the films and the reflectances and the transmittances of the information layers) as the information layers of A-side information recording medium 201. The films are formed by the same methods as the methods employed in the formation of A-side information recording medium 201. Cover layer 4 is also made to have the same configuration as cover layer 4 of A-side information recording medium 201 and is formed by the same method. Intermediate separation layers 2 and 3 also have the same configurations as the intermediate separation layers of A-side information recording medium 201. In B-side information recording medium 202, however, a rotation direction of the spiral guide groove provided in intermediate separation layers 2 and 3 is opposite to a spiral rotation direction of the guide groove provided in intermediate separation layers 2 and 3 of A-side information recording medium 201.

Lastly, an ultraviolet-curable resin is uniformly applied to a surface opposite from the guide groove-provided surface of substrate 1 in A-side information recording medium 201, and the applied resin is bonded to a surface opposite from the guide groove-provided surface of substrate 1 in B-side information recording medium 202. Then, the resin is cured with ultraviolet light to form bonding layer 5. Thus, information recording media 200 (Disc Nos. 3-125 to 138) of the present example are prepared.

The information recording media of the example and the comparative example are evaluated for the groove reflectance, the reproduction durability, and the signal quality of the L2 layer. The power for reproduction of Disc Nos. 3-125 to 138 shows standardized values, with the power for reproduction of Disc No. 3-001 set as the reference value. Disc No. 3-001 is used as an object for comparison in the comprehensive evaluation. Table 16 shows results of the comprehensive evaluation.

TABLE 16

| | | | Groove | | Amount of | | |
|---|---|---|---|---|---|---|---|
| | A-side information recording | A-side information recording | reflectance | Power for | light for | | |
| Disc | medium 201/First dielectric | medium 201/Recording | R | reproduction | reproduction | | Comprehensive |
| No. | film 31 (L2 layer) | film 32 (L2 layer) | (%) | Pr | R × Pr | c-bER | evaluation |
| 3-125 | (ZrO₂)₃₀(SiO₂)₃₀(In₂O₃)₄₀ | W₃₈Cu₁₀Mn₁₄Mo₃₈ (atom %) | 6.0 | 1.45 | 0.087 | 9.5 × E−4 | ⊚ |
| | (mol %) | | | | | | |
| 3-126 | (ZrO₂)₃₀(SiO₂)₃₀(In₂O₃)₄₀ | W₃₈Cu₁₀Mn₁₄Nb₃₈ (atom %) | 6.2 | 1.45 | 0.090 | 8.7 × E−4 | ⊚ |
| | (mol %) | | | | | | |
| 3-127 | (ZrO₂)₃₀(SiO₂)₃₀(In₂O₃)₄₀ | W₃₈Cu₁₀Mn₁₄Ta₃₈ (atom %) | 6.0 | 1.47 | 0.088 | 8.3 × E−4 | ⊚ |
| | (mol %) | | | | | | |
| 3-128 | (ZrO₂)₃₀(SiO₂)₃₀(In₂O₃)₄₀ | W₃₈Cu₁₀Mn₁₄Ti₃₈ (atom %) | 6.5 | 1.22 | 0.079 | 1.5 × E−3 | ◯ |
| | (mol %) | | | | | | |
| 3-129 | (ZrO₂)₃₀(SiO₂)₃₀(In₂O₃)₄₀ | W₃₃Cu₁₆Mn₁₇Mo₃₄ (atom %) | 6.2 | 1.37 | 0.085 | 9.0 × E−4 | ⊚ |
| | (mol %) | | | | | | |
| 3-130 | (ZrO₂)₃₀(SiO₂)₃₀(In₂O₃)₄₀ | W₃₃Cu₁₆Mn₁₇Nb₃₄ (atom %) | 6.4 | 1.35 | 0.086 | 8.4 × E−4 | ⊚ |
| | (mol %) | | | | | | |
| 3-131 | (ZrO₂)₃₀(SiO₂)₃₀(In₂O₃)₄₀ | W₃₃Cu₁₆Mn₁₇Ta₃₄ (atom %) | 6.2 | 1.35 | 0.084 | 8.0 × E−4 | ⊚ |
| | (mol %) | | | | | | |
| 3-132 | (ZrO₂)₃₀(SiO₂)₃₀(In₂O₃)₄₀ | W₃₃Cu₁₆Mn₁₇Ti₃₄ (atom %) | 6.6 | 1.18 | 0.078 | 1.2 × E−3 | ◯ |
| | (mol %) | | | | | | |
| 3-133 | (ZrO₂)₃₀(SiO₂)₃₀(In₂O₃)₄₀ | W₃₁Cu₁₈Mn₁₉Mo₂₁Zn₁₁ | 6.2 | 1.35 | 0.084 | 8.9 × E−4 | ⊚ |
| | (mol %) | (atom %) | | | | | |
| 3-134 | (ZrO₂)₃₀(SiO₂)₃₀(In₂O₃)₄₀ | W₃₁Cu₁₈Mn₁₉Nb₂₁Zn₁₁ | 6.5 | 1.32 | 0.086 | 8.2 × E−4 | ⊚ |
| | (mol %) | (atom %) | | | | | |
| 3-135 | (ZrO₂)₃₀(SiO₂)₃₀(In₂O₃)₄₀ | W₃₁Cu₁₈Mn₁₉Ta₂₁Zn₁₁ | 6.3 | 1.33 | 0.084 | 7.7 × E−4 | ⊚ |
| | (mol %) | (atom %) | | | | | |
| 3-136 | (ZrO₂)₃₀(SiO₂)₃₀(In₂O₃)₄₀ | W₂₁Cu₁₈Mn₁₉Ta₂₁Zn₂₁ | 6.2 | 1.30 | 0.081 | 7.0 × E−4 | ⊚ |
| | (mol %) | (atom %) | | | | | |
| 3-137 | (ZrO₂)₃₀(SiO₂)₃₀(In₂O₃)₄₀ | W₃₃Cu₁₆Mn₁₇Ta₂₃Zn₁₁ | 6.2 | 1.28 | 0.079 | 7.5 × E−4 | ⊚ |
| | (mol %) | (atom %) | | | | | |
| 3-138 | (ZrO₂)₃₀(SiO₂)₃₀(In₂O₃)₄₀ | W₂₃Cu₁₆Mn₁₇Ta₁₈Zn₂₆ | 6.1 | 1.25 | 0.076 | 7.2 × E−4 | ⊚ |
| | (mol %) | (atom %) | | | | | |
| 3-001 | (ZrO₂)₁₅(SiO₂)₁₅(In₂O₃)₇₀ | W₃₃Cu₁₆Mn₁₇Zn₃₄ | 6.0 | 1.00 | 0.060 | 2.6 × E−3 | X |
| | (mol %) | (atom %) | | | | | |

Any of the discs of the example gave a larger amount of light for reproduction than the disc of the comparative example. B-side information recording medium 202 is also observed to similarly, for example, improve the amount of light for reproduction of L2 layer 30.

### Example 3-4

In the present example, one example of information recording medium 200 shown in FIG. 2 is described. In the present example, information recording media 200 (Disc Nos. 3-139 to 150) are prepared similarly to Example 3-3 except that first dielectric film 31 in L2 layer 30 is formed as a film that has a thickness of 20 nm and is shown in Table 17 and recording film 32 is formed as W₃₁Cu₁₈Mn₁₉Ta₂₁Zn₁₁—O having a thickness of 34 nm.

These discs are evaluated for the groove reflectance, the reproduction durability, and the signal quality of L2 layer 30. The power for reproduction of Disc Nos. 3-139 to 150 shows standardized values, with the power for reproduction of Disc No. 3-001 set as the reference value. Disc No. 3-001 is used as an object for comparison in the comprehensive evaluation. Table 17 shows results of the comprehensive evaluation.

TABLE 17

| | | | Groove | | Amount of | | |
|---|---|---|---|---|---|---|---|
| | A-side information recording | A-side information recording | reflectance | Power for | light for | | |
| Disc | medium 201/First dielectric | medium 201/Recording | R | reproduction | reproduction | | Comprehensive |
| No. | film 31 (L2 layer) | film 32 (L2 layer) | (%) | Pr | R × Pr | c-bER | evaluation |
| 3-139 | (ZrO₂)₂₅(SiO₂)₃₅(In₂O₃)₄₀ | W₃₁Cu₁₈Mn₁₉Ta₂₁Zn₁₁ | 6.1 | 1.27 | 0.077 | 8.1 × E−4 | ⊚ |
| | (mol %) | (atom %) | | | | | |
| 3-140 | (ZrO₂)₃₀(SiO₂)₃₀(In₂O₃)₄₀ | W₃₁Cu₁₈Mn₁₉Ta₂₁Zn₁₁ | 6.3 | 1.33 | 0.084 | 7.7 × E−4 | ⊚ |
| | (mol %) | (atom %) | | | | | |
| 3-141 | (ZrO₂)₃₅(SiO₂)₂₅(In₂O₃)₄₀ | W₃₁Cu₁₈Mn₁₉Ta₂₁Zn₁₁ | 6.4 | 1.38 | 0.088 | 7.3 × E−4 | ⊚ |
| | (mol %) | (atom %) | | | | | |
| 3-142 | (ZrO₂)₄₀(SiO₂)₂₀(In₂O₃)₄₀ | W₃₁Cu₁₈Mn₁₉Ta₂₁Zn₁₁ | 6.5 | 1.45 | 0.094 | 7.3 × E−4 | ⊚ |
| | (mol %) | (atom %) | | | | | |
| 3-143 | (ZrO₂)₄₅(SiO₂)₁₅(In₂O₃)₄₀ | W₃₁Cu₁₈Mn₁₉Ta₂₁Zn₁₁ | 6.6 | 1.51 | 0.100 | 7.7 × E−4 | ⊚ |
| | (mol %) | (atom %) | | | | | |
| 3-144 | (ZrO₂)₅₀(SiO₂)₁₀(In₂O₃)₄₀ | W₃₁Cu₁₈Mn₁₉Ta₂₁Zn₁₁ | 6.6 | 1.54 | 0.102 | 7.5 × E−4 | ⊚ |
| | (mol %) | (atom %) | | | | | |
| 3-145 | (ZrO₂)₃₅(SiO₂)₂₀(In₂O₃)₄₅ | W₃₁Cu₁₈Mn₁₉Ta₂₁Zn₁₁ | 6.2 | 1.41 | 0.087 | 7.8 × E−4 | ⊚ |
| | (mol %) | (atom %) | | | | | |
| 3-146 | (ZrO₂)₄₀(SiO₂)₁₅(In₂O₃)₄₅ | W₃₁Cu₁₈Mn₁₉Ta₂₁Zn₁₁ | 6.3 | 1.45 | 0.091 | 7.2 × E−4 | ⊚ |
| | (mol %) | (atom %) | | | | | |
| 3-147 | (ZrO₂)₄₅(SiO₂)₁₀(In₂O₃)₄₅ | W₃₁Cu₁₈Mn₁₉Ta₂₁Zn₁₁ | 6.3 | 1.49 | 0.094 | 7.8 × E−4 | ⊚ |
| | (mol %) | (atom %) | | | | | |
| 3-148 | (ZrO₂)₃₅(SiO₂)₁₅(In₂O₃)₅₀ | W₃₁Cu₁₈Mn₁₉Ta₂₁Zn₁₁ | 6.1 | 1.36 | 0.083 | 7.0 × E−4 | ⊚ |
| | (mol %) | (atom %) | | | | | |
| 3-149 | (ZrO₂)₄₀(SiO₂)₁₀(In₂O₃)₅₀ | W₃₁Cu₁₈Mn₁₉Ta₂₁Zn₁₁ | 6.2 | 1.41 | 0.087 | 7.5 × E−4 | ⊚ |
| | (mol %) | (atom %) | | | | | |
| 3-150 | (ZrO₂)₄₅(SiO₂)₅(In₂O₃)₅₀ | W₃₁Cu₁₈Mn₁₉Ta₂₁Zn₁₁ | 6.3 | 1.44 | 0.091 | 7.5 × E−4 | ⊚ |
| | (mol %) | (atom %) | | | | | |
| 3-001 | (ZrO₂)₁₅(SiO₂)₁₅(In₂O₃)₇₀ | W₃₃Cu₁₆Mn₁₇Zn34 | 6.0 | 1.00 | 0.060 | 2.6 × E−3 | X |
| | (mol %) | (atom %) | | | | | |

Any of the discs of the example gave a larger amount of light for reproduction than the disc of the comparative example. According to comparison of Disc No. 3-139 with Disc Nos. 3-140 to 144, first dielectric films 31 having the same amount of In₂O₃ improve the power for reproduction along with an increase of the amount of ZrO₂. According to this fact, it is possible to obtain L2 layer 30 having higher power for reproduction (reproduction durability) by making the amount of Zr larger than the amount of Si in first dielectric film 21.

### Example 4

In the present example, as a modified example of information recording medium 400 shown in FIG. 4, an information recording medium is described that is configured by forming third dielectric film 14a between and in contact with substrate 1 and first dielectric film 11.

First, a configuration of an A-side information recording medium is described. As substrate 1, a polycarbonate substrate (diameter: 120 mm, thickness 0.5 mm) is prepared that includes a spiral guide groove (depth: 30 nm, track pitch (land-groove distance): 0.225 μm). Third dielectric film 14a, first dielectric film 11, recording film 12, and second dielectric film 13 are sequentially formed on substrate 1 by a sputtering method, with third dielectric film 14a formed as (ZrO₂)₂₅(SiO₂)₂₅(In₂O₃)₅₀ (mol %) having a thickness of 5 nm, first dielectric film 11 formed as a dielectric film having a thickness of 12 nm and a composition shown in Table 18, recording film 12 formed as a film having a thickness ranging from 31 nm to 34 nm and a composition shown in Table 18, and second dielectric film 13 formed as (ZrO₂)₂₅(SiO₂)₂₅(In₂O₃)₅₀ (mol %) having a thickness of 9 nm. When irradiated with laser beam 6 having a wavelength of 405 nm, the L0 layer that is provided with none of L1 layer 20, L2 layer 30, and L3 layer 40 and is unrecorded has a reflectance R_{g} of nearly equal to 7.0% to 14.0% and a reflectance Rₗ of nearly equal to 7.5% to 15.0%.

Formation of third dielectric film 14a is performed in an Ar atmosphere or an Ar and O₂ mixed-gas atmosphere, using a DC power source or a pulse DC power source. Formation of first dielectric film 11 is performed in an Ar atmosphere or an Ar and O₂ mixed-gas atmosphere, using a DC power source or an RF power source. Formation of recording film 12 is performed in an Ar and O₂ mixed-gas atmosphere, using a pulse DC power source. With a total amount of the metal elements defined as 100 atom %, recording film 12 that has a composition including 20 atom % to 50 atom % of W is formed by sputtering with use of an alloy target containing all the constituent elements. Recording film 12 that has a different composition is formed by multi-sputtering (cosputtering) that simultaneously sputters respective metal targets of the constituent elements. Formation of second dielectric film 13 is performed in an Ar atmosphere, using a DC power source or a pulse DC power source.

Subsequently, intermediate separation layer 2 provided with a spiral guide groove (depth: 30 nm, track pitch (land-groove distance): 0.225 μm) is formed on the L0 layer. Specifically, a main portion that occupies most of the thickness of intermediate separation layer 2 is first formed by spin coating with an ultraviolet-curable resin and curing by irradiation with ultraviolet light. Next, a surface of the main portion is spin-coated with an ultraviolet-curable resin, a transfer substrate that includes a guide groove and is made of polycarbonate is bonded onto the resin, the resin is cured with ultraviolet light, and then the transfer substrate is peeled, to form intermediate separation layer 2 including a guide groove. Intermediate separation layer 2 has a thickness of about 25 μm.

L1 layer 20 is formed on intermediate separation layer 2. Specifically, first dielectric film 21, recording film 22, and second dielectric film 23 in L1 layer 20 are sequentially formed by a sputtering method, with first dielectric film 21 formed as (ZrO₂)₃₀(SiO₂)₃₀(In₂O₃)₄₀ (mol %) having a thickness of 15 nm, recording film 22 formed as W₃₈Cu₁₀Zn₃₈Mn₁₄—O having a thickness of 35 nm, and second dielectric film 23 formed as (ZrO₂)₂₅(SiO₂)₂₅(In₂O₃)₅₀ (mol %) having a thickness of 5 nm. Film thickness of first dielectric film 21 and second dielectric film 23 is determined by calculation based on a matrix method. Specifically, the film thickness is determined so that L1 layer 20 that is provided with neither L2 layer 30 nor L3 layer 40 and is unrecorded has a reflectance R_{g} of nearly equal to 8.2%, a reflectance Rₗ of nearly equal to 8.7%, and a transmittance of about 79% when irradiated with 405-nm laser beam 6.

Formation of first dielectric film 21 and second dielectric film 23 is performed in an Ar atmosphere, using a DC power source or a pulse DC power source. Formation of recording film 22 is performed with an alloy target, in an Ar and O₂ mixed-gas atmosphere, using a pulse DC power source.

Subsequently, intermediate separation layer 3 provided with a spiral guide groove (depth: 30 nm, track pitch (land-groove distance): 0.225 μm) is formed on L1 layer 20. Intermediate separation layer 3 is formed by the same method as for intermediate separation layer 2. Intermediate separation layer 3 has a thickness of about 13 μm.

L2 layer 30 is formed on intermediate separation layer 3. First dielectric film 31, recording film 32, and second dielectric film 33 are sequentially formed by a sputtering method, with first dielectric film 31 formed as (ZrO₂)₃₀(SiO₂)₃₀(In₂O₃)₄₀ (mol %) having a thickness of 17 nm, recording film 32 formed as W₄₂Cu₆Zn₄₂Mn₁₀—O having a thickness of 35 nm, and second dielectric film 33 formed as (ZrO₂)₂₅(SiO₂)₂₅(In₂O₃)₅₀ (mol %) having a thickness of 7 nm. Film thickness of first dielectric film 31 and second dielectric film 33 is determined by calculation based on a matrix method. Specifically, the film thickness is determined so that L2 layer 30 that is provided with no L3 layer 40 and is unrecorded has a reflectance R_{g} of nearly equal to 6.8%, a reflectance Rₗ of nearly equal to 7.2%, and a transmittance of about 83% when irradiated with 405-nm laser beam 6.

Formation of first dielectric film 31 and second dielectric film 33 is performed in an Ar atmosphere, using a DC power source or a pulse DC power source. Formation of recording film 32 is performed in an Ar and O₂ mixed-gas atmosphere, using a pulse DC power source, by multi-sputtering that simultaneously sputters respective metal targets of the constituent elements.

Subsequently, intermediate separation layer 7 provided with a spiral guide groove (depth: 30 nm, track pitch (land-groove distance): 0.225 μm) is formed on L2 layer 30. Intermediate separation layer 7 is formed by the same method as for intermediate separation layer 2. Intermediate separation layer 7 has a thickness of about 18 μm.

L3 layer 40 is formed on intermediate separation layer 7. First dielectric film 41, recording film 42, and second dielectric film 43 are sequentially formed by a sputtering method, with first dielectric film 41 formed as (ZrO₂)₃₀(SiO₂)₃₀(In₂O₃)₄₀ (mol %) having a thickness of 17 nm, recording film 42 formed as W₄₅Cu₃Zn₄₅Mn₇—O having a thickness of 35 nm, and second dielectric film 43 formed as (ZrO₂)₂₅(SiO₂)₂₅(In₂O₃)₅₀ (mol %) having a thickness of 7 nm. Film thickness of first dielectric film 41 and second dielectric film 43 is determined by calculation based on a matrix method. Specifically, the film thickness is determined so that unrecorded L3 layer 40 has a reflectance R_{g} of nearly equal to 6.0%, a reflectance Rₗ of nearly equal to 6.3%, and a transmittance of about 86% when irradiated with 405-nm laser beam 6.

Formation of first dielectric film 41 and second dielectric film 43 is performed in an Ar atmosphere, using a DC power source or a pulse DC power source. Formation of recording film 42 is performed in an Ar and O₂ mixed-gas atmosphere, using a pulse DC power source, by multi-sputtering that simultaneously sputters respective metal targets of the constituent elements.

Thereafter, an ultraviolet-curable resin is applied onto second dielectric film 43, followed by spin coating, and is then cured with ultraviolet light, to form cover layer 4 having a thickness of about 57 μm. This procedure completes preparation of the A-side information recording medium.

Next, a configuration of a B-side information recording medium is described. As substrate 1, a polycarbonate substrate (diameter 120 mm, thickness 0.5 mm) is prepared that includes a spiral guide groove (depth: 30 nm, track pitch (land-groove distance): 0.225 μm). A spiral rotation direction of the guide groove is made opposite to a spiral rotation direction of the guide groove formed in substrate 1 of the A-side information recording medium described above.

L0 layer 10a, intermediate separation layer 2, L1 layer 20, intermediate separation layer 3, L2 layer 30, intermediate separation layer 7, L3 layer 40, and cover layer 4 are formed on substrate 1. In the B-side information recording medium, the films (the first dielectric films, the recording films, and the second dielectric films) that constitute the information layers are formed so that the information layers have the same configurations (e.g., the composition and the thickness of the films and the reflectances and the transmittances of the information layers) as the information layers of the A-side information recording medium. The films are formed by the same methods as the methods employed in the formation of the A-side information recording medium. Cover layer 4 is also made to have the same configuration as cover layer 4 of the A-side information recording medium and is formed by the same method. Intermediate separation layers 2, 3 and 7 also have the same configurations as the intermediate separation layers of the A-side information recording medium.

In the B-side information recording medium, however, a rotation direction of the spiral guide groove provided in intermediate separation layers 2 and 3 is opposite to a spiral rotation direction of the guide groove provided in intermediate separation layers 2 and 3 of the A-side information recording medium. L0 layer 10a that is provided with none of L1 layer 20, L2 layer 30, and L3 layer 40 and is unrecorded has, similarly to L0 layer 10a of the A-side information recording medium, a reflectance R_{g} of nearly equal to 7.0% to 14.0% and a reflectance Rₗ of nearly equal to 7.5% to 15.0%.

Lastly, an ultraviolet-curable resin is uniformly applied to a surface opposite from the guide groove-provided surface of substrate 1 in the A-side information recording medium, and the applied resin is bonded to a surface opposite from the guide groove-provided surface of substrate 1 in the B-side information recording medium. Then, the resin is cured with ultraviolet light to form bonding layer 5. Thus, the information recording media (Disc Nos. 4-101 to 109) of the present example are prepared.

### Comparative Example 4

An information recording medium 400 (Disc No. 4-001) is prepared that has the same configuration as the information recording media of Example 4 except that first dielectric films 11 of the A-side information recording medium and the B-side information recording medium are formed as (ZrO₂)₁₅(SiO₂)₁₅(In₂O₃)₇₀ (mol %) having a thickness of 12 nm, recording films 12 are formed as W₁₉Cu₂₅Zn₂₀Mn₃₆—O having a thickness of 31 nm, and no third dielectric film is formed.

The information recording media of the example and the comparative example are evaluated for the groove reflectance, the reproduction durability, and the signal quality of the L0 layer. Table 18 shows results of the evaluation.

The discs having a one-side four-layer structure were evaluated for, for example, the reflectance by a following method. The reflectance is measured using a reflectance evaluation apparatus (manufactured by Pulstec Industrial Co., Ltd., trade name: ODU-1000). For measuring the reflectance, a laser beam source with a wavelength of 405 nm and an objective lens having a numerical aperture NA of 0.85.

An evaluation apparatus (manufactured by Pulstec Industrial Co., Ltd., trade name: ODU-1000) for signal evaluation, with laser beam having a wavelength of 405 nm and an objective lens having a numerical aperture NA of 0.91, records information on a groove and a land. Linear velocity of recording is set at 13.38 m/s (500 GB-sextuple speed) and linear velocity of reproduction is set at 8.85 m/s (500 GB-quadruple speed). Data bit length is set at 51.3 nm and 83.4-GB information is recorded per one information layer. The power during reproduction is set at 2.0 mW for L0 layer 10, L1 layer 20, and L2 layer 30 and at 1.5 mW for L3 layer 40. Laser beam 6 subjected to high frequency superposition (modulation) at 2:1 is used as light for reproduction. Recording with random signals (2 T to 12T) is performed and the signal quality is evaluated as a channel bit error rate (c-bER). In the present example, reference value 2×E-3 was set as a standard for determining the signal quality. Signals having a c-bER of less than or equal to 2×E-3 were determined to be good in signal quality.

The reproduction durability is evaluated by size of the power for reproduction (upper limit of the power of a laser beam during reproduction). Specifically, random signals are recorded on adjacent grooves and lands, and a groove on which the recording has been performed and that is positioned at a center of a track is reproduced at a linear velocity of 8.85 m/s one million times, and the c-bER is measured. The c-bER after one-million-time reproduction is measured while changing the power during reproduction, and power that gives a c-bER of 2×E-3 is set as the power for reproduction. The groove exhibits a higher light absorptance than the land and has worse reproduction durability than the land, so that the evaluation is performed not by reproduction of the land but by reproduction of the groove. The power for reproduction is evaluated not by an absolute value but by a value standardized with a reference value, with the power for reproduction of one disc set as the reference value (1.00) (that is, by how many times larger or smaller the power for reproduction is than the reference value). In the present example, the power for reproduction of Disc no. 4-001 is set as the reference value.

Comprehensive evaluation is performed similarly to Example 1-1. Disc No. 4-001, however, is used as an object for comparison in the comprehensive evaluation.

TABLE 18

| | A-side information | A-side information | A-side information | | | | | |
|---|---|---|---|---|---|---|---|---|
| | recording | recording | recording | Groove | | Amount of | | |
| | medium/Third | medium/First | medium/Recording | reflectance | Power for | light for | | |
| Disc | dielectric film 14a | dielectric film 11 | film 12 | R | reproduction | reproduction | | Comprehensive |
| No. | (L0 layer) | (L0 layer) | (L0 layer) | (%) | Pr | R × Pr | c-bER | evaluation |
| 4-101 | (ZrO₂)₂₅(SiO₂)₂₅ | Nb₂O₅ | W₁₉Cu₂₅Mn₃₆Mo₂₀ | 3.6 | 1.45 | 0.052 | 8.5 × E−4 | ⊚ |
| | (In₂O₃)₅₀(mol %) | | (atom %) | | | | | |
| 4-102 | (ZrO₂)₂₅(SiO₂)₂₅ | Nb₂O₅ | W₁₉Cu₂₅Mn₃₆Nb₂₀ | 3.4 | 1.35 | 0.046 | 8.8 × E−4 | ⊚ |
| | (In₂O₃)₅₀(mol %) | | (atom %) | | | | | |
| 4-103 | (ZrO₂)₂₅(SiO₂)₂₅ | Nb₂O₅ | W₁₉Cu₂₅Mn₃₆Ta₂₀ | 3.5 | 1.35 | 0.047 | 8.8 × E−4 | ⊚ |
| | (In₂O₃)₅₀(mol %) | | (atom %) | | | | | |
| 4-104 | (ZrO₂)₂₅(SiO₂)₂₅ | Nb₂O₅ | W₂₇Cu₁₈Mn₂₆Mo₂₉ | 3.3 | 1.65 | 0.054 | 9.9 × E−4 | ⊚ |
| | (In₂O₃)₅₀(mol %) | | (atom %) | | | | | |
| 4-105 | (ZrO₂)₂₅(SiO₂)₂₅ | Nb₂O₅ | W₂₇Cu₁₈Mn₂₆Nb₂₉ | 3.2 | 1.60 | 0.051 | 9.7 × E−4 | ⊚ |
| | (In₂O₃)₅₀(mol %) | | (atom %) | | | | | |
| 4-106 | (ZrO₂)₂₅(SiO₂)₂₅ | Nb₂O₅ | W₂₇Cu₁₈Mn₂₆Ta₂₉ | 3.3 | 1.55 | 0.051 | 8.4 × E−4 | ⊚ |
| | (In₂O₃)₅₀(mol %) | | (atom %) | | | | | |
| 4-107 | (ZrO₂)₂₅(SiO₂)₂₅ | Nb₂O₅ | W₃₃Cu₁₆Mn₁₇Mo₃₄ | 2.7 | 2.15 | 0.058 | 9.6 × E−4 | ⊚ |
| | (In₂O₃)₅₀(mol %) | | (atom %) | | | | | |
| 4-108 | (ZrO₂)₂₅(SiO₂)₂₅ | Nb₂O₅ | W₃₃Cu₁₆Mn₁₇Nb₃₄ | 2.6 | 2.10 | 0.055 | 9.6 × E−4 | ⊚ |
| | (In₂O₃)₅₀(mol %) | | (atom %) | | | | | |
| 4-109 | (ZrO₂)₂₅(SiO₂)₂₅ | Nb₂O₅ | W₃₃Cu₁₆Mn₁₇Ta₃₄ | 2.6 | 2.15 | 0.056 | 8.7 × E−4 | ⊚ |
| | (In₂O₃)₅₀(mol %) | | (atom %) | | | | | |
| 4-001 | — | (ZrO₂)₁₅(SiO₂)₁₅ | W₁₉Cu₂₅Mn₃₆Zn₂₀ | 3.0 | 1.00 | 0.030 | 4.5 × E−3 | X |
| | | (In₂O₃)₇₀(mol %) | (atom %) | | | | | |

Comparison of Disc Nos. 4-101 to 109 with Disc No. 4-001 clarifies that first dielectric film 11 formed as Nb₂O₅ and recording film 12 containing W, Cu, Mn, and the M improve the power for reproduction and thus improve the amount of light for reproduction. Recording film 12 that is changed in composition to further decrease the amount of Cu and the amount of Mn slightly lowers the reflectance but improves the power for reproduction, resulting in enabling an improvement in the amount of light for reproduction. The B-side information recording medium is also observed to similarly, for example, improve the amount of light for reproduction of the L0 layer.

### Example 5

In the present example, one example of information recording medium 500 shown in FIG. 5 is described. First, a configuration of A-side information recording medium 501 is described. As substrate 1, a polycarbonate substrate (diameter: 120 mm, thickness 0.5 mm) is prepared that includes a spiral guide groove (depth: 30 nm, track pitch (land-groove distance): 0.225 μm). First dielectric film 61, recording film 62, and second dielectric film 63 are sequentially formed on substrate 1 by a sputtering method, with first dielectric film 61 formed as (ZrO₂)₂₅(SiO₂)₂₅(In₂O₃)₅₀ (mol %) having a thickness of 12 nm, recording film 62 formed as a film having a thickness of 31 nm and a composition shown in Table 19, and second dielectric film 63 formed as (ZrO₂)₂₅(SiO₂)₂₅(In₂O₃)₅₀ (mol %) having a thickness of 9 nm. When irradiated with laser beam 6 having a wavelength of 405 nm, L0 layer 60 that is provided with neither L1 layer 70 nor L2 layer 80 and is unrecorded has a reflectance R_{g} of nearly equal to 8.0% to 14.0% and a reflectance Rₗ of nearly equal to 9.0% to 15.0%.

Formation of first dielectric film 61 and second dielectric film 63 is performed in an Ar atmosphere, using a DC power source or a pulse DC power source. Formation of recording film 62 is performed with an alloy target containing all the constituent elements, in an Ar and O₂ mixed-gas atmosphere, using a pulse DC power source.

Subsequently, intermediate separation layer 2 provided with a spiral guide groove (depth: 30 nm, track pitch (land-groove distance): 0.225 μm) is formed on L0 layer 60. Specifically, a main portion that occupies most of the thickness of intermediate separation layer 2 is first formed by spin coating with an ultraviolet-curable resin and curing by irradiation with ultraviolet light. Next, a surface of the main portion is spin-coated with an ultraviolet-curable resin, a transfer substrate that includes a guide groove and is made of polycarbonate is bonded onto the resin, the resin is cured with ultraviolet light, and then the transfer substrate is peeled, to form intermediate separation layer 2 including a guide groove. Intermediate separation layer 2 has a thickness of about 25 μm.

L1 layer 70 is formed on intermediate separation layer 2. Specifically, first dielectric film 71, recording film 72, and second dielectric film 73 in L1 layer 70 are sequentially formed by a sputtering method, with first dielectric film 71 formed as (ZrO₂)₃₀(SiO₂)₃₀(In₂O₃)₄₀ (mol %) having a thickness of 20 nm, recording film 72 formed as W₃₁Cu₁₈Mn₁₉Ta₂₁Zn₁₁—O having a thickness of 35 nm, and second dielectric film 73 formed as (ZrO₂)₂₅(SiO₂)₂₅(In₂O₃)₅₀ (mol %) having a thickness of 12 nm. When irradiated with 405-nm laser beam 6, L1 layer 70 that is provided with no L2 layer 80 and is unrecorded has a reflectance R_{g} of nearly equal to 7.0%, a reflectance Rₗ of nearly equal to 7.5%, and a transmittance of about 75%.

Formation of first dielectric film 71 and second dielectric film 73 is performed in an Ar atmosphere, using a DC power source or a pulse DC power source. Formation of recording film 72 is performed with an alloy target containing all the constituent elements, in an Ar and O₂ mixed-gas atmosphere, using a pulse DC power source.

Subsequently, intermediate separation layer 3 provided with a spiral guide groove (depth: 30 nm, track pitch (land-groove distance): 0.225 μm) is formed on L1 layer 70. Intermediate separation layer 3 is formed by the same method as for intermediate separation layer 2. Intermediate separation layer 3 has a thickness of about 18 μm.

L2 layer 80 is formed on intermediate separation layer 3. First dielectric film 81, recording film 82, and second dielectric film 83 are sequentially formed by a sputtering method, with first dielectric film 81 formed as (ZrO₂)₃₀(SiO₂)₃₀(In₂O₃)₄₀ (mol %) having a thickness of 21 nm, recording film 82 formed as W₃₁Cu₁₈Mn₁₉Ta₂₁Zn₁₁—O having a thickness of 34 nm, and second dielectric film 83 formed as (ZrO₂)₂₅(SiO₂)₂₅(In₂O₃)₅₀ (mol %) having a thickness of 19 nm. Film thickness of first dielectric film 81 and second dielectric film 83 is determined by calculation based on a matrix method. Specifically, the film thickness is determined so that unrecorded L2 layer 80 has a reflectance R_{g} of nearly equal to 5.8%, a reflectance Rₗ of nearly equal to 6.3%, and a transmittance of about 79% when irradiated with 405-nm laser beam 6.

Formation of first dielectric film 81 and second dielectric film 83 is performed in an Ar atmosphere, using a DC power source or a pulse DC power source. Formation of recording film 82 is performed with an alloy target containing all the constituent elements, in an Ar and O₂ mixed-gas atmosphere, using a pulse DC power source.

Thereafter, an ultraviolet-curable resin is applied onto second dielectric film 83, followed by spin coating, and is then cured with ultraviolet light, to form cover layer 4 having a thickness of about 57 μm. This procedure completes preparation of A-side information recording medium 501.

Next, a configuration of B-side information recording medium 502 is described. As substrate 1, a polycarbonate substrate (diameter: 120 mm, thickness 0.5 mm) is prepared that includes a spiral guide groove (depth: 30 nm, track pitch (land-groove distance): 0.225 μm). A spiral rotation direction of the guide groove is made opposite to a spiral rotation direction of the guide groove formed in substrate 1 of A-side information recording medium 501 described above.

L0 layer 60, intermediate separation layer 2, L1 layer 70, intermediate separation layer 3, L2 layer 80, and cover layer 4 are formed on substrate 1. In B-side information recording medium 502, the films (the first dielectric films, the recording films, and the second dielectric films) that constitute the information layers are formed so that the information layers have the same configurations (e.g., the composition and the thickness of the films and the reflectances and the transmittances of the information layers) as the information layers of A-side information recording medium 501. The films are formed by the same methods as the methods employed in the formation of A-side information recording medium 501. Cover layer 4 is also made to have the same configuration as cover layer 4 of A-side information recording medium 501 and is formed by the same method. Intermediate separation layers 2 and 3 also have the same configurations as the intermediate separation layers of A-side information recording medium 501. In B-side information recording medium 502, however, a rotation direction of the spiral guide groove provided in intermediate separation layers 2 and 3 is opposite to a spiral rotation direction of the guide groove provided in intermediate separation layers 2 and 3 of A-side information recording medium 501.

Lastly, an ultraviolet-curable resin is uniformly applied to a surface opposite from the guide groove-provided surface of substrate 1 in A-side information recording medium 501, and the applied resin is bonded to a surface opposite from the guide groove-provided surface of substrate 1 in B-side information recording medium 502. Then, the resin is cured with ultraviolet light to form bonding layer 5. Thus, information recording media 500 (Disc Nos. 5-101 to 106) of the present example are prepared.

The information recording media of the example and the comparative example are evaluated for the groove reflectance, the reproduction durability, and the signal quality of the L0 layer. The power for reproduction of Disc Nos. 5-101 to 106 shows standardized values, with the power for reproduction of Disc No. 1-001 (Comparative Example 1) set as the reference value. Disc No. 1-001 is used as an object for comparison in the comprehensive evaluation. Table 19 shows results of the comprehensive evaluation.

TABLE 19

| | | | Groove | | Amount of | | |
|---|---|---|---|---|---|---|---|
| | A-side information recording | A-side information recording | reflectance | Power for | light for | | |
| Disc | medium 501/First dielectric | medium 501/Recording | R | reproduction | reproduction | | Comprehensive |
| No. | film 61 (L0 layer) | film 62 (L0 layer) | (%) | Pr | R × Pr | c-bER | evaluation |
| 5-101 | (ZrO₂)₂₅(SiO₂)₂₅(In₂O₃)₅₀(mol %) | W₁₉Cu₂₅Mn₃₆Ti₂₀ (atom %) | 3.9 | 1.10 | 0.043 | 9.5 × E−4 | ⊚ |
| 5-102 | (ZrO₂)₂₅(SiO₂)₂₅(In₂O₃)₅₀(mol %) | W₂₅Cu₂₁Mn₂₈Ti₂₆ (atom %) | 3.7 | 1.22 | 0.045 | 9.3 × E−4 | ⊚ |
| 5-103 | (ZrO₂)₂₅(SiO₂)₂₅(In₂O₃)₅₀(mol %) | W₂₇Cu₁₈Mn₂₆Ti₂₉ (atom %) | 3.7 | 1.24 | 0.046 | 9.0 × E−4 | ⊚ |
| 5-104 | (ZrO₂)₂₅(SiO₂)₂₅(In₂O₃)₅₀(mol %) | W₃₀Cu₂₀Mn₂₀Ti₃₀ (atom %) | 3.6 | 1.28 | 0.046 | 9.7 × E−3 | ⊚ |
| 5-105 | (ZrO₂)₂₅(SiO₂)₂₅(In₂O₃)₅₀(mol %) | W₂₅Cu₂₁Mn₂₈Ti₂₁Zn₅ (atom %) | 3.7 | 1.22 | 0.045 | 9.2 × E−4 | ⊚ |
| 5-106 | (ZrO₂)₂₅(SiO₂)₂₅(In₂O₃)₅₀(mol %) | W₂₀Cu₂₁Mn₂₈Ti₂₁Zn₁₅ (atom %) | 3.6 | 1.20 | 0.043 | 9.0 × E−4 | ⊚ |
| 1-001 | (ZrO₂)₁₅(SiO₂)₁₅(In₂O₃)₇₀(mol %) | W₁₉Cu₂₅Mn₃₆Zn₂₀ (atom %) | 3.0 | 1.00 | 0.030 | 4.0 × E−3 | X |

Any of the discs of the example gave a larger amount of light for reproduction than the disc of the comparative example. B-side information recording medium 502 is also observed to similarly, for example, improve the amount of light for reproduction of L0 layer 60.

### INDUSTRIAL APPLICABILITY

The information recording medium and the method for producing the information recording medium according to the present disclosure are configured to include an information layer that exhibits a larger amount of light for reproduction, so that the information recording medium is suitable for recording information at high recording density and is useful to an optical disc that records a large amount of contents. Specifically, the information recording medium is useful to a next-generation optical disc (for example, recording capacity: 500 GB) including three or four information layers on both sides of the disc conforming to the Archival Disc standard.

### REFERENCE MARKS IN THE DRAWINGS

100, 200, 300, 400, 500: information recording medium
101, 201, 301, 401, 501: A-side information recording medium
102, 202, 302, 402, 502: B-side information recording medium
10, 10a, 10b, 60: L0 layer
20, 70: L1 layer
30, 80: L2 layer
40: L3 layer
12, 22, 32, 42, 62, 72, 82: recording film
11, 21, 31, 41, 61, 71, 81: first dielectric film
13, 23, 33, 43, 63, 73, 83: second dielectric film
14a, 14b: third dielectric film
1: substrate
2, 3, 7: intermediate separation layer
4: cover layer
5: bonding layer
6: laser beam

1. An information recording medium that records or reproduces information by irradiation with a laser beam, the information recording medium comprising three or more information layers,
the three or more information layers including a first information layer, the first information layer including a first dielectric film, a recording film, and a second dielectric film in this order from a farther end toward a nearer end of the first information layer from a laser beam-irradiated surface of the information recording medium,
the first dielectric film containing an oxide of D1, where the D1 represents at least one element selected from a first group consisting of niobium (Nb), molybdenum (Mo), tantalum (Ta), tungsten (W), titanium (Ti), bismuth (Bi), and cerium (Ce),
the recording film containing at least tungsten (W), copper (Cu), manganese (Mn), and oxygen and further containing M, where the M representing at least one element selected from a second group consisting of niobium (Nb), molybdenum (Mo), tantalum (Ta), and titanium (Ti),
the W, the Cu, the Mn, and the M except the oxygen in the recording film satisfying a following formula (1):
WₓCu_{y}Mn_{z}M_{100-x-y-z} (atom %) (1),
wherein
x, y, and z satisfy 15≤x≤60, y≤z, 0<z≤40, and 60≤x+y+z≤98.

2. The information recording medium according to claim 1,
wherein x and z in the formula (1) satisfy 0.5≤(x/z)≤3.0.

3. The information recording medium according to claim 1,
wherein the first group consists of Nb, Mo, and Ta.

4. The information recording medium according to claim 1,
wherein the second group consists of Nb, Mo, and Ta.

5. The information recording medium according to claim 1,
wherein the first information layer is disposed at a farthest position from the laser beam-irradiated surface.

6. The information recording medium according to claim 1,
wherein the second dielectric film contains an oxide of D2, where the D2 representing at least one element selected from a third group consisting of niobium (Nb), molybdenum (Mo), tantalum (Ta), tungsten (W), titanium (Ti), bismuth (Bi), cerium (Ce), zirconium (Zr), indium (In), tin (Sn), and silicon (Si).

7. The information recording medium according to claim 6,
wherein the third group consists of Nb, Mo, Ta, Zr, In, Sn, and Si.

8. The information recording medium according to claim 1,
wherein the recording film further contains zinc (Zn).

9. The information recording medium according to claim 1,
wherein the first dielectric film further contains an oxide of zirconium (Zr), and
the first dielectric film has a proportion of the oxide of Zr of less than or equal to 70 mol % in a total amount of the oxide of Zr and the oxide of the D1.

10. The information recording medium according to claim 1,
wherein the first information layer further includes a third dielectric film, and
the third dielectric film, the first dielectric film, and the recording film are disposed in this order from the farther end toward the nearer end of the first information layer from the laser beam-irradiated surface.

11. The information recording medium according to claim 1,
wherein the first information layer further includes a third dielectric film, and
the first dielectric film, the third dielectric film, and the recording film are disposed in this order from the farther end toward the nearer end of the first information layer from the laser beam-irradiated surface.

12. The information recording medium according to claim 10,
wherein the third dielectric film contains an oxide of D3, where the D3 representing at least one element selected from a fourth group consisting of zirconium (Zr), indium (In), tin (Sn), and silicon (Si).

13. The information recording medium according to claim 1,
wherein the three or more information layers include a second information layer,
the second information layer is different from the first information layer and includes a recording film, and
the recording film in the second information layer contains at least tungsten (w), copper (Cu), manganese (Mn), and oxygen.

14. The information recording medium according to claim 1, comprising a substrate on each side of which the three or more information layers are disposed.

15. The information recording medium according to claim 1,
wherein each of the three or more information layers has uneven surfaces including a groove and a land on each of which information recorded, the groove being nearer from the laser beam-irradiated surface than the land is.

16. The information recording medium according to claim 1,
wherein the first information layer is positioned farthest from the laser beam-irradiated surface,
the three or more information layers include a second information layer,
the second information layer is different from the first information layer and includes a first dielectric film, a recording film, and a second dielectric film in this order from a farther end of the second information layer from the laser beam-irradiated surface, and
the first dielectric film and the second dielectric film in the second information layer contain an oxide of D3, where the D3 representing at least one element selected from a fourth group consisting of zirconium (Zr), indium (In), tin (Sn), and silicon (Si).

17. The information recording medium according to claim 16,
wherein the first dielectric film in the second information layer contains at least Zr and Si, and the first dielectric film in the second information layer contains the Zr more than the Si.

18. An information recording medium that records or reproduces information by irradiation with a laser beam, the information recording medium comprising three or more information layers,
the three or more information layers including an information layer, the information layer including a first dielectric film, a recording film, and a second dielectric film in this order from a farther end toward a nearer end of the information layer from a laser beam-irradiated surface of the information recording medium,
the first dielectric film and the second dielectric film containing an oxide of D3, where the D3 representing at least one element selected from a group consisting of zirconium (Zr), indium (In), tin (Sn), and silicon (Si), the recording film containing at least tungsten (W), copper (Cu), manganese (Mn), titanium (Ti), and oxygen,
the W, the Cu, the Mn, and the Ti except the oxygen in the recording film satisfying a following formula (2):
WₓCu_{y}Mn_{z}Ti_{100-x-y-z} (atom %) (2),
wherein
x, y, and z satisfy 15≤x≤60, y≤z, 0<z≤40, and 60≤x+y+z≤98.

19. The information recording medium according to claim 18,
wherein the recording film further contains at least one element selected from a group consisting of zinc (Zn), niobium (Nb), molybdenum (Mo), and tantalum (Ta).

20. The information recording medium according to claim 10,
wherein at least one of the first dielectric film, the second dielectric film, or the third dielectric film further contains carbon (C).

21. A method for producing an information recording medium, the method comprising steps of respectively forming three or more information layers included in the information recording medium,
wherein at least one of the steps of respectively forming the three or more information layers includes:
forming a first dielectric film containing an oxide of D1 by sputtering with use of a target containing the D1, where the D1 representing at least one element selected from a first group consisting of niobium (Nb), molybdenum (Mo), tantalum (Ta), tungsten (W), titanium (Ti), bismuth (Bi), and cerium (Ce); and
forming a recoding film containing at least tungsten (W), copper (Cu), manganese (Mn), and oxygen, and further containing M by sputtering with use of a target containing at least W, Cu, and Mn and further containing the M, where the M representing at least one element selected from a second group consisting of niobium (Nb), molybdenum (Mo), tantalum (Ta), and titanium (Ti),
the W, the Cu, the Mn, and the M except the oxygen in the target used in a step for forming the recording film satisfying a following formula (1):
WₓCu_{y}Mn_{z}M_{100-x-y-z} (atom %) (1),
wherein
x, y, and z satisfy 15≤x≤60, y≤z, 0<z≤40, and 60≤x+y+z≤98.

22. The method for producing the information recording medium according to claim 21,
wherein x and z in the formula (1) satisfy 0.5≤(x/z)≤3.0.

23. The method for producing the information recording medium according to claim 21,
wherein the step for forming the recording film employs a reactive sputtering method that introduces oxygen.

24. The method for producing an information recording medium according to claim 21,
wherein the target used in the step for recording film further contains zinc (Zn), and
the step for forming the recording film forms, by the sputtering, the recording film containing at least the W, the Cu, the Mn, the M, the Zn, and oxygen.

25. A sputtering target for forming a recording film of an information recording medium, the sputtering target comprising:
at least tungsten (W), copper (Cu), and manganese (Mn); and
M, where the M representing at least one element selected from a group consisting of niobium (Nb), molybdenum (Mo), tantalum (Ta), and titanium (Ti), the W, the Cu, the Mn, and the M except oxygen satisfying a following formula (1);
WₓCu_{y}Mn_{z}M_{100-x-y-z} (atom %) (1),
wherein
x, y, and z satisfy 15≤x≤60, y≤z, 0<z≤40, and 60≤x+y+z≤98.

26. The sputtering target according to claim 25,
wherein x and z in the formula (1) satisfy 0.5≤(x/z)≤3.0.

27. The sputtering target according to claim 25, further comprising zinc (Zn).
